(19) United States
(12) Patent Application Publication
(10) Pub. No.: US 2026/0268182 A1
(43) Pub. Date: Sep. 10, 2026

(54) SYSTEMS AND METHODS FOR MULTI-TIER ORCHESTRATION OF ARTIFICIAL INTELLIGENCE INFERENCE

(71) Applicant: Edgevana, Inc., San Francisco, CA (US)

(72) Inventors: Andrew Yasutake, San Francisco, CA (US); Russell Thompson, San Francisco, CA (US); Stephen Wong, San Francisco, CA (US); Jay Robertson, San Francisco, CA (US); Anh Thu Vo, San Francisco, CA (US)

(21) Appl. No.: 19/558,249

(22) Filed: Mar. 5, 2026

Related U.S. Application Data
(63) Continuation of application No. PCT/IB2025/052361, filed on Mar. 5, 2025.
(60) Provisional application No. 63/767,464, filed on Mar. 5, 2025.
(60) Provisional application No. 63/769,445, filed on Mar. 10, 2025.
(60) Provisional application No. 63/868,894, filed on Aug. 22, 2025.

(51) Int. Cl. G06N 5/043; G06F 21/62

(52) U.S. Cl. CPC G06N 5/043; G06F 21/6245

(57) ABSTRACT

A distributed artificial intelligence inference system comprising a hierarchical multi-tier architecture with device, edge, metro, and data center tiers. A workload distribution controller computes a composite routing score for each inference task based on computational complexity, latency requirement, privacy classification, data volume, device resource state, and network conditions, and selects a target processing tier accordingly. A privacy classification engine assigns sensitivity levels to data elements, constraining eligible processing tiers. Multiple inference pipelines are co-located on shared edge nodes and exchange data via local shared memory. A model-architecture-specific state compression engine compresses session state using methods selected based on whether the inference pipeline employs a state-space model, transformer, or convolutional neural network architecture. A predictive routing engine computes destination confidence scores and proactively transfers compressed session state to predicted destination edge nodes to maintain session continuity during user mobility.

### CROSS REFERENCE TO RELATED APPLICATIONS

This application claims the benefit of priority to International PCT Patent Application No. PCT/IB2025/052361, filed Mar. 5, 2025; U.S. Provisional Patent Application No. 63/767,464, filed Mar. 5, 2025; U.S. Provisional Patent Application No. 63/769,445, filed Mar. 10, 2025; and U.S. Provisional Patent Application No. 63/868,894, filed Aug. 22, 2025, the entire disclosures of each of which are incorporated herein by reference.

### TECHNICAL FIELD

The present invention relates to distributed computing systems for artificial intelligence inference. This can include systems and methods for dynamically orchestrating AI inference workloads across a multi-tier architecture spanning end-user devices, distributed edge computing infrastructure nodes, and data center facilities, with privacy-controlled tier selection, model-architecture-specific state compression for session mobility between edge nodes, and predictive pre-positioning of compressed inference state at destination edge nodes.

### BACKGROUND

### The Latency Problem in Centralized AI Inference

The proliferation of artificial intelligence applications requiring real-time inference has exposed a fundamental limitation of centralized cloud-based AI architectures. Applications such as augmented reality overlay rendering, live multilingual speech translation, interactive AI assistants, autonomous vehicle coordination, and in-play sports analytics demand end-to-end inference latencies well below 200 milliseconds to maintain acceptable user experience and operational viability. However, round-trip latency from end-user devices to cloud data centers and back typically ranges from 150 to 500 milliseconds or more depending on geographic distance, wide-area network conditions, multi-tenant GPU scheduling queue depths, and inter-service serialization overhead at the data center.

The problem is structural rather than incidental. Physical distance between end users and centralized data centers imposes irreducible propagation delays. Wide-area network traversals introduce variable jitter. Multi-tenant GPU scheduling at cloud data centers introduces queuing delays that grow with utilization. And in microservice architectures common in cloud deployments, multiple inference pipelines that must exchange data do so via network round-trips between separate services, adding cumulative latency with each pipeline interaction. These latency sources compound, rendering centralized cloud inference inadequate for the growing class of latency-sensitive AI applications.

### Existing Edge Computing Approaches and Their Limitations

Edge computing architectures have emerged to address some of these latency challenges by deploying computational resources closer to end users. Multi-access edge computing (MEC) platforms, as standardized by various industry bodies, provide frameworks for network function virtualization, content caching, and application hosting at network edge locations. These systems have demonstrated significant latency improvements for traditional network services and content delivery.

However, existing edge computing approaches were designed primarily for network function virtualization and content delivery, not for the unique requirements of AI inference workloads.

### The Mobility Problem for Stateful AI Inference

Traditional cellular handoff protocols transfer radio connectivity from one base station to another as a user moves between coverage areas. These protocols are well-established and achieve seamless handoff for voice calls and data sessions. However, they transfer only connectivity state (bearer contexts, IP sessions, quality-of-service parameters).

When a user with an active AI inference session moves from one edge node coverage area to another, existing systems face an unsatisfactory choice. One option is to restart the inference session from scratch at the new edge node, a cold start that discards all accumulated context and requires the model to rebuild its internal representation from the ground up. For a neural machine translation model that has accumulated thousands of tokens of conversational context, or a spatial understanding model that has built an environmental map over minutes of observation, this cold start represents a significant loss of accumulated computational investment and a degradation in inference quality.

The other option is to continue routing all AI inference requests back to the original edge node, which defeats the purpose of edge proximity. As the user moves further from the original node, latency increases and may exceed application requirements, while the edge node continues to hold resources for a user who is no longer in its geographic service area.

Neither approach is acceptable for the growing class of stateful AI inference applications where accumulated context represents both significant computational investment and meaningful improvements in inference quality and personalization.

### The Privacy Gap in Current Orchestration

Current workload distribution systems may distributed computing environments optimize routing decisions based on latency, available computational resources, throughput capacity, and cost. These systems treat all requests as functionally equivalent from a data sensitivity perspective, routing each request to whichever processing tier satisfies performance constraints at lowest cost.

This approach fails to account for the varying sensitivity of data contained in AI inference requests. An inference request processing a user's biometric voice signature has fundamentally different privacy requirements than an inference request processing publicly available text. An inference request containing medical imaging data is subject to regulatory constraints that do not apply to an inference request analyzing a public sports broadcast. Existing known orchestration systems provide no mechanism to classify the sensitivity of inference request data and use that classification as a routing constraint that determines which processing tiers may handle the request.

There exists a need for a distributed AI inference system that addresses the discussed background systems deficiencies and other deficiencies.

### SUMMARY OF THE INVENTION

In accordance with one or more embodiments, a distributed AI inference system is provided comprising a hierarchical multi-tier architecture with at least a device tier, an edge computing infrastructure tier, and a data center tier, and in preferred embodiments a metro/regional coordination tier. The system includes a workload distribution controller configured to route AI inference requests among the tiers based on a composite routing decision that considers at least: computational complexity of the inference task, latency requirements, a privacy classification of the input data, available resources at each tier, and data volume. The system further includes a state compression engine configured to compress active AI inference session state using compression techniques adapted to the specific model architecture, and a predictive routing engine configured to pre-position compressed session state at predicted destination edge nodes based on user mobility prediction. The system maintains AI inference session continuity during user mobility across edge computing infrastructure node coverage areas with sub-100 millisecond session interruption.

In accordance with one or more embodiments, a method is provided for distributing AI inference workloads across a multi-tier architecture. The method comprises receiving an inference request at a device tier, classifying the inference request according to at least a computational complexity factor and a privacy sensitivity factor, selecting a processing tier from among the device tier, an edge computing infrastructure tier, and a data center tier based on the classification, routing the inference request to the selected tier, performing inference at the selected tier, and returning inference results. When the privacy sensitivity factor exceeds a threshold, the method constrains processing to the device tier or the nearest edge computing infrastructure tier, regardless of whether a higher tier would provide lower latency or higher throughput.

In accordance with one or more embodiments, a method is operable to provide for maintaining AI inference session continuity during user mobility across edge computing infrastructure node coverage areas. The method comprises monitoring mobility signals for a user with an active AI inference session at a first edge computing infrastructure node, predicting based on the mobility signals a destination edge computing infrastructure node, compressing the active AI inference session state using a compression technique selected based on the model architecture of the active inference session, transferring the compressed session state to the predicted destination edge computing infrastructure node before the user arrives, and activating the session at the destination node upon user arrival with sub-100 millisecond interruption.

In accordance with one or more embodiments, a system is provided wherein a plurality of interdependent AI inference pipelines are co-located on shared edge computing infrastructure, communicating through local shared memory with microsecond-level inter-pipeline latency, creating closed-loop inference cycles that are structurally impossible to achieve at equivalent speed in centralized cloud deployments where the pipelines would operate as separate networked microservices.

In accordance with one or more embodiments, a distributed artificial intelligence inference system is provided comprising one or more processors configured to execute stored computer readable instructions that configure the system, for each inference request received from an end-user device, to assess a computational complexity of the inference request, determine a latency requirement, and classify a sensitivity level of data associated with the inference request by analyzing the associated data against predefined sensitivity patterns to assign one of a plurality of privacy levels, wherein each privacy level maps to a set of permitted processing tiers. The permitted processing tiers comprise a hierarchical multi-tier system comprising at least a device tier comprising a plurality of end-user devices, an edge computing infrastructure tier comprising a plurality of edge nodes, a metro/regional coordination tier, and a data center tier, wherein the sensitivity level limits which processing tiers are eligible to process the inference request such that the inference request is excluded from processing at a tier prohibited by the privacy classification. The system is further configured to assess a data volume, a device resource state, and a network condition, and to select a target processing tier from among the permitted tiers based on a composite routing score derived from at least one of the computational complexity, the latency requirement, the data volume, the device resource state, and the network condition. The system compresses active session state of at least one inference pipeline using a compression method selected based on a model architecture identifier of the inference pipeline, wherein the compression method is selected from among a plurality of architecture-specific compression methods. The system predicts a destination edge node for a user device based on at least trajectory data and historical mobility patterns, computes a destination confidence score, and when the destination confidence score exceeds a threshold, initiates transfer of compressed session state to the predicted destination edge node before the user device exits a coverage area of a current edge node. At least two inference pipelines are co-located on a single edge node and exchange data via local shared memory, creating a closed-loop inference cycle in which an output of a first inference pipeline is consumed as an input by a second inference pipeline within a single inference cycle.

In accordance with one or more embodiments, a plurality of privacy levels comprises a regulated level constraining processing to the device tier or an edge node with encrypted audit logging.

In accordance with one or more embodiments, a plurality of architecture-specific compression methods implemented in the system comprises, for an inference pipeline having a state-space model architecture, extracting a fixed-size hidden state vector and applying delta encoding relative to a reference checkpoint state followed by structured sparsity encoding and adaptive quantization to produce a compressed state representation. For an inference pipeline having a transformer architecture, the system computes incremental key-value cache deltas relative to a prior checkpoint, scores tokens by importance, prunes tokens below an importance threshold, and applies low-rank factorization to produce a compressed state representation. For an inference pipeline having a convolutional neural network architecture, the system applies spatial downsampling to activation maps, retains activation peaks above a significance threshold, and applies a learned compression network to produce a compressed state representation.

In accordance with one or more embodiments, for the state-space model architecture, the compressed state representation has a size between 0.5 kilobytes and 8 kilobytes per active model instance.

In accordance with one or more embodiments, for the transformer architecture, a compression method provides a compression ratio between 50:1 and 100:1.

In accordance with one or more embodiments, a destination confidence score is computed as a weighted combination of at least one of the following: a trajectory certainty component derived from position, velocity, and heading data of the user device; a historical accuracy component derived from prediction accuracy for similar mobility patterns; a boundary proximity component indicating distance of the user device from a coverage area boundary of the current edge node; and a capacity projection component derived from resource availability telemetry of the predicted destination edge node.

In accordance with one or more embodiments, when the destination confidence score is between the threshold and a second threshold lower than the threshold, the system initiates partial state transfer comprising session metadata and model architecture identifiers without transferring full compressed session state, and when the destination confidence score is below the second threshold, the system defers state transfer until a handoff trigger condition is detected.

In accordance with one or more embodiments, the at least two co-located inference pipelines exchange data via local shared memory.

In accordance with one or more embodiments, a compressed session state is serialized into a self-describing compressed state payload data structure comprising at least one of the following: a model architecture identifier, a compression method identifier, quantization parameters, a layer count, per-layer compressed state data, session metadata including a user identifier and session identifier, and an integrity checksum.

In accordance with one or more embodiments, a plurality of edge nodes comprise at least one non-terrestrial edge node selected from the group consisting of a low-Earth-orbit satellite, a high-altitude platform station, and an unmanned aerial vehicle, and the system incorporates orbital trajectory data or flight path data of the at least one non-terrestrial edge node when computing the destination confidence score.

In accordance with one or more embodiments, when transferring compressed session state for a plurality of co-located inference pipelines, the system assembles compressed states for each pipeline into a unified session payload and transfers the unified session payload as a single transfer unit, the unified session payload comprising per-pipeline compressed state, cross-pipeline shared context, and session metadata.

In accordance with one or more embodiments, the system adjusts a compression aggressiveness parameter based on an available bandwidth between a source edge node and the predicted destination edge node, an estimated time remaining before the user device crosses a coverage area boundary, and a minimum quality-of-service threshold specified by the inference pipeline, to produce compressed session state that can be transferred within the estimated time at the available bandwidth while maintaining reconstruction quality above the minimum threshold.

In accordance with one or more embodiments, a computer-implemented method for distributed artificial intelligence inference is provided comprising receiving, at an end-user device, an inference task request and classifying, by one or more processors, a sensitivity level of data associated with the inference task request by analyzing the data against predefined sensitivity patterns to assign one of a plurality of privacy levels, each privacy level mapping to a set of permitted processing tiers. The method constrains eligible processing tiers to the set of permitted tiers corresponding to the assigned privacy level, wherein the constraining operates as a mandatory pre-filter applied before evaluating other routing factors whereby no combination of favorable scores on computational complexity, latency, data volume, device resource state, or network condition causes the inference task to be processed at a tier excluded by the privacy classification. The method further comprises computing a composite routing score for the inference task based on at least computational complexity, latency requirement, data volume, device resource state, and network condition, considering only tiers within the set of permitted tiers, selecting a target processing tier from the set of permitted tiers based on the composite routing score, and transmitting the inference task to the selected target processing tier for execution.

In accordance with one or more embodiments, wherein the inference task request contains data elements at different privacy levels, the method further comprises splitting the inference task request into sub-requests, each sub-request containing data elements at a single privacy level, routing each sub-request to a processing tier permitted by its respective privacy level, and recombining results from the sub-requests before returning to the requesting application.

In accordance with one or more embodiments, method such as those disclosed herein further comprise maintaining an audit log of instances where the mandatory pre-filter excludes a processing tier that would otherwise have the highest composite routing score, the audit log recording the excluded tier, the privacy level that caused exclusion, and the tier to which the inference task was routed instead.

In accordance with one or more embodiments, a computer-implemented method is capable of model-architecture-specific state compression in a distributed inference system is provided comprising receiving, at one or more processors, a request to compress session state of an inference pipeline executing at an edge node, and identifying an artificial intelligence model architecture of the inference pipeline from among at least a state-space model architecture, a transformer architecture, and a convolutional neural network architecture. The method selects a compression method based on the identified model architecture, wherein for the state-space model architecture, the compression method comprises extracting a fixed-size hidden state vector from each active model layer, applying delta encoding relative to a reference checkpoint state to produce a delta vector, applying structured sparsity encoding to the delta vector by encoding only dimensions that have changed by more than a configurable threshold, and applying adaptive quantization. For the transformer architecture, the method comprises computing incremental key-value cache deltas relative to a prior checkpoint, scoring tokens by importance based on attention weights, pruning tokens below an importance threshold, and applying low-rank factorization to remaining key-value pairs. For the convolutional neural network architecture, the compression method comprises applying spatial downsampling to activation maps, retaining activation peaks above a significance threshold with their spatial indices, and applying a learned compression network. The method applies the selected compression method to produce a compressed state payload comprising at least one of a model architecture identifier, a compression method identifier, quantization parameters, a layer count, per-layer compressed state data, session metadata, and an integrity checksum, and transmits the compressed state payload to a destination node for decompression and session state restoration.

In accordance with one or more embodiments, for the state-space model architecture, the compressed state payload has a size between 0.5 kilobytes and 8 kilobytes per active model instance, and for the transformer architecture, the compression method provides a compression ratio between 50:1 and 100:1.

In accordance with one or more embodiments, a method is available that further comprises determining an available bandwidth between the edge node and the destination node, determining a transfer time constraint based on a predicted time until a mobility handoff event, and adjusting a compression aggressiveness parameter by modifying at least one of the configurable threshold, a quantization level, and a pruning aggressiveness to produce a compressed state payload that can be transferred within the transfer time constraint at the available bandwidth while maintaining a reconstruction quality above a minimum threshold.

In accordance with one or more embodiments, wherein an inference pipeline comprises a plurality of co-located inference pipelines, the method further comprises compressing session state for each of the plurality of inference pipelines using a respective architecture-specific compression method, assembling the compressed states into a unified session payload, and transmitting the unified session payload as a single transfer unit.

In accordance with one or more embodiments, a compressed state payload further comprises a priority field, and the method further comprises, when a transfer is interrupted before completion, retransmitting compressed state data in order of the priority field such that highest-priority state data is restored first.

In accordance with one or more embodiments, wherein the request to compress session state is triggered by a model update event, the method further comprises compressing active session state at the edge node prior to deploying an updated model version, staging the updated model version at a tier one level above a target deployment tier, deploying the updated model version to the target deployment tier, and restoring the compressed session state into the updated model version to maintain session continuity across the model update.

In accordance with one or more embodiments, a system for predictive state pre-positioning in a distributed inference network is provided comprising a plurality of edge nodes, each edge node comprising at least one processor configured to execute at least one artificial intelligence inference pipeline. The system includes one or more first processors configured to execute stored computer readable instructions that configure the one or more processors to receive a plurality of signal inputs comprising at least trajectory data from a user device, historical mobility patterns associated with the user device, and capacity telemetry from candidate destination edge nodes, and to compute a composite destination confidence score for each candidate destination edge node based on at least one of a trajectory certainty component derived from the trajectory data, a historical accuracy component derived from the historical mobility patterns, a boundary proximity component indicating a distance of the user device from a coverage area boundary of a current edge node, and a capacity projection component derived from the capacity telemetry. The system includes one or more second processors configured to execute stored computer readable instructions that configure the one or more second processors to, when the composite destination confidence score for a candidate destination edge node exceeds a high-confidence threshold, initiate full state transfer comprising compressed session state for all active inference pipelines to the candidate destination edge node, when the composite destination confidence score is between the high-confidence threshold and a medium-confidence threshold, initiate partial state transfer comprising session metadata and model identifiers to the candidate destination edge node, and when the composite destination confidence score is below the medium-confidence threshold, defer state transfer. The compressed session state is produced by one or more processors that select a compression method based on a model architecture of each active inference pipeline from among a plurality of architecture-specific compression methods.

In accordance with one or more embodiments, one or more first processors are configured to compute the composite destination confidence score are further configured to receive network condition forecasts and application-level context signals as additional signal inputs, and to incorporate the additional signal inputs into the composite destination confidence score.

In accordance with one or more embodiments, upon initiating full state transfer, the system maintains a dual-connection state in which the user device is simultaneously connected to both the current edge node and the candidate destination edge node for a verification period, and releases the connection to the current edge node after verifying successful state restoration at the candidate destination edge node.

In accordance with one or more embodiments, one or more processors that are configured to initiate state transfer are further configured to coordinate transfer of compressed states for a plurality of co-located inference pipelines as a unified session payload comprising per-pipeline compressed state, cross-pipeline shared context, and session metadata.

In accordance with one or more embodiments, at least one of a plurality of edge nodes is a non-terrestrial edge node, and the one or more processors configured to compute the composite destination confidence score are further configured to incorporate orbital trajectory data or flight path data of the non-terrestrial edge node, and to account for signal propagation delay to the non-terrestrial edge node when determining transfer timing.

In accordance with one or more embodiments, a computer-implemented method is available for maintaining artificial intelligence inference session continuity during user mobility is provided comprising monitoring, by one or more processors, mobility signals for a user device with an active AI inference session at a first edge computing infrastructure node, predicting, based on the mobility signals, a destination edge computing infrastructure node, and compressing, by the one or more processors, the active AI inference session state using a compression technique selected based on a model architecture of the active inference session, wherein the compression technique is selected from among a plurality of architecture-specific compression techniques each adapted to exploit structural properties of a corresponding model architecture family. The method further comprises transferring the compressed session state to the predicted destination edge computing infrastructure node before the user device arrives at the destination, activating the session at the destination node upon arrival of the user device, and verifying session integrity at the destination node by comparing inference outputs against an expected baseline.

In accordance with one or more embodiments, an active AI inference session comprises a plurality of co-located inference pipelines, the method further comprises transferring compressed session state for all of the plurality of co-located inference pipelines as a unified session payload, the unified session payload preserving cross-pipeline consistency across the transition.

In accordance with one or more embodiments, two or more of the first processors, second processors, and third processors are implemented on common computing hardware at a single edge computing infrastructure node, such that the routing, compression, and prediction functions execute on shared processing resources.

In accordance with one or more embodiments, a distributed artificial intelligence inference system is provided comprising one or more processors and a computer-readable non-transitory medium comprising instructions that, when executed by the one or more processors, configure the system, for each inference request received from an end-user device, to: assess the request's computational complexity level; determine the request's latency criteria; classify a sensitivity level of data associated with the inference request; assess the data volume of the request, a device resource state, and a network condition; calculate a composite routing score derived from one of the following group: the request's computational complexity, latency requirement, the data volume, the device resource state, and the network condition; and select a target processing tier from a plurality of processing tiers based on the composite routing score. The system may further be configured to: select a compression method from a plurality of compression methods; compress active session state of at least one inference pipeline using the selected compression method; predict a destination edge node for a user device based on at least trajectory data and historical mobility patterns; and compute a destination confidence score for the predicted destination edge node, wherein when the destination confidence score exceeds a threshold, the system initiates transfer of the compressed session state to the predicted destination edge node before the user device exits a coverage area of a current edge node.

In accordance with one or more embodiments, a computer-implemented method for distributed artificial intelligence inference is provided comprising receiving, at an end-user device, an inference task request, and classifying, by one or more processors, a sensitivity level of data associated with the inference task request by analyzing the data against predefined sensitivity patterns to assign one of a plurality of privacy levels, each privacy level mapping to a set of permitted processing tiers. The method may further constrain eligible processing tiers to the set of permitted tiers, computes a composite routing score for the inference task, selects a target processing tier from the set of permitted tiers based on the composite routing score, and transmits the inference task to the selected target processing tier for execution.

In accordance with one or more embodiments, a computer-implemented method for model-architecture-specific state compression in a distributed inference system is provided comprising receiving, at one or more processors, a request to compress session state of an inference pipeline executing at an edge node, and identifying an artificial intelligence model architecture of the inference pipeline from among at least a state-space model architecture, a transformer architecture, and a convolutional neural network architecture. The method may further select a compression method based on the identified model architecture, applies the selected compression method to produce a compressed state payload, and transmits the compressed state payload to a destination node for decompression and session state restoration.

In accordance with one or more embodiments, a computer-implemented method for maintaining artificial intelligence inference session continuity during user mobility is provided comprising monitoring, by one or more processors, mobility signals for a user device with an active AI inference session at a first edge computing infrastructure node, and predicting, based on the mobility signals, a destination edge computing infrastructure node. The method may further comprise compressing, by the one or more processors, the active AI inference session state using a compression technique selected based on a model architecture of the active inference session, wherein the compression technique is selected from among a plurality of architecture-specific compression techniques. The method may further comprise transferring the compressed session state to the predicted destination edge computing infrastructure node before the user device arrives at the destination, and activating the session at the destination node upon arrival of the user device.

### BRIEF DESCRIPTION OF THE DRAWINGS

The following drawings form part of the present specification and are included to further demonstrate certain aspects of the present invention(s). The invention may be better understood by reference to one or more of these drawings in combination with the detailed description of specific embodiments presented herein. Each of the figures described below is in accordance with the invention(s) described throughout this disclosure.

FIG. 1 illustrates a distributed, multi-tier AI inference system in accordance with one or more embodiments of the present invention.

FIG. 2 (comprising FIGS. 2A and 2B) illustrates a workload distribution controller and routing decision logic in accordance with one or more embodiments of the present invention.

FIG. 3 (comprising FIGS. 3A and 3B) illustrates privacy-controlled tier selection in accordance with one or more embodiments of the present invention.

FIG. 4 (comprising FIGS. 4A and 4B) illustrates device tier components and task routing in accordance with one or more embodiments of the present invention.

FIG. 5 (comprising FIGS. 5A and 5B) illustrates a task lifecycle flow from initiation through completion in accordance with one or more embodiments of the present invention.

FIG. 6 (comprising FIGS. 6A and 6B) illustrates a model-specific state compression pipeline in accordance with one or more embodiments of the present invention.

FIG. 7 (comprising FIGS. 7A and 7B) illustrates a predictive routing engine in accordance with one or more embodiments of the present invention.

FIG. 8 (comprising FIGS. 8A and 8B) illustrates session continuity and a multi-phase handoff protocol in accordance with one or more embodiments of the present invention.

FIG. 9 (comprising FIGS. 9A and 9B) illustrates asynchronous task completion and device behavior in accordance with one or more embodiments of the present invention.

FIG. 10 illustrates a model update distribution flow in accordance with one or more embodiments of the present invention.

FIG. 11 illustrates the distributed AI inference system applied to real-time multilingual speech translation for interactive communication in accordance with one or more embodiments of the present invention.

FIG. 12 illustrates the distributed AI inference system applied to real-time multilingual speech translation for interactive education in accordance with one or more embodiments of the present invention.

FIG. 13 illustrates the distributed AI inference system applied to real-time multilingual speech translation for telemedicine with jurisdictional boundary constraints in accordance with one or more embodiments of the present invention.

FIG. 14 illustrates the distributed AI inference system applied to real-time multilingual speech translation for in-venue events in accordance with one or more embodiments of the present invention.

FIG. 15 illustrates the distributed AI inference system applied to real-time multilingual speech translation for social media live streaming in accordance with one or more embodiments of the present invention.

FIG. 16 illustrates the distributed AI inference system applied to in-play sports betting operations for real-time odds calculation in accordance with one or more embodiments of the present invention.

FIG. 17 illustrates the distributed AI inference system applied to in-play sports betting operations for computer vision event detection in accordance with one or more embodiments of the present invention.

FIG. 18 illustrates the distributed AI inference system applied to in-play sports betting operations for fraud and risk management in accordance with one or more embodiments of the present invention.

FIG. 19 illustrates the distributed AI inference system applied to in-play sports betting operations for personalized recommendations in accordance with one or more embodiments of the present invention.

FIG. 20 illustrates an integrated four-pipeline architecture for in-play sports betting operations with cross-pipeline data flows in accordance with one or more embodiments of the present invention in accordance with one or more embodiments of the present invention.

FIG. 21 illustrates the distributed AI inference system applied to augmented reality navigation for spatial understanding in accordance with one or more embodiments of the present invention.

FIG. 22 illustrates the distributed AI inference system applied to augmented reality navigation for visual scene understanding in accordance with one or more embodiments of the present invention.

FIG. 23 illustrates the distributed AI inference system applied to augmented reality navigation for translation in accordance with one or more embodiments of the present invention.

FIG. 24 illustrates an integrated three-pipeline architecture for augmented reality navigation with cross-pipeline data flows and mobility handoff in accordance with one or more embodiments of the present invention.

FIG. 25 illustrates end-to-end latency comparisons between edge-enabled deployment and cloud-only deployment for the real-time voice translation embodiment in accordance with one or more embodiments of the present invention.

FIG. 26 illustrates end-to-end latency comparisons between edge-enabled deployment and cloud-only deployment for the sports betting embodiment in accordance with one or more embodiments of the present invention.

FIG. 27 illustrates end-to-end latency comparisons between edge-enabled deployment and cloud-only deployment for the augmented reality navigation embodiment in accordance with one or more embodiments of the present invention.

FIG. 28 (comprising FIGS. 28A and 28B) illustrates a model deployment and distribution pipeline in accordance with one or more embodiments of the present invention.

FIG. 29 (comprising FIGS. 29A and 29B) illustrates device-tier concurrent task management in accordance with one or more embodiments of the present invention.

FIG. 30 illustrates end-to-end latency breakdowns across four execution paths of the system in accordance with one or more embodiments of the present invention in accordance with one or more embodiments of the present invention.

### DETAILED DESCRIPTION OF PREFERRED EMBODIMENTS

The following description sets forth specific details in order to provide a thorough understanding of the invention. It will be apparent to those skilled in the art that the present invention may be practiced without some or all of these specific details. In some instances, well-known features have not been described in detail to avoid unnecessarily obscuring the invention. In addition, the present invention may be practiced in combination with various conventional techniques not specifically described herein.

In accordance with the principles of the invention, systems, methods and computer readable medium are provided that address technical problems that arise in implementing AI inference systems (e.g., that are deployed at the network edge and/or are distributed)

In general, workload distribution mechanisms optimize for latency, throughput, and computational cost but do not treat data sensitivity as a first-class or primary routing constraint (or at all). When an inference request involves biometric identifiers, medical information, financial details, or other sensitive content, systems may route the request to whichever processing minimizes latency or cost without regard to whether the data should be processed closer to the data source for privacy, security, or regulatory reasons.

Another problem relates to AI inference workloads differing from stateless web requests in that many AI models accumulate significant computational context during a session. For example, a neural machine translation model accumulates vocabulary preferences, language identification, and domain terminology context. A spatial understanding model accumulates an environmental map. A temporal analysis model accumulates a running representation of event sequences. When a user moves from one edge node coverage area to another (as an example), this accumulated computational state must either be discarded (causing a cold start with degraded performance) or transferred to the new serving edge node. Existing systems provide no mechanism for such transfer, much less a mechanism adapted to the specific structure of different AI model architectures.

Another problem relates to mobility such as the mobility of end devices in relation to other processing nodes. Embodiments of the present invention are configured to predictively pre-position inference session state at destination edge nodes based on mobility prediction. Even if state transfer were supported, initiating transfer only after a user arrives at a new edge node coverage area introduces an interruption during which the session cannot be served. Predictive approaches that anticipate user mobility and transfer state in advance are not addressed in existing edge computing architectures.

When a user with an active AI inference session moves from one edge node coverage area, one option is to restart the inference session from scratch at the new edge node, a cold start may discard all accumulated context and requires the model to rebuild its internal representation from the ground up. For a neural machine translation model that has accumulated thousands of tokens of conversational context, or a spatial understanding model that has built an environmental map over minutes of observation, this cold start represents a significant loss of accumulated computational investment and a degradation in inference quality. It adds processing burden and potential time delays to reestablish the session. Another option is to continue routing all inference requests back to the original edge node, which may defeat the purpose of edge proximity. As the user moves further from the original node, latency increases and may exceed application requirements, while the edge node continues to hold resources for a user who is no longer in its geographic service area. The growing class of stateful AI inference applications where accumulated context represents both significant computational investment and meaningful improvements in inference quality and personalization may be degraded or inefficient in such options.

In accordance with one or more embodiments of the present invention, a system is provided that dynamically routes inference workloads based on data sensitivity as a first-class (or primary) routing parameter; that compresses and transfers active AI model state between edge nodes using techniques adapted to the specific model architecture during user mobility; and that predictively pre-positions compressed session state at destination edge nodes before user arrival to minimize session interruption.

In some embodiments, the distributed AI inference processing system (e.g., nodes therein) is physically co-located in the same facility or physical structure (or rack etc.) that is deployed or configured to establish general network communications infrastructure for the end devices to be able to communicate with other devices or receive services. For example, mobile (e.g., cellular) devices are supported by communications networks that provide the communications channel between users and/or between a user and desired application services. This can include, for example, towers and base stations. Preferably, the distributed AI inference processing system is co-located with this network communications infrastructure and/or could be implemented on the hardware, computers, etc. that reside at such locations (rather than necessarily installing additional hardware equipment at the location.)

### GLOSSARY OF TERMS

The following terms, as used throughout this specification and in the claims, have the meanings set forth below unless the context clearly dictates otherwise.
“AI model” refers to a parameterized computational model comprising interconnected processing layers with learned numerical parameters (weights and/or biases) trained on data to perform inference tasks. As used herein, AI models include but are not limited to neural network architectures such as state-space models, transformers, convolutional neural networks, recurrent neural networks, and hybrid architectures combining elements thereof. As used herein, AI models are distinguished from rule-based systems, decision trees, and lookup tables by the presence of learned parameters determined through training processes on representative data.
“Acceleration-capable processing unit” or “accelerator” refers to a processor architecturally optimized for AI/ML inference workloads, including graphics processing units (GPUs), neural processing units (NPUs), tensor processing units (TPUs), and similar parallel processing hardware designed to perform tensor operations at higher throughput than general-purpose central processing units.
“Edge computing infrastructure node (edge node)” refers to a computing device topologically located at the network edge including but not limited to: (a) terrestrial installations such as cellular towers, utility poles, lamp posts, rooftop installations, building-mounted equipment, street furniture, traffic infrastructure, small cells, macro cells, micro cells, pico cells, and femtocells; (b) mobile terrestrial units such as mobile edge computing vehicles and deployable field computing platforms; (c) non-terrestrial platforms such as low-earth orbit satellite computing nodes, medium-earth orbit satellite computing nodes, geostationary orbit satellite computing nodes, high-altitude platform systems including stratospheric stations and solar-powered unmanned aerial vehicles, unmanned aerial vehicle based mobile computing platforms, and airborne computing nodes; (d) maritime platforms such as shipborne computing nodes and offshore platform computing installations; or (e) any other fixed or mobile computing infrastructure, whether terrestrial, aerial, orbital, or maritime, positioned between end-user devices and centralized data centers. The edge computing infrastructure node is preferably network-agnostic and may connect to end-user devices and backhaul networks via cellular, WI-FI®, satellite link, free-space optical, or any other communication technology.
“Task” refers to a single AI inference workload request. An AI inference workload request is one or more digital messages or structures (e.g., comprising a prompt) generated to have a particular inference task performed by the model to provide a resulting AI inference (output) to the requesting device (e.g., application on the device). Tasks may be batched or sequential within a session.
“Handoff” refers to the process of transferring an active AI inference session from one edge computing infrastructure node to another without material or significant interruption of session continuity and/or model state (e.g., while maintaining session continuity and model state).
“Session state” refers to the context required to continue AI inference including but not limited to model hidden states, attention caches, conversation history, user preferences, accumulated environmental context, and position encodings.
“State-space model (SSM)” refers to A class of neural network architectures that process sequences through linear recurrence relations, maintaining a fixed-size hidden state vector that summarizes all prior input, achieving O(n) time complexity and O(1) per-step memory complexity for sequence processing.
“Overlay Renderer” refers to a component that composites visual information on top of an existing visual field. Used extensively in computer graphics, augmented reality (AR), and virtual reality (VR), gaming, and related fields.
“Privacy classification” refers to a categorical assessment of the sensitivity (e.g., with respect to privacy) of data contained in an inference request and which is the subject of the inference request, used as a routing parameter to constrain which processing tiers (or nodes) are permitted to handle the request (or are blocked or avoided).
“Tier” refers to a level or computing device or nodes in a level in the hierarchical processing architecture. The system comprises at least a end-device tier, an edge computing infrastructure tier, and a data center tier, and optionally a metro/regional coordination tier.
“Compressed state payload” refers to a data structure containing serialized, compressed AI inference session state in a format for transfer between edge computing infrastructure nodes, including at minimum a model architecture identifier, compression method indicator, quantization parameters, integrity verification data, and per-layer compressed state data containing the actual compressed state for each model layer (“state data”).
“Co-located inference” refers to a deployment configuration in which multiple interdependent AI inference pipelines execute on shared computing infrastructure at a single edge node, where cross-pipeline data exchange occurs through local shared memory (e.g., shared memory segments, memory-mapped files, or in-process data structures) rather than through network interfaces. This co-location enables cross-pipeline data exchange at microsecond latency rather than the millisecond-scale latency of network-based communication.
“Metro/regional coordination tier” refers to an intermediate infrastructure tier positioned between edge computing infrastructure nodes and centralized data centers, providing aggregation of cross-session analytics, orchestration coordination across a plurality of edge nodes within a metropolitan or regional geographic area, overflow processing capacity for inference tasks that exceed individual edge node capacity, model distribution coordination, compliance and audit services, and/or fallback inference for models too large for edge deployment. Concrete examples include metropolitan data centers, regional aggregation facilities, metropolitan area network hubs, and regional cloud availability zones. Communication between the metro/regional coordination tier and the edge computing infrastructure tier is preferably asynchronous.
“Inference proxy” refers to a programmable gateway (a combination of a computer and software) that receives incoming AI inference requests and forwards each request to the appropriate model-serving backend, based on routing directives from the workload distribution controller.
“Inference request” refers to a message or data structure submitted to a deployed AI model to obtain a prediction, classification, translation, or other computational output based on the model's learned parameters and the submitted input data.
“Inference session” or “AI inference session” refers to a persistent computational context established between a requesting application and one or more AI model serving backends, during which the model accumulates state (such as hidden state vectors, attention caches, conversation history, and contextual preferences) that affects subsequent inference outputs within the session. In certain embodiments, a session persists across multiple inference requests until explicitly terminated or timed out.
“Local shared memory” refers to an inter-process communication mechanism in which co-located inference pipelines on a single edge node exchange data through shared memory segments (e.g., POSIX shared memory, memory-mapped files, or in-process data structures) accessible to multiple pipelines without traversing any network protocol stack. This enables cross-pipeline data exchange at microsecond latency, orders of magnitude faster than network-based communication between the same pipelines.
“Model serving backend” refers to a computational process executing a loaded AI model and accepting inference requests, producing inference results, and reporting resource utilization metrics.
“Processing node” or “Node” refers to a physical or virtual device, system, or connection point capable of sending, receiving, or forwarding data and configured to provide processing capabilities to the overall system or service in which it is established.
“State data” refers to digital representations of the model's internal computational state for each active layer.
“Orchestration agent” refers to a software module executing on a computing device that autonomously monitors system conditions, makes decisions based on predefined policies and learned patterns, and initiates actions such as inference routing, state compression, state transfer, and model deployment without requiring per-action human intervention. The system comprises orchestration agents at multiple tiers: device-tier orchestration agents (ie—Local Orchestration Agent 116) that make local routing and offload decisions, edge-tier orchestration agents that manage inference pipeline execution and cross-pipeline coordination, and metro/regional-tier orchestration agents that coordinate across multiple edge nodes. These orchestration agents collectively form a multi-agent system in which agents at different tiers cooperate to optimize inference latency, resource utilization, and privacy compliance.
“Module” refers to a combination of hardware and/or software implemented to deploy the module operation.

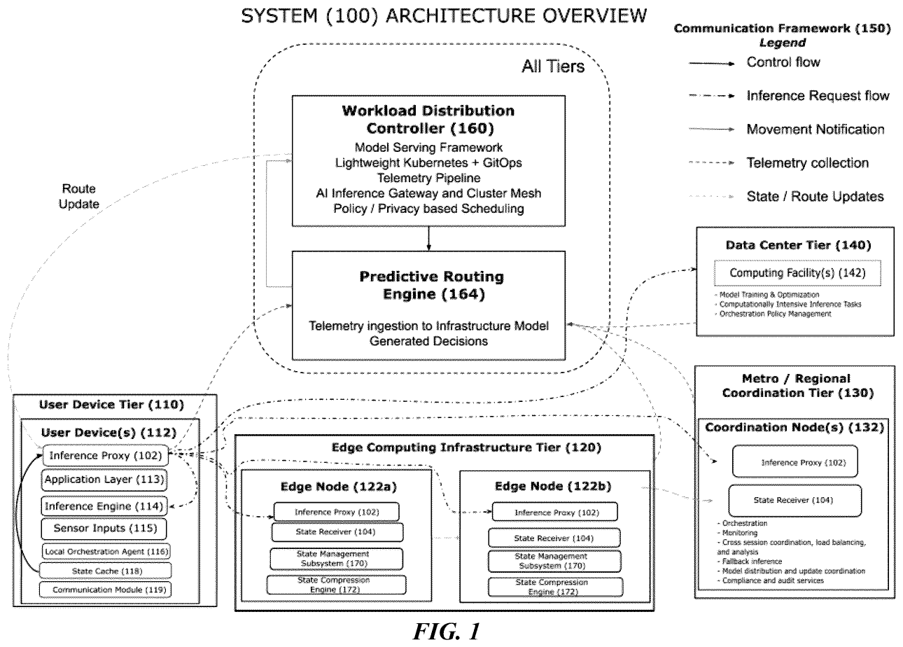

### System Architecture Overview (FIG. 1)

Referring now to FIG. 1, there is shown a multi-tier system architecture overview of a distributed AI inference system in accordance with one or more embodiments of the present disclosure. The system 100 comprises a hierarchical multi-tier architecture with four processing tiers: a device tier 110, an edge computing infrastructure tier 120, a metro/regional coordination tier 130, and a data center tier 140. The tiers are interconnected via communication paths 150. A workload distribution controller 160, which functions as a distributed inference gateway, manages the routing of AI inference requests across the tiers. In certain embodiments, a state management subsystem handles session state compression, transfer, and restoration during mobility events.

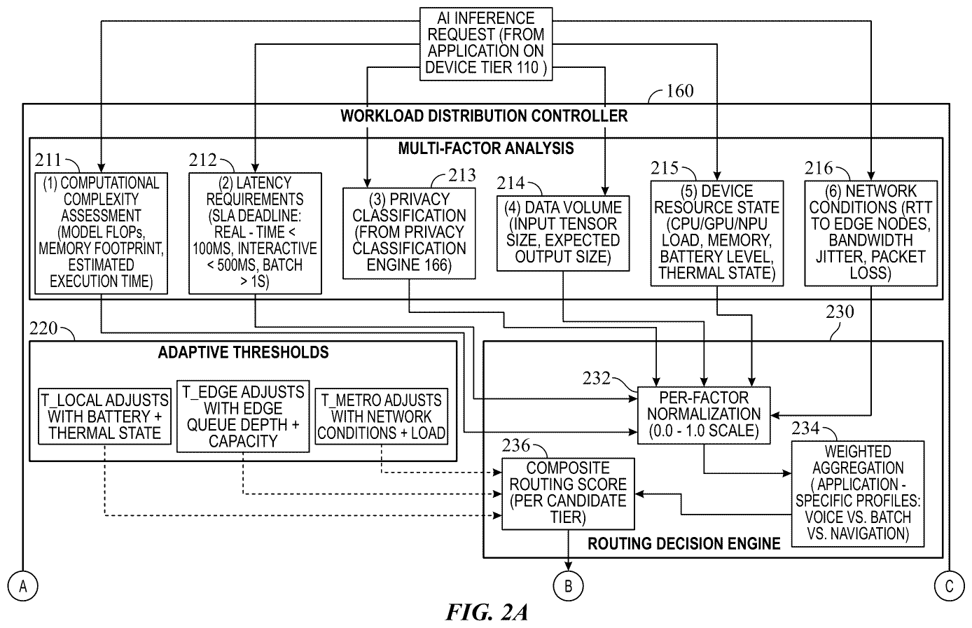

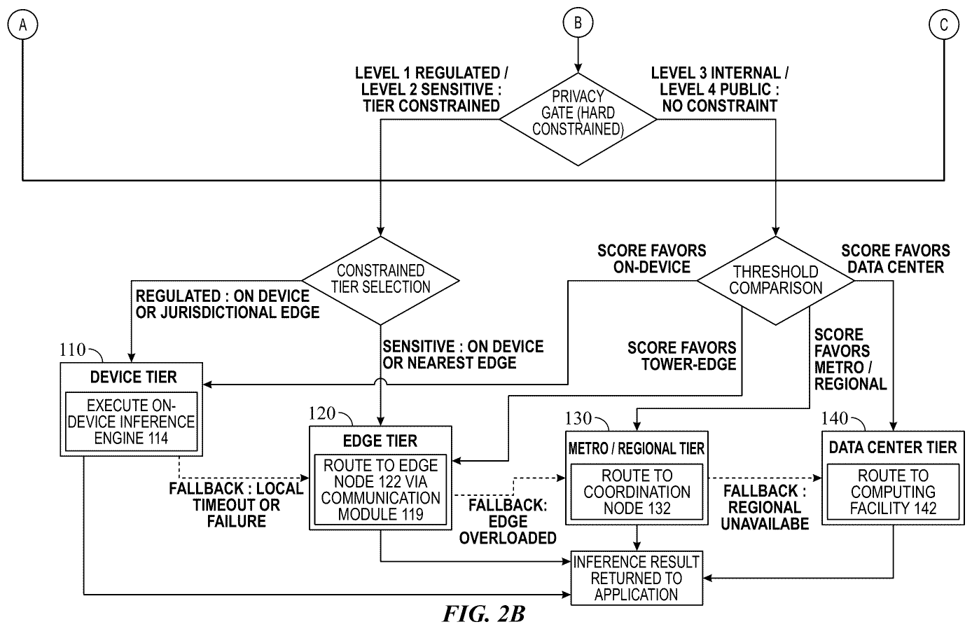

The system 100 operates as a distributed inference fabric that proxies incoming inference requests and forwards each request to the optimal model serving backend for processing. The determination of the optimal backend is made by the workload distribution controller 160 based on a composite routing decision that considers at least six factors: computational complexity of the inference task, latency requirements, privacy classification of the input data, data volume, device resource state, and current network conditions, as described in further detail with reference to FIG. 2.

### Hierarchical Multi-Tier Architecture

The hierarchical multi-tier architecture of system 100 may organize processing resources into tiers ordered by proximity to the end user, measured by network round-trip latency, which correlates with but is not limited to geographic distance. In certain embodiments, each successive tier provides greater computational capacity at the cost of increased latency. At the lowest tier, the user device tier 110 provides the closest processing to the user with minimal latency but limited computational resources. The edge computing infrastructure tier 120 provides substantially greater computational resources within sub-100 millisecond round-trip latency in certain embodiments. The metro/regional coordination tier 130 provides coordination, fallback, and cross-edge-node services asynchronously. The data center tier 140 provides the greatest computational resources for tasks that exceed edge capacity, model training, and system-wide management.

Each tier may comprise a plurality of processing nodes (a physical or virtual device, system, or connection point capable of sending, receiving, or forwarding data and configured to provide processing capabilities to the overall system or network in which it is established). In certain embodiments, the workload distribution controller 160 operates as a system-level control plane with primary orchestration logic deployed at the metro/regional tier 130 and local orchestration agents distributed at the device tier 110 and the edge computing infrastructure tier 120. This distributed architecture can ensure that latency-critical routing decisions can be made locally at the edge tier without requiring a round-trip to the metro or data center tiers, while system-wide policy management and cross-edge coordination are handled by the primary control plane at the metro/regional tier.

### Device Tier 110

The device tier 110 comprises user device(s) 112. Examples of user device(s) 112 include but are not limited to smartphones, AR/VR headsets, Internet of Things devices, autonomous vehicles, wearable computing devices, kiosks, and terminals. In certain embodiments, each end-user device operates within a power envelope of approximately 5 to 40 watts and may include one or more of the following components.

An on-device inference engine 114 is configured to execute quantized AI models locally on a device. The inference engine 114 supports lightweight inference tasks that fall within the device's computational budget, including but not limited to text classification, simple language model inference, basic object detection, and audio preprocessing. In certain embodiments, the inference engine 114 maintains a local model registry indicating which AI models are currently loaded and available for local execution.

A local orchestration agent 116 is configured to assess the complexity of incoming inference requests and make routing decisions. The local orchestration agent 116 functions as a local inference gateway that receives inference requests from the application layer and determines whether each request should be processed locally on an on-device inference engine 114 or forwarded to the edge computing infrastructure tier 120. The agent 116 makes this determination based on one or more of the following: a task complexity estimate derived from the request type and input characteristics, current device resource utilization (processor load, memory availability, battery level, thermal state), availability of the required model in the local model registry, the latency requirement specified by the application, and the privacy classification of the input data. The local orchestration agent 116 is programmable such that the control plane logic from the workload distribution controller 160 can update routing directives, and the system ensures that a new backend is fully ready before updating the agent's routing table.

A state cache 118 maintains local copies of session state including recent inference results, model weight caches, and session state snapshots. The state cache 118 enables the device(s) 112 to continue serving cached responses to the user interface while inference requests are being processed at a remote tier, and to preserve session state as a fallback in the event of a handoff failure.

A communication module 119 connects the user device(s) 112 to one or more edge computing infrastructure nodes (e.g., nearest nodes) via a network interface. The communication module 119 supports edge discovery (identifying available edge nodes and their capabilities), secure transport for inference request and result transmission, and telemetry reporting. The system 100 collects categories of metrics from the device comprising one or more of the following: application metrics describing inference request patterns, compute engine metrics describing device resource utilization, model serving metrics describing local inference performance, and network metrics describing connection quality to available edge nodes. These metrics are collected by a metric collector and reported to the workload distribution controller 160, which uses them as inputs to the predictive routing engine 164.

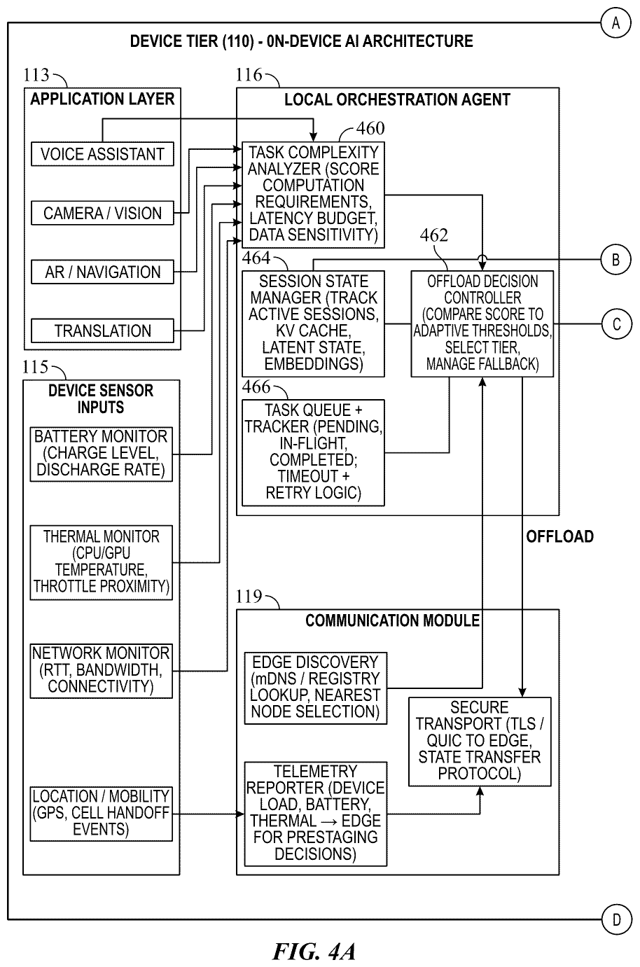

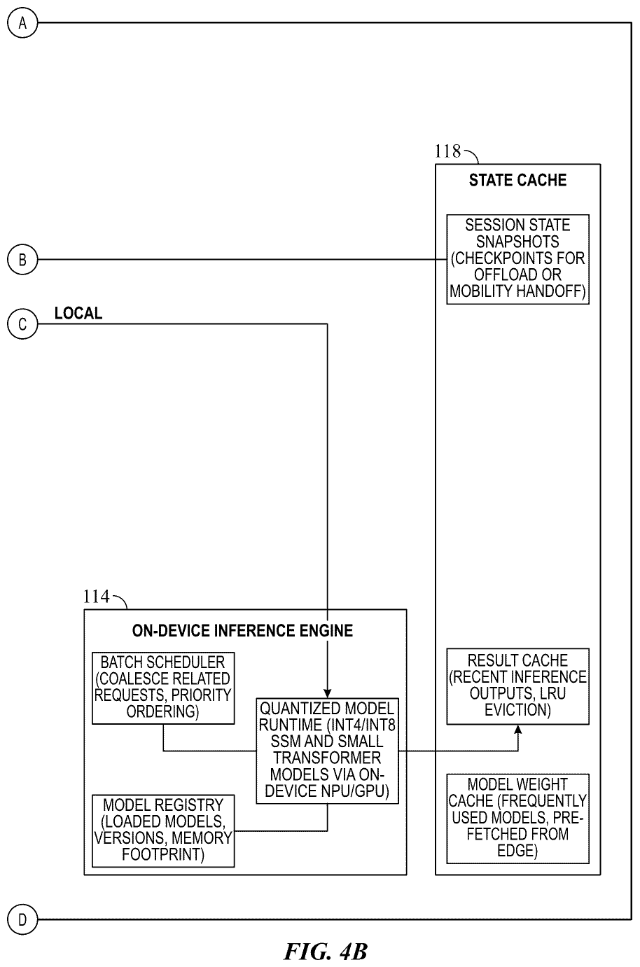

Further details regarding the application layer 113, the device sensor inputs 155, and other components of the device tier 110 are provided in the section corresponding to FIG. 4 below.

The system 100 gives preference to device-local AI model serving. That is, if the required model is already loaded on the device(s) 112 of the user device tier 100, or if there is sufficient compute capacity to serve the model locally, the local orchestration agent 116 schedules the workload locally on the device(s) 112. When local processing is not feasible or when a higher-tier backend would provide substantially better results, the agent 116 forwards the request through the communication module 119 to the nearest edge node (122a or 122b).

### Edge Computing Infrastructure Tier 120

In certain embodiments, the edge computing infrastructure tier 120 comprises a plurality of edge computing infrastructure nodes 122 (as depicted here, 122a and 122b, and alternatively referred to as “edge nodes”) distributed across geographic locations. In certain embodiments, edge nodes 122 comprise acceleration-capable processing units configured for AI inference operations including matrix multiplication, convolution, and other tensor operations; sufficient memory for concurrent execution of multiple AI models; non-volatile storage for model weights and configuration; a thermal management subsystem; a power management subsystem supporting multiple input sources including grid power and renewable energy; and a connectivity module supporting multiple network interfaces.

In certain embodiments, each edge node 122 hosts one or more AI inference models and is configured to serve inference requests from nearby the user device(s) 112 with sub-100 millisecond round-trip latency. Each edge node 122 of certain embodiments includes an inference proxy 102 that receives incoming inference requests and routes each request to the appropriate model serving backend. Edge nodes communicate with neighboring edge nodes via backhaul connections for state transfer during mobility handoffs. Edge nodes report resource utilization and availability to the workload distribution controller 160 via telemetry channels. In certain embodiments, each edge node 122 comprises a state management component 170 and a compression engine 172 for compressing session state prior to transfer, as well as a state receiver 104 for receiving and decompressing transferred session state from neighboring edge nodes.

Edge nodes 122 may be installed in various locations that include but are not limited to cellular towers, utility poles, rooftop installations, building-mounted equipment, street furniture, traffic infrastructure, small cells, macro cells, micro cells, pico cells, and femtocells. These locations are terrestrial (i.e., land-based), however the edge computing infrastructure tier 120 is not limited to terrestrial installations. In some embodiments, the plurality of edge computing infrastructure nodes 122 includes non-terrestrial edge nodes 122 such as computing platforms deployed on low-earth orbit (LEO) satellites, medium-earth orbit (MEO) satellites, high-altitude platform systems (HAPS) including stratospheric stations and solar-powered unmanned aerial vehicles, and unmanned aerial vehicle based mobile computing platforms. Non-terrestrial edge computing infrastructure nodes share the same functional role as terrestrial nodes within the multi-tier architecture: they receive inference requests from nearby devices, execute AI inference models, participate in state transfer during mobility handoffs, and report resource availability to the workload distribution controller 160.

Non-terrestrial edge computing infrastructure nodes present characteristics distinct from terrestrial installations. A LEO satellite node, for example, typically provides broader geographic coverage per node than a terrestrial tower installation, but the satellite node itself moves relative to the ground at orbital velocity such that its coverage area shifts continuously. The system 100 accommodates this by treating non-terrestrial node coverage areas as time-varying: the predictive routing engine 164 incorporates edge node position and trajectory data for non-terrestrial nodes in addition to user position and trajectory when computing handoff predictions. Power and thermal constraints for non-terrestrial nodes may differ from terrestrial installations, and the workload distribution controller 160 accounts for these differences when routing inference requests.

In certain embodiments, the edge computing infrastructure tier 120 comprises a heterogeneous mix of terrestrial and non-terrestrial nodes. For example, in an urban environment, the tier 120 may comprise primarily terrestrial tower-mounted and building-mounted nodes, while in a rural, maritime, or remote environment the tier may comprise primarily satellite-based or HAPS-based nodes, with the workload distribution controller 160 routing inference requests to whichever available node best satisfies the composite routing criteria, regardless of whether the node is terrestrial or non-terrestrial.

### Metro/Regional Coordination Tier 130

The metro/regional coordination tier 130 comprises one or more metro/regional coordination node(s) 132 (alternatively referred to as “metro clusters”) that provide services that support inference path. In certain embodiments, this tier 130 is configured to optimize for latency-sensitive use cases by never blocking the critical path of an inference request and operating asynchronously. In this context, not blocking the critical path means that inference requests are routed to the next available compute resource capable of handling the inference task, rather than being queued or delayed waiting for a specific resource to become available.

Orchestration and monitoring by the coordination node(s) 132 provides system-level management of the workload distribution controller 160, including policy updates, model serving framework management, container orchestration coordination, telemetry pipeline aggregation, and inference gateway configuration. In a preferred embodiment, the orchestration system employs a lightweight container orchestrator with declarative configuration management for deploying and updating model serving backends across the edge node(s) 122. Lightweight container orchestrators provide efficient, low-overhead container management, ideal for edge computing, IoT, and small-scale deployments. Key solutions include K3s (minimal KUBERNETES®), Docker Swarm (native, simple DOCKER® integration), and HASHICORP® Nomad (flexible, single-binary). These tools reduce resource consumption compared to full-featured KUBERNETES®.

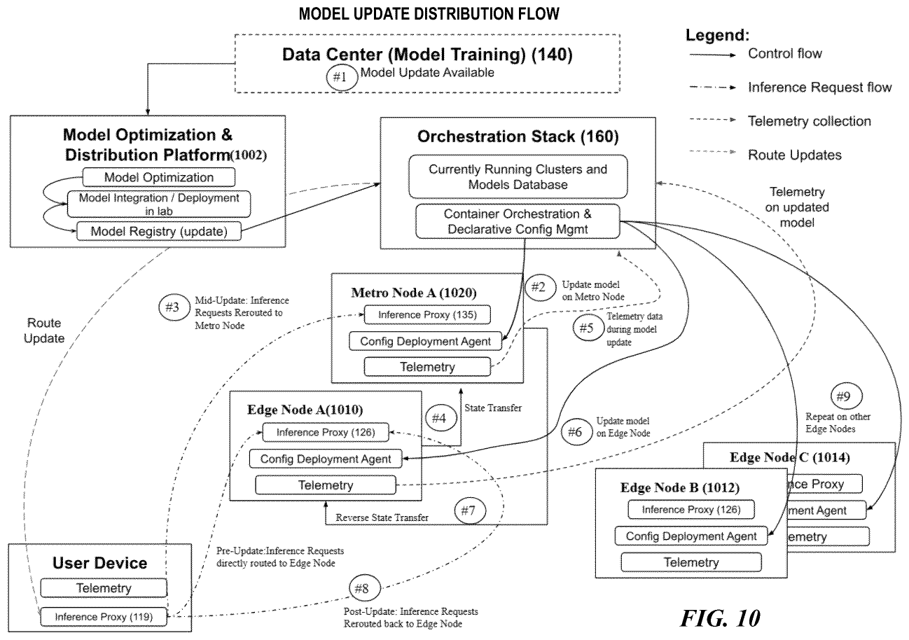

Cross-session analysis by the coordination node(s) 132 aggregates inference patterns across multiple user sessions and multiple edge nodes to identify trends, optimize model placement, and improve routing decisions. Cross-edge-node coordination and load balancing by the coordination node(s) 132 distributes workload across edge nodes 122 when individual nodes approach capacity limits. Fallback inference may provide processing for inference tasks that exceed the computational capability of available edge nodes, including rare or complex inference requests that require models that are too large for deployment on edge node(s) 122. Certain embodiments employ model distribution and update coordination features to manage the distribution of model updates from the data center tier 140 to the edge computing infrastructure tier 120, as described in further detail with reference to FIG. 10. Compliance and audit services may operate to maintain encrypted audit logs for regulatory compliance, particularly for inference requests classified at the regulated or sensitive privacy levels.

### Data Center Tier 140

The data center tier 140 comprises high-performance computing facilities 142 providing three primary functions. First, model training and optimization: the data center tier 140 trains AI models using aggregated and anonymized data, optimizes trained models for edge deployment through quantization, pruning, and distillation, and generates differential model updates for distribution to edge nodes. Second, complex inference: the data center tier 140 handles inference tasks that require computational resources exceeding what is available at the edge computing infrastructure tier 120, or that require access to large-scale reference datasets not suitable for edge storage. The data center tier 140 serves as a high-precision, high-compute, high-memory-capacity fallback when edge resources are insufficient. Third, orchestration policy management: the data center tier 140 defines and distributes the routing policies, privacy classification rules, and compression parameters used by the workload distribution controller 160 at lower tiers.

In certain embodiments, the data center tier 140 connects to the metro/regional coordination tier 130 via aggregation networks. In certain embodiments, normal operation of the system does not include the data center tier 140 as part of a latency-critical inference path; inference requests in such embodiments reach the data center tier 140 only when (a) the request exceeds the computational capacity of all available edge and metro tier resources, (b) the request requires access to training data or large reference datasets stored at the data center, or (c) no edge node 122 with the required model is available and the metro tier fallback is also unavailable.

### Communication Framework 150

The communication framework 150 defines the interconnection topology among the tiers of the system 100. In certain embodiments, device-to-edge communication occurs via wireless network interfaces including but not limited to cellular networks, WI-FI®, satellite links, and free-space optical connections. The system 100 is network-agnostic and can leverage existing communications infrastructure without requiring any specific network technology. Edge-to-edge communication may occur via backhaul connections for state transfer during mobility handoffs. Edge-to-metro and edge-to-data-center communication may occur via aggregation networks.

In certain embodiments(s), the communication framework 150 supports five categories of data flow, as illustrated in FIG. 1: (a) control flow (black, solid arrows), comprising routing directives, policy updates, and configuration management from the workload distribution controller 160 to processing nodes at each tier; (b) inference request flow (black, dashed & dotted arrows) comprising the transmission of inference requests from the user device(s) 112 to processing nodes and the return of inference results; (c) movement notification (light gray, solid arrows), comprising mobility signals from the user device(s) 112 to the predictive routing engine 164; (d) telemetry collection (dashed, dark gray arrows), comprising resource utilization, performance metrics, and health status from processing nodes at all tiers to the orchestration and monitoring system; and (e) state and route updates (dashed, light gray arrows), comprising compressed session state transfers between edge nodes 122 during mobility handoffs and routing table updates to device proxies.

The connections depicted in FIG. 1 representing the communication framework 150 are illustrative rather than exhaustive, and are not intended to limit the architecture to only the specific links shown. Additional communication paths between the various tiers and components, though not explicitly depicted, are fully contemplated and would not depart from the scope of the invention(s) disclosed herein.

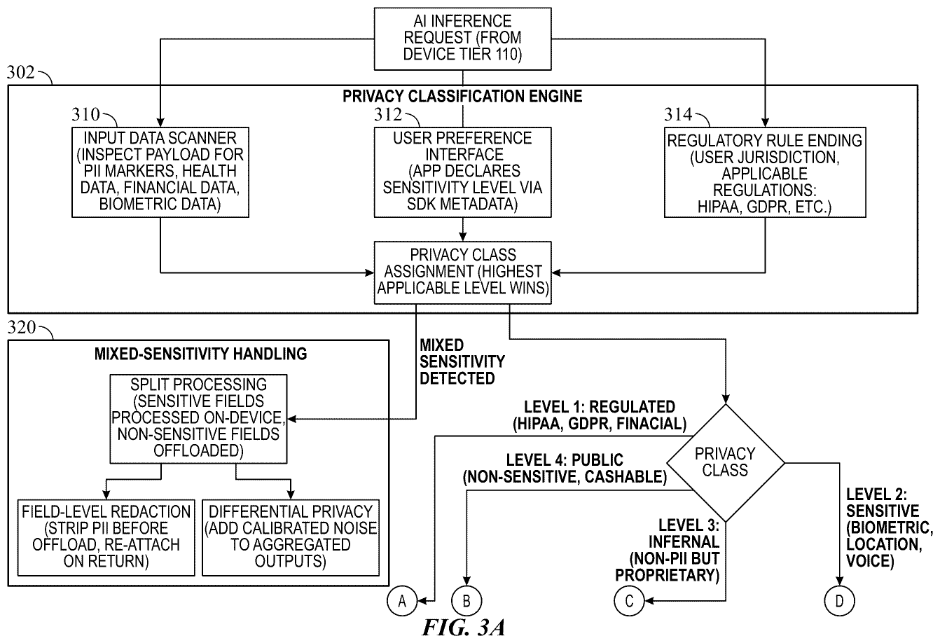

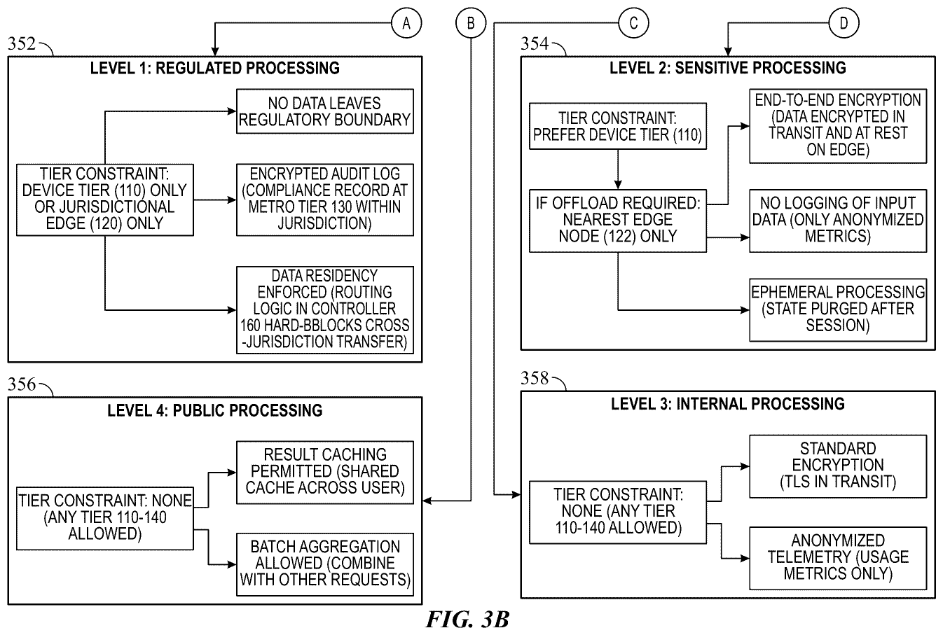

### Workload Distribution Controller and Routing Decision Logic (FIGS. 2-3)

### Multi-Factor Routing Decision Logic (FIG. 2)

Referring now to FIG. 2, there is shown a block diagram of the workload distribution controller 160 and its routing decision logic in accordance with one or more embodiments. In certain embodiments, the workload distribution controller 160 receives an inference request and determines which processing tier should handle the request based on a composite routing decision that considers six input factors. Embodiments using additional or fewer factors for such routing decisions are also contemplated.

The first input factor is a computational complexity assessment 211. For each incoming inference request, the workload distribution controller 160 estimates the computational resources required to process the request. This estimate is derived from a task type classification (which categorizes the request based on the type of inference operation, such as text generation, image classification, speech recognition, or object detection) combined with historical profiling data from similar tasks previously processed by the system. The complexity assessment produces an estimated execution time, estimated memory requirement, and estimated accelerator utilization for each candidate processing tier.

The second input factor is a latency requirement 212. In certain embodiments, maximum acceptable end-to-end latency criteria are either explicitly specified by the application in the inference request metadata or inferred by the workload distribution controller 160 from the task type. For example, real-time speech translation tasks may have a typical latency requirement of less than 150 milliseconds, while batch document translation tasks may tolerate latencies of several seconds.

The third input factor is a privacy classification 213, determined by the privacy classification engine 166 described in detail below with reference to FIG. 3. The privacy classification identifies the sensitivity level of the input data and produces a tier constraint mask that restricts which processing tiers are permitted to handle the request.

The fourth input factor is a data volume assessment 214, comprising the size of the input data payload and the expected size of the output. Data volume affects both the transmission time to remote processing tiers and the memory required for processing, and may favor local processing for large input payloads when network bandwidth is constrained.

The fifth input factor is a device resource state 215, comprising the current processor utilization, memory availability, battery level, and thermal state of the requesting device 112. This information is reported by the communication module 119 as part of the device telemetry. A device with high processor utilization, low battery, or elevated thermal state is less suitable for local inference processing.

The sixth input factor is a network conditions assessment 216, comprising the current measured latency and available bandwidth between the requesting device 112 and each reachable edge computing infrastructure node 122. Network conditions are assessed via periodic probe measurements and historical network performance data.

In certain embodiments, the workload distribution controller 160 comprises a routing decision engine 230 that computes a composite routing score for each candidate processing tier based on the input factors 210a-210f and per-tier adaptive thresholds 220. In certain embodiments, the input factors are normalized to values between 0.0 and 1.0 at 232, subjected to weighted based on application specific criteria at 234, and at 236, composite score S for candidate tier t is computed according to the following equation:

$$S ( t ) = w 1 * C ( t ) + w 2 * L ( t ) + w 3 * D ( t ) + w 4 * R ( t ) + w 5 * N ( t )$$

Where C(t) is a computational fit score indicating how well the candidate tier's available resources match the task's computational requirements, L(t) is a latency score indicating the expected end-to-end latency at tier t relative to the requirement, D(t) is a data transfer score accounting for input/output data volume relative to available bandwidth, R(t) is a device resource score reflecting the suitability of local processing, N(t) is a network quality score, and w1 through w5 are configurable weights. In certain embodiments, the tier with the highest composite score is selected, subject to the constraint that the privacy classification of the input data permits processing at that tier. If the highest-scoring tier is excluded by the privacy constraint, the system selects the highest-scoring tier from among the permitted tiers. If a selected tier is unavailable to handle an inference request, certain embodiments include fallback features to ensure that the inference request is processed by another tier.

### Privacy Classification Engine and Tier Constraints (FIG. 3)

Referring now to FIG. 3, there is shown a flowchart of the privacy-controlled tier selection process performed by the privacy classification engine 302 in accordance with certain embodiments. In certain embodiments, the privacy classification engine 302 is a subsystem of the workload distribution controller 160 that classifies the sensitivity of data contained in each inference request and produces tier constraints that are applied as a mandatory gate on the routing decision.

In certain embodiments, the privacy classification engine 302 analyzes the input data associated with each inference request using three input mechanisms. A data type scanner 310 examines the content of the inference request to identify data elements that match predefined sensitivity patterns, such as biometric data structures, medical record formats, financial data fields, or personally identifiable information patterns. A user preference interface 312 allows applications to specify data sensitivity levels explicitly in request metadata. A regulatory rule engine evaluates the request against a configurable set of jurisdiction-specific regulatory rules that constrain where certain data types may be processed.

Based on the analysis, the privacy classification engine 302 assigns each inference request to one of four privacy levels. Level 1 classification 352 (Regulated) applies to data subject to specific regulatory requirements, such as medical records, financial data under jurisdiction-specific regulation, or data subject to data residency requirements. Level 1 classification 352 constrains processing to the device tier 110 or to jurisdictionally-compliant edge node(s) 122, with encrypted audit logging at the metro/regional coordination tier 130.

Level 2 classification 354 (Sensitive) applies to data containing biometric identifiers, personal behavioral data, or other personally identifiable information. Level 2 classification 354 constrains processing to the device tier 110 or the nearest edge computing infrastructure node 122. In certain embodiments, data classified at Level 2 is processed ephemerally (state is not persisted after session completion) and uses end-to-end encryption.

Level 3 classification 356 (Internal) applies to data that is not personally identifiable but is proprietary or business-sensitive. Level 3 classification 356 permits processing at any tier with standard encryption in transit and at rest.

Level 4 (Public) classification 358 applies to data with no sensitivity constraints. Level 4 classification 356 permits processing at any tier without additional encryption constraints and permits result caching and batch aggregation for efficiency.

The privacy classification can operate as a mandatory technical gate on the routing decision, not an advisory preference or soft-gating mechanism that may be overridden by other routing factors. In certain embodiments, when the privacy classification engine 302 determines that the input data meets Level 1 or Level 2 criteria, the routing decision produced by the composite scoring function described above is constrained to the permitted tiers, regardless of what any of the other routing factors would otherwise bias towards. This constraint is structural, not advisory—a Level 1 request will not be routed to a non-compliant tier, even if that tier would provide the lowest latency and highest throughput. As a concrete example, consider an inference request containing biometric voice data (Level 2 classification 354) during a period when the nearest edge computing infrastructure node 122 is operating at 95% capacity while a data center tier node 142 has abundant capacity and could process the request with 3× lower latency. Despite the substantial performance advantage of the data center tier 140, the mandatory privacy gate prevents the request from being routed to that tier. The system routes the request to a constrained edge node 122, accepting higher latency and potential queuing delay rather than violating the tier constraint. This mandatory enforcement is in contrast to advisory privacy systems that treat data sensitivity as one weighted factor among many in a composite scoring function, where a sufficiently high performance score from other factors could override the privacy preference. In certain embodiments of the system described herein, the privacy constraint is applied as a pre-filter that removes ineligible tiers from the candidate set before the composite scoring function is evaluated, such that the scoring function only considers tiers that have already passed the privacy gate. No combination of favorable scores on the other five routing factors can cause an inference request to be processed at a tier that the privacy classification has excluded. The system maintains an audit log of instances where the mandatory gate overrides what would otherwise be the highest-scoring tier, providing verifiable evidence that the privacy constraint is enforced as a hard technical control rather than an advisory guideline.

In certain embodiments privacy classification engine 302 can further support mixed-sensitivity handling at 320. When an inference request contains data elements at different privacy levels, the system can split the request into sub-requests processed at different tiers according to each element's privacy level. For example, a request containing both biometric voice data (Level 2) and non-sensitive text context (Level 4) may process the biometric voice data at the device tier or nearest edge node while processing the text context at a higher tier with greater computational resources. In certain embodiments, the results from the split processing are recombined before returning to the requesting application.

### Device Tier Components and Task Routing (FIG. 4)

Referring now to FIG. 4, there is shown a block diagram of the user device tier 110 of FIG. 1, using components and task routing in accordance with certain embodiments of the invention(s). In certain embodiments, device tier 110 employs a layered architecture comprising an application layer 113, the local orchestration agent 116, the on-device inference engine 114, the state cache 118, the communication module 119, and device sensor inputs 115.

In certain embodiments, the application layer on the device generates inference requests. Each request includes a task type identifier, input data, optional latency and quality parameters, and optional privacy classification metadata. The application layer passes each request to the local orchestration agent 116.

The local orchestration agent 116 of certain embodiments comprises a task complexity analyzer 460 that estimates the computational requirements of each request, an offload decision controller 462 that determines whether the request should be processed locally or forwarded to the edge computing infrastructure tier 120, a session state manager 464 that tracks active sessions and their associated state, and a task queue 466 that manages pending requests. The local orchestration agent 116 also receives device sensor inputs including battery level, thermal sensor readings, network signal strength, and device location (GPS or network-derived).

In certain embodiments, the offload decision controller 462 within the local orchestration agent 116 applies the following decision logic. If the required model is loaded in the on-device inference engine 114 and the device has sufficient available compute capacity (e.g., processor utilization below a configurable threshold, memory availability above a configurable threshold, battery level above a configurable threshold, and thermal state below a configurable threshold), the estimated local execution time satisfies the latency requirement, and the privacy classification does not require higher-tier processing, then the request is processed locally. Otherwise, the request is forwarded to the nearest available edge computing infrastructure node 122 via the communication module 119.

When an inference request is forwarded to an edge node 122, the device does not idle. The local orchestration agent 116 enters an asynchronous wait state during which it continues to serve cached responses from the device-side state cache 118 to the user interface, processes other local tasks on the on-device inference engine 114, and pre-fetches models for likely follow-up tasks into the state cache 118. If additional related inference requests arrive while the device is awaiting results from the edge node, the local orchestration agent 116 may queue these follow-up requests with session affinity metadata indicating that they should preferentially be routed to the same edge node 122 where the session state remains resident.

When edge connectivity is unavailable, the local orchestration agent 116 of certain embodiments falls back to local processing for all requests that can be served by models available in the on-device inference engine 114, accepting potentially reduced inference quality for the benefit of continued operation. Requests that require models not available locally are queued for later processing when edge connectivity is restored.

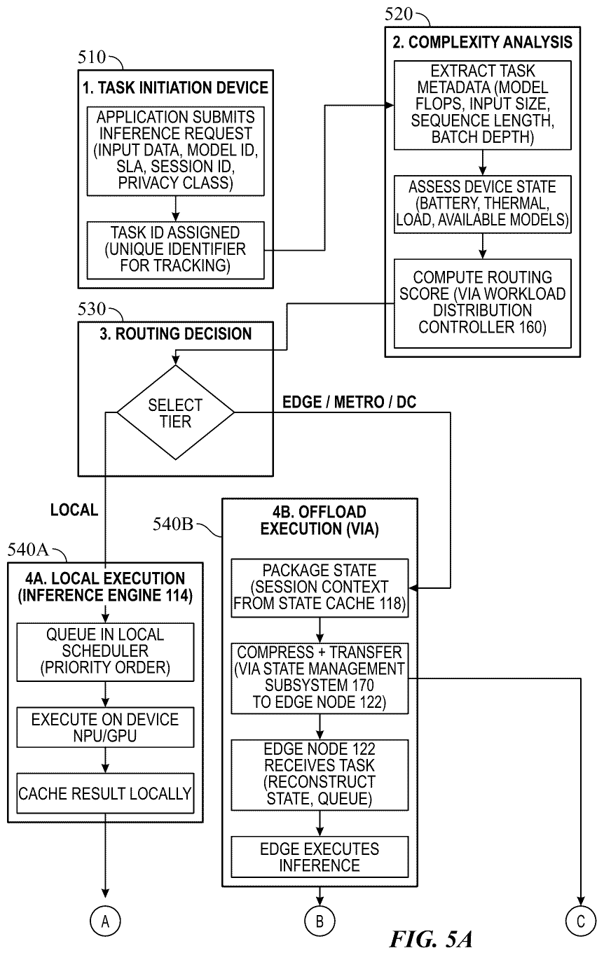

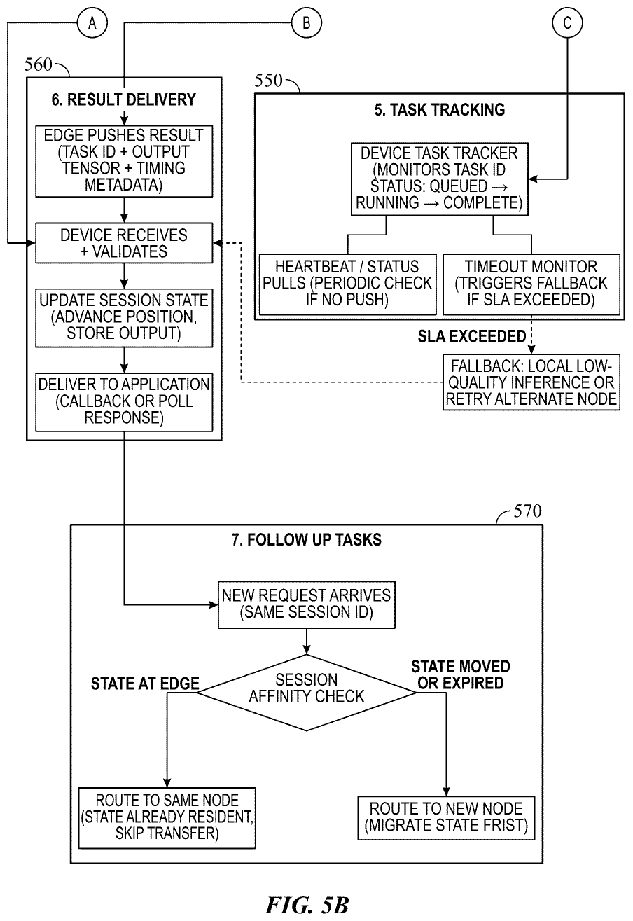

### Task Lifecycle Flow (FIG. 5)

Referring now to FIG. 5, there is shown a flowchart illustrating the complete lifecycle of an AI inference task from initiation through completion in accordance with one or more embodiments. In certain embodiments, the task lifecycle comprises seven stages.

In stage 1 (Task Initiation) 510, an application on the a user device 112 generates an inference request. The local orchestration agent 116 assigns a unique task identifier to the request and logs the initiation time.

In stage 2 (Complexity Analysis) 520, the local orchestration agent 116 performs a complexity assessment of the request. The task complexity analyzer 450 estimates the computational requirements based on the task type and input characteristics, and the offload decision controller queries the current device resource state. The workload distribution controller 160 computes a routing score that incorporates the routing factors described with reference to FIG. 2.

In stage 3 (Tier Selection) 530, the routing decision determines the processing tier. The privacy classification engine 166 applies tier constraints based on the data sensitivity. The composite routing score, subject to privacy constraints, selects the optimal tier.

In stage 4A (Local Execution) 540A, if the selected tier is the device tier 110, the request is passed to the on-device inference engine 114 for local processing. The inference result is returned directly to the application layer.

In stage 4B (Offload) 540B, if the selected tier is the edge computing infrastructure tier 120, the metro/regional coordination tier 130, or the data center tier 140, the communication module 119 transmits the request to the selected node. If the request is associated with an active session whose state resides at a specific edge node 122, the system preferentially routes to that node to avoid redundant state transfer. In certain embodiments, a state management subsystem may compress and include relevant session state with the forwarded request.

In stage 5 (Task Tracking) 550, the user device 112 monitors the offloaded task via heartbeat polling and timeout mechanisms. The edge node 122 returns an acknowledgment with a task identifier and an estimated completion time. If the task is not completed within the estimated time, the edge node 122 may escalate the task to the metro tier 130 or data center tier 140, sending a revised estimated time of arrival to the device. If the total time exceeds a threshold such as a service-level agreement deadline, the local orchestration agent 116 may invoke a fallback to local low-quality inference or retry at an alternate edge node.

In stage 6 (Result Delivery) 560, the processing node returns the inference result to the device 112. The local orchestration agent 116 validates the result, updates the session state in the device-side state cache 118, and delivers the result to the application layer via a callback.

In stage 7 (Follow-Up Routing) 570, if follow-up tasks were queued during the asynchronous wait, the local orchestration agent 116 re-evaluates the routing decision for each queued task with updated context. In certain embodiments, follow-up tasks carry session affinity metadata that preferentially routes them to the same edge node 122 where session state remains resident, avoiding redundant state transfer. If the session state has been transferred to a different edge node (due to a mobility handoff during the wait), the session affinity metadata is updated accordingly.

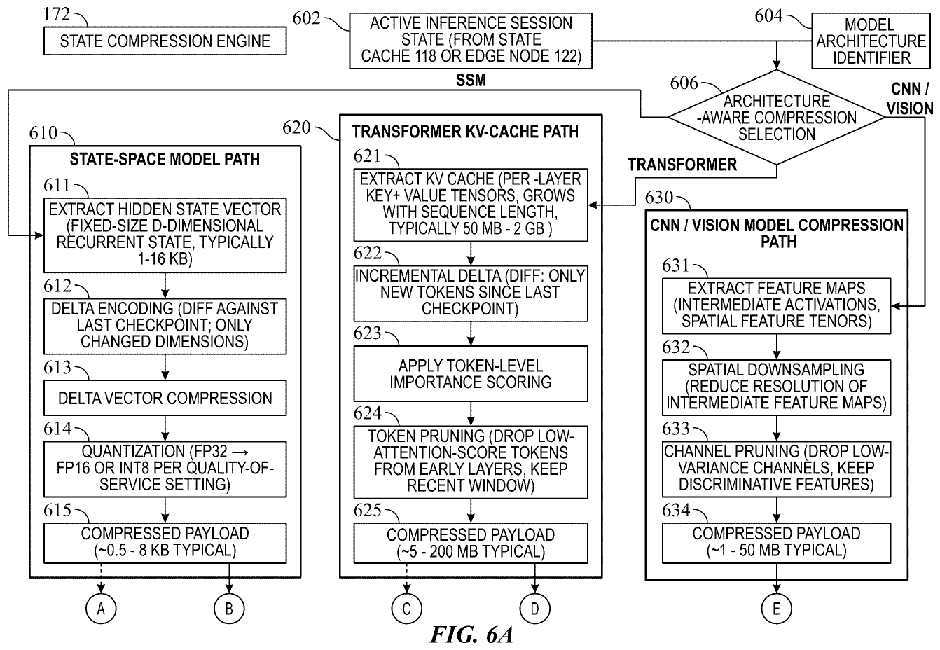

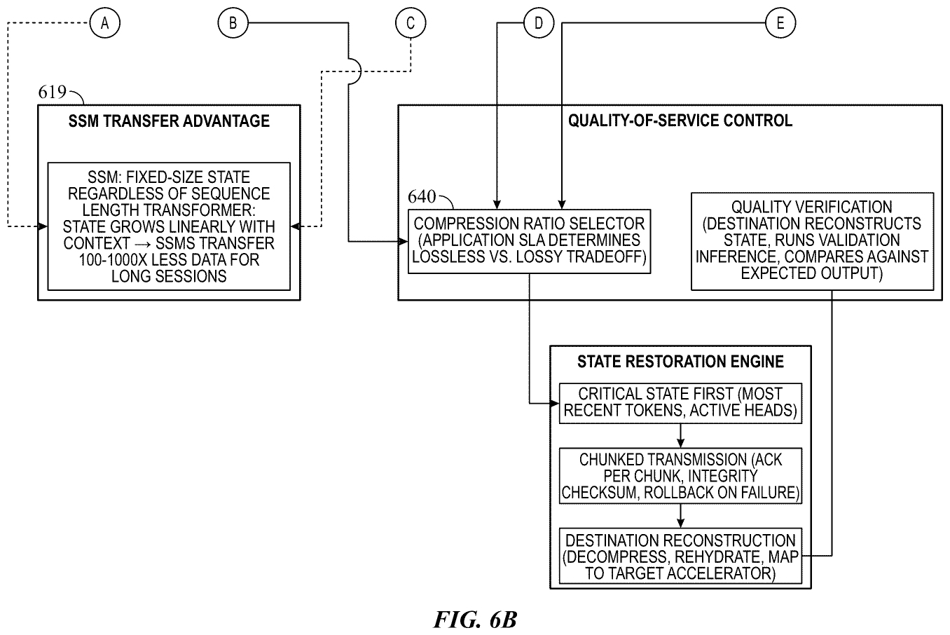

### Model-Specific State Compression (FIG. 6)

Referring now to FIG. 6, there is shown a block diagram of the model-specific state compression pipeline within the state compression engine 172 of the state management subsystem 170 in accordance with one or more embodiments. The state compression engine 172 is the primary mechanism by which the system 100 of certain embodiments enables efficient transfer of active AI inference session state between edge computing infrastructure nodes 122 during mobility handoffs. The compression engine 172 exploits structural properties specific to each AI model architecture to achieve compression ratios and transfer times that make real-time session mobility feasible at the edge.

### Architecture-Aware Compression Selection (606)

In certain embodiments, the state compression engine 172 receives two inputs: the active inference session state 602 to be compressed, and a model architecture identifier 604 indicating the architecture of the model whose state is being compressed. Based on the model architecture identifier 604, at 606 the compression engine 172 selects a compression technique adapted to exploit structural properties of that specific model architecture. In certain embodiments, the system 100 supports at least three compression paths, each corresponding to three major families of AI model architectures: state-space models (SSM) (path 610), Transformer-based models (path 620), and convolutional neural network (CNN) models (path 630).

### State-Space Model Compression Path (610)

State-space models (SSMs) are a class of neural network architectures that process input sequences through linear recurrence relations. The discrete-time state-space equations governing an SSM layer are:

$$x ( t + 1 ) = A * x ( t ) + B * u ( t )$$

$$y ( t ) = C * x ( t ) + D * u ( t )$$

where x(t) is the hidden state vector of dimension d_state at time step t, u(t) is the input vector at time step t, y(t) is the output vector at time step t, A is the state transition matrix of dimension d_state by d_state, B is the input projection matrix, C is the output projection matrix, and D is the feedthrough matrix. The matrices A, B, C, and D are learned parameters.

The hidden state vector x(t) has three properties that make SSMs particularly well-suited for the distributed edge inference architecture described herein. First, fixed-size representation: the hidden state x(t) has a fixed size of d_state regardless of the length of the input sequence processed to date. Whether the model has processed 10 tokens or 10,000 tokens, the hidden state remains a vector of d_state dimensions. This is in contrast to Transformer-based architectures, where the key-value attention caches grow linearly with sequence length, requiring O(n) storage where n is the number of tokens processed.

Second, efficient inference: each step of SSM inference requires only a matrix multiplication and addition (O(d_state\hat{ }2) operations per step), compared to O(n*d_model) operations per step for attention mechanisms that must attend to all previous tokens. This O(1) per-step complexity (constant with respect to sequence length) makes SSMs suitable for resource-constrained edge computing infrastructure nodes 122 where computational resources must be shared across multiple concurrent inference sessions.

Third, efficient compression for transfer: because the state transition matrix A governs smooth evolution of the hidden state, successive hidden states tend to be correlated. Delta encoding between the current state and a recent checkpoint produces a delta vector that is typically sparse, meaning that most dimensions have changed only slightly. This sparsity enables a structured sparsity compression to achieve compression ratios that make real-time state transfer over backhaul connections feasible.

While SSMs are a preferred embodiment due to their uniquely compact state representation, the system 100 is configured to handle multiple model architectures through an architecture-aware compression selection. The system provides the greatest efficiency advantage for SSM-based models (0.5 to 8 KB compressed state) but also supports Transformer-based models (5 to 200 MB compressed state) and CNN-based models (1 to 50 MB compressed state), making the architecture applicable to the full range of AI model types deployed at the edge.

For state-space models, the hidden state at any point in processing is a fixed-size vector h(t) of dimension d_state per layer. This is a fundamental architectural property arising from the state-space formulation: x(t+1)=A*x(t)+B*u(t), y(t)=C*x(t)+D*u(t), where x(t) is the hidden state vector, u(t) is the input, y(t) is the output, and A, B, C, D are learned parameter matrices. The hidden state vector x(t) summarizes prior inputs in a fixed-size representation (e.g., regardless of the length of the input sequence processed to date). This fixed-size property makes SSMs uniquely amenable to efficient state compression and transfer.

Returning now to FIG. 6, the SSM compression path 610 proceeds as follows. Step A (611): extract the hidden state vectors from all active SSM layers. For a model with L layers, each having state dimension d_state, the total uncompressed state size is L*d_state*precision_bytes. Step B (612): apply delta encoding relative to a reference checkpoint state. The system periodically stores checkpoint snapshots of the hidden state. Because the state transition matrix A governs smooth evolution of the hidden state, the delta between the current state and the most recent checkpoint is typically sparse, with most dimensions having changed only slightly. Step C (613): apply structured sparsity compression to the delta vector, encoding only the dimensions that have changed by more than a configurable threshold. Step D (614): apply adaptive quantization, reducing precision from the inference-time representation (typically 16-bit or 32-bit floating point) to a transfer-time representation (8-bit or lower), with the degree of quantization being adaptive based on available bandwidth and time remaining before handoff. Step E (615): serialize the compressed data into a compressed state payload data structure.

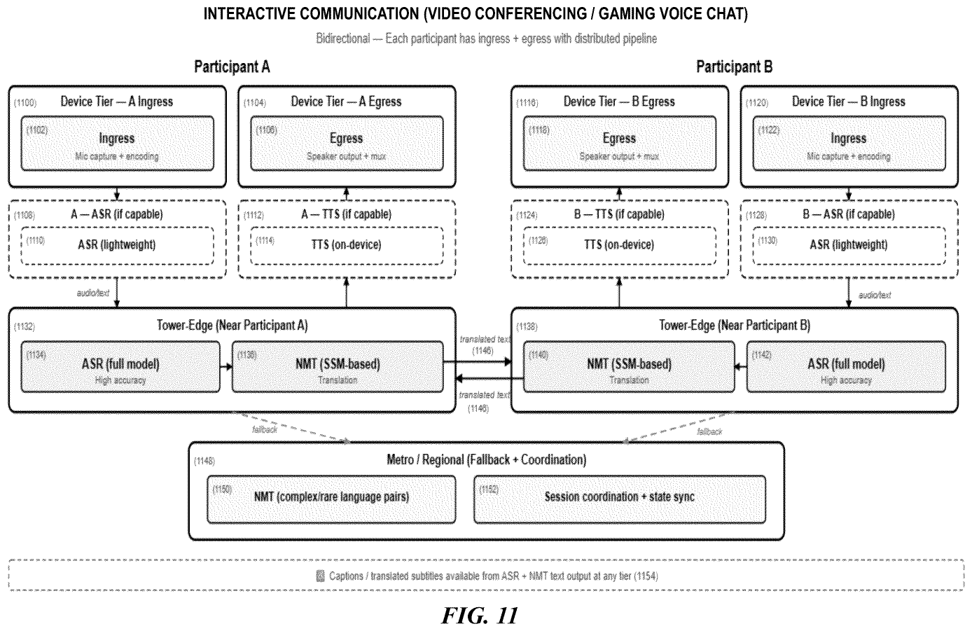

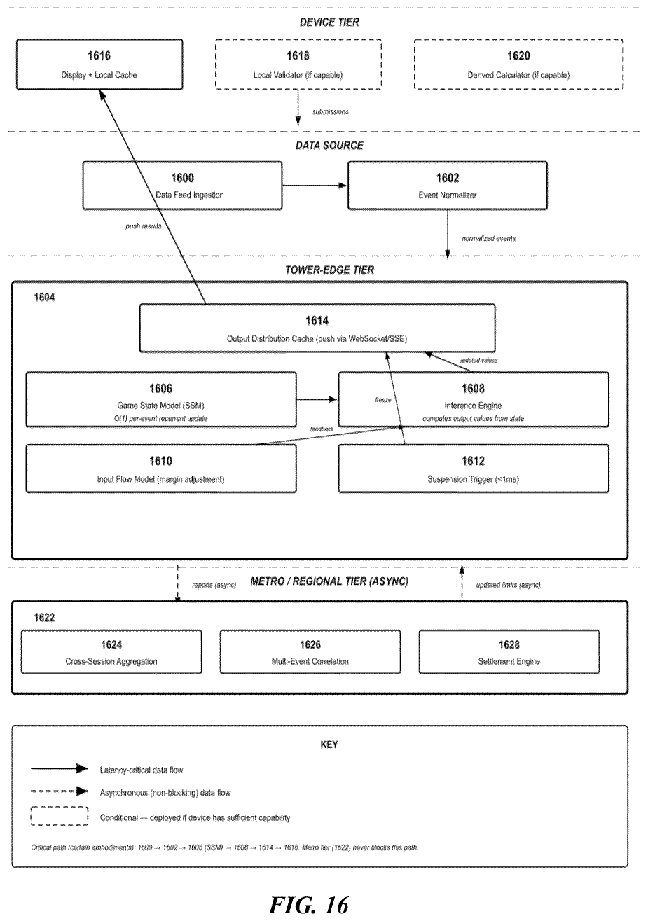

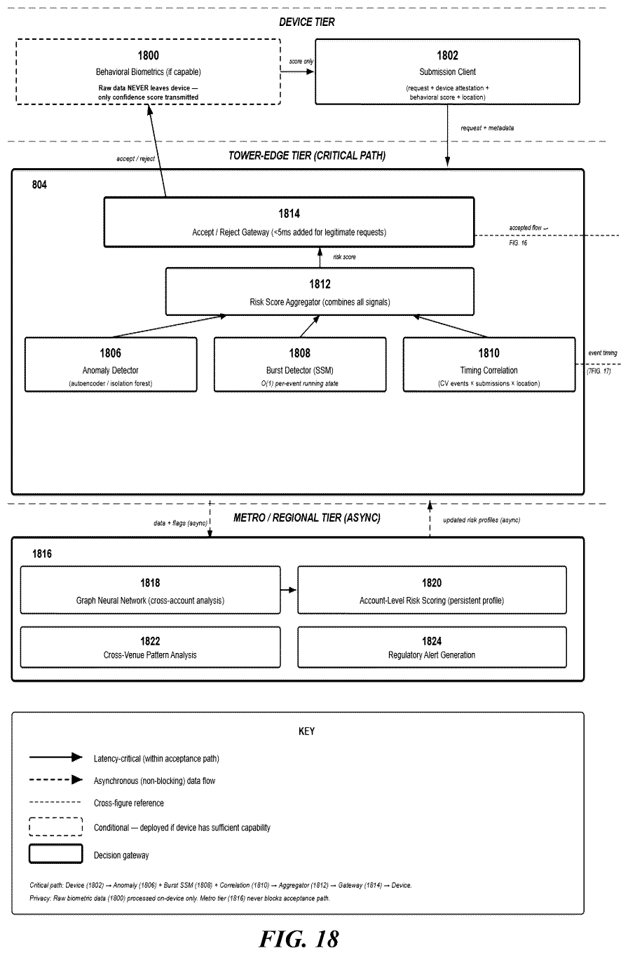

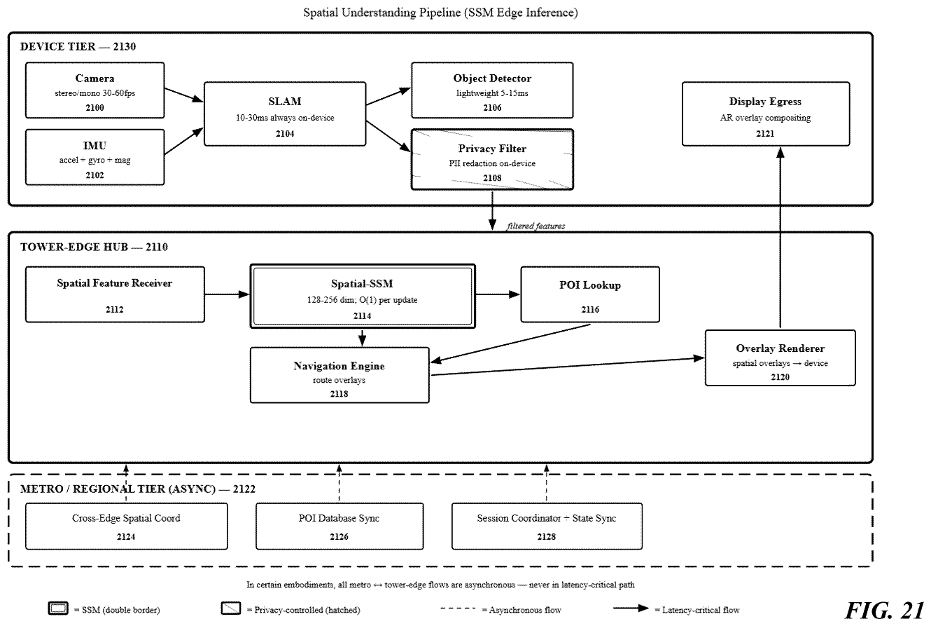

In certain embodiments, as discussed at 619, the resulting compressed state size for SSM-based models ranges from approximately 0.5 to 8 kilobytes per active model instance, depending on the number of layers, state dimensions, and compression aggressiveness. This compact representation enables transfer over backhaul connections in under 10 milliseconds for certain embodiments, making real-time predictive state pre-positioning feasible even for edge nodes connected by bandwidth-constrained backhaul. The SSM compression path 610 is applicable to SSM-based inference pipelines deployed across the use-case embodiments described herein, including the NMT translation models described with reference to FIGS. 11-15 and FIG. 23, the game state model described with reference to FIG. 16, the temporal burst detector described with reference to FIG. 18, and the Spatial-SSM described with reference to FIG. 21.

### SSM Compression Example

The following example illustrates the SSM compression path 610 applied to a representative state-space model architecture such as Mamba, S4, or S5. Consider an SSM-based neural machine translation model deployed at an edge node 122 with the following parameters: L=24 layers, d_state=256 dimensions per layer, and inference-time precision of 16-bit floating point (2 bytes per value). The total uncompressed state size is L*d_state*precision_bytes=24*256*2=12,288 bytes (approximately 12 KB).

Step A (611) extracts the hidden state vectors h(t) from all 24 layers, yielding a 24×256 matrix of 16-bit values. Step B (612) computes the delta relative to the most recent checkpoint state h(t_checkpoint): delta(t)=h(t)−h(t_checkpoint). Because the state transition matrix A in the recurrence x(t+1)=A*x(t)+B*u(t) produces smooth, correlated state evolution, the delta vector is empirically sparse. In a representative session after processing 500 tokens since the last checkpoint, approximately 80-90% of the delta dimensions have magnitude below a configurable threshold epsilon (for example, epsilon=0.01*max(|delta|)). Step C (613) applies structured sparsity encoding: for each layer, the system encodes only the indices and values of dimensions where |delta_i|>epsilon. With 85% sparsity, each layer contributes approximately 38 non-zero delta values rather than 256, and each non-zero entry is stored as an (index, value) pair requiring 2 bytes for the index and 2 bytes for the value at 16-bit precision, yielding 38*4=152 bytes per layer. Step D (614) applies adaptive quantization, reducing the non-zero delta values from 16-bit to 8-bit precision (1 byte per value), yielding 38*3=114 bytes per layer. Across all 24 layers, the compressed state size is 24*114=2,736 bytes, plus header overhead (model architecture identifier, compression method, quantization parameters, layer count, checksum) of approximately 64 bytes, for a total compressed payload of approximately 2.8 KB. This represents a compression ratio of approximately 4.4:1 relative to the uncompressed state.

For more aggressive compression when bandwidth is constrained, the compression ratio selector 640 can increase the sparsity threshold to epsilon=0.05*max(|delta|), achieving approximately 95% sparsity (approximately 13 non-zero values per layer), and reduce quantization to 4-bit precision. This yields approximately 13*2.5=32.5 bytes per layer, or approximately 780 bytes+64 bytes header=844 bytes total, a compression ratio of approximately 14.6:1. At a backhaul bandwidth of 1 Mbps (a conservative estimate for bandwidth-constrained inter-edge-node links), the 844-byte payload transfers in under 7 milliseconds, well within the sub-50-millisecond handoff budget.

The key property exploited in this compression is unique to the SSM architecture: because the hidden state x(t) is a fixed-size vector that evolves smoothly under the learned state transition matrix A, the delta between any two temporally proximate states is naturally sparse. This property does not hold for Transformer KV caches, where each new token adds entirely new key and value vectors that are not correlated with previous entries in the same way. It does not hold for CNN feature maps, where spatial activations can change discontinuously as new visual input is processed. This architecture-specific compression path 610 described herein exploits this structural property to achieve compression ratios for SSM state that are substantially higher than what is achievable for Transformer or CNN state, making SSMs uniquely amenable to the real-time state transfer required for seamless edge-to-edge session mobility.

### Transformer Attention Cache Compression Path (620)

For Transformer-based models, the runtime state includes key-value (KV) attention caches that grow with the length of the sequence processed. Unlike the fixed-size SSM state, Transformer KV caches accumulate one key vector and one value vector per attention head per layer for each token in the sequence, resulting in state sizes that can reach hundreds of megabytes for large models processing long sequences.

The Transformer compression path 620 proceeds as follows. Step A (621): Extract the per-layer key and value tensors from the Transformer's KV cache, which grows with sequence length. Step B (622): compute an incremental delta relative to the most recent checkpoint state. Only the KV cache entries added since the last checkpoint need to be transferred if the destination already holds the checkpoint state. Step C (623): apply token-level importance scoring to the cache entries. Tokens with low attention weights across recent forward passes contribute less to ongoing inference quality and can be pruned with minimal quality degradation. The system prunes low-importance token entries, retaining only the top-k most important entries per attention head. Step D (624): apply low-rank factorization to the remaining cache entries, decomposing the key and value matrices into lower-rank approximations that require less storage. Step E (625): yield the compressed payloads through quantization and serialization.

The resulting compressed state size for Transformer-based models ranges from approximately 5 to 200 megabytes depending on model size, number of attention heads, and sequence length. Compression ratios of 50:1 to 100:1 are achievable with acceptable quality degradation as measured by a quality-of-service verification.

### Transformer Compression Example

The following worked example illustrates the Transformer compression path 620 applied to a representative Transformer-based model deployed at an edge computing infrastructure node 122 for real-time text generation or interactive AI assistant tasks. Consider a Transformer model with the following parameters: L=32 layers, H=32 attention heads per layer, d_head=128 dimensions per head (key and value vectors each), inference-time precision of 16-bit floating point (2 bytes per value), and a sequence length of n=2,048 tokens accumulated during an active conversation session. The total uncompressed KV cache size extracted at Step A (621) is 2 (keys and values)*L*H*n*d_head*precision_bytes=2*32*32*2,048*128*2=1,073,741,824 bytes (approximately 1,024 MB or 1 GB).

Step B (622) computes an incremental delta relative to the most recent checkpoint. Assume the last checkpoint was taken at token position 1,536, meaning 512 tokens of KV cache entries have been added since the checkpoint. Only these 512 tokens of new entries need to be transferred, as the destination edge node 122b already holds the checkpoint state from a prior synchronization. The delta size is 2*32*32*512*128*2=268,435,456 bytes (approximately 256 MB), representing a 4:1 reduction from the full cache.

Step C (623) applies token-level importance scoring. For each attention head, the system computes an importance score for each token based on the cumulative attention weight that token has received across recent forward passes. Tokens that contribute minimally to ongoing inference, such as formulaic greeting tokens, repeated filler words, or early conversational tokens that have been superseded by more recent context, are pruned. In the representative session, importance scoring identifies that approximately 60% of the 512 new tokens have importance scores below the pruning threshold (for example, cumulative attention weight below the 40th percentile across all heads). Pruning these tokens retains the top-k=205 most important token entries per head, reducing the transferable data to 2*32*32*205*128*2=107,347,968 bytes (approximately 102 MB).

Step D (624) applies low-rank factorization to the remaining key and value matrices. For each attention head and each layer, the key matrix K (of dimension 205×128) and the value matrix V (of dimension 205×128) are decomposed into low-rank approximations K≈U_k*S_k*V_k\hat{ }T and V≈U_v*S_v*V_v\hat{ }T, where the rank r is selected to retain at least 95% of the matrix energy (sum of squared singular values). In the representative session, a rank of r=16 suffices for 95% energy retention across most heads and layers. The factored representation for each matrix requires storing U (205×16), S (16), and V\hat{ }T (16×128) rather than the full 205×128 matrix. The storage per factored matrix is (205*16+16+16*128)*2=(3,280+16+2,048)*2=10,688 bytes, compared to 205*128*2=52,480 bytes for the unfactored matrix, a per-matrix reduction of approximately 4.9:1. Across all layers, heads, and both keys and values: 2*32*32*10,688=21,889,024 bytes (approximately 20.9 MB).

Step E (625) applies quantization from 16-bit to 8-bit precision on the factored components, yielding approximately 10.4 MB, plus header overhead (model architecture identifier, compression parameters, layer metadata, per-head rank selections, integrity checksum) of approximately 0.1 MB, for a total compressed payload of approximately 10.5 MB.

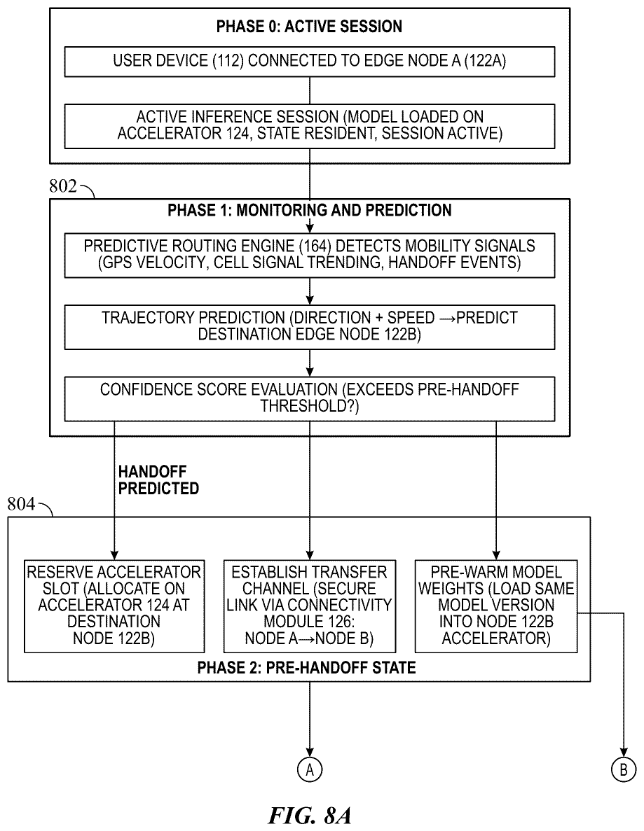

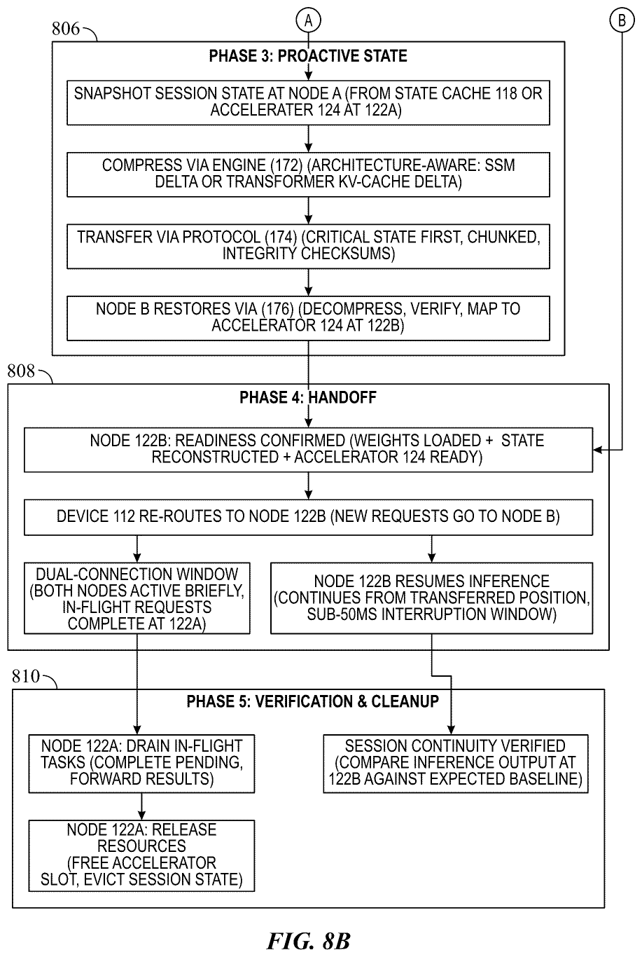

The overall compression ratio from the full uncompressed KV cache is 1,024 MB/10.5 MB≈97:1, falling within the claimed 50:1 to 100:1 range. At a backhaul bandwidth of 100 Mbps (typical for inter-edge-node fiber or high-quality microwave backhaul), the 10.5 MB payload transfers in approximately 0.84 seconds, which is within the Phase 3 (Proactive State Transfer) window described with reference to FIG. 8.

The key property exploited in this compression is specific to the Transformer attention architecture: the KV cache is organized as per-token, per-head, per-layer entries, and individual tokens vary significantly in their contribution to ongoing inference quality. Tokens that received low cumulative attention across recent forward passes can be pruned with minimal quality impact because the attention mechanism naturally down-weights their influence. This token-level importance variance does not exist in SSM hidden states, which are monolithic fixed-size vectors where every dimension contributes to the aggregate representation and cannot be selectively pruned. It does not exist in CNN feature maps, where spatial activations are organized by spatial location and channel rather than by discrete input tokens. The architecture-specific compression path described herein exploits this token-level importance structure to achieve high compression ratios for Transformer state while preserving the tokens that matter most to ongoing inference quality.

### Convolutional Neural Network (CNN) Feature Map Compression Path (630)

For convolutional neural network models used in vision tasks, the runtime state includes intermediate feature maps produced by convolutional layers. These feature maps represent spatial activations at various resolutions and channel depths.

The CNN compression path 630 proceeds as follows. Step A (631): Extract the path feature maps. Step B (632): apply spatial downsampling of intermediate feature maps, reducing spatial resolution while preserving the locations and magnitudes of the most significant activations. Step C (633): retain activation peaks and their spatial indices only, discarding low-magnitude activations that contribute minimally to downstream processing. Step D (634): apply learned compression networks that encode the significant activations into a compact representation optimized for reconstruction at the destination node.

The resulting compressed state size for CNN models ranges from approximately 1 to 50 megabytes depending on input resolution, number of convolutional layers, and feature map depth.

### CNN Compression Example

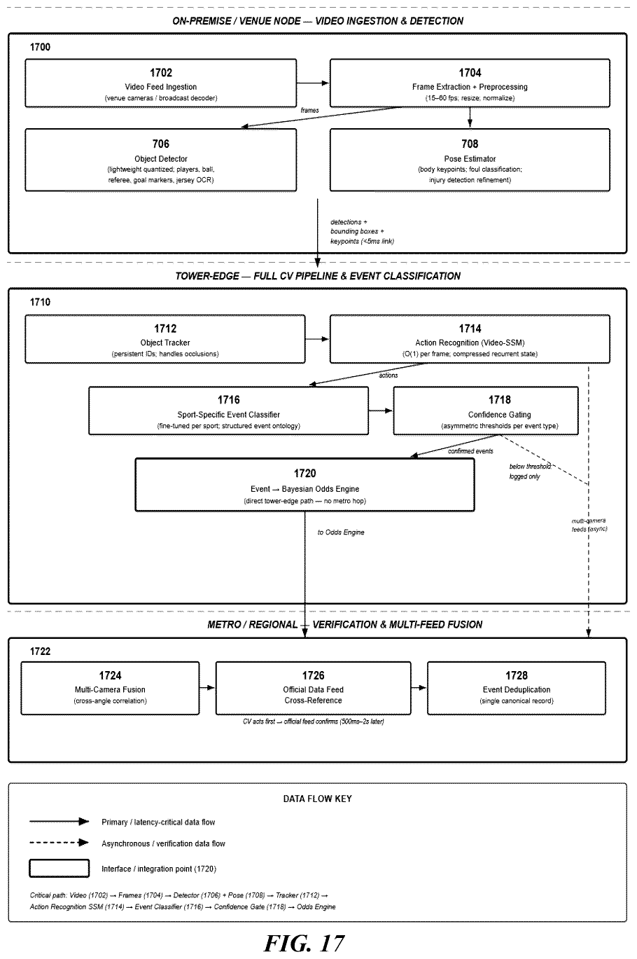

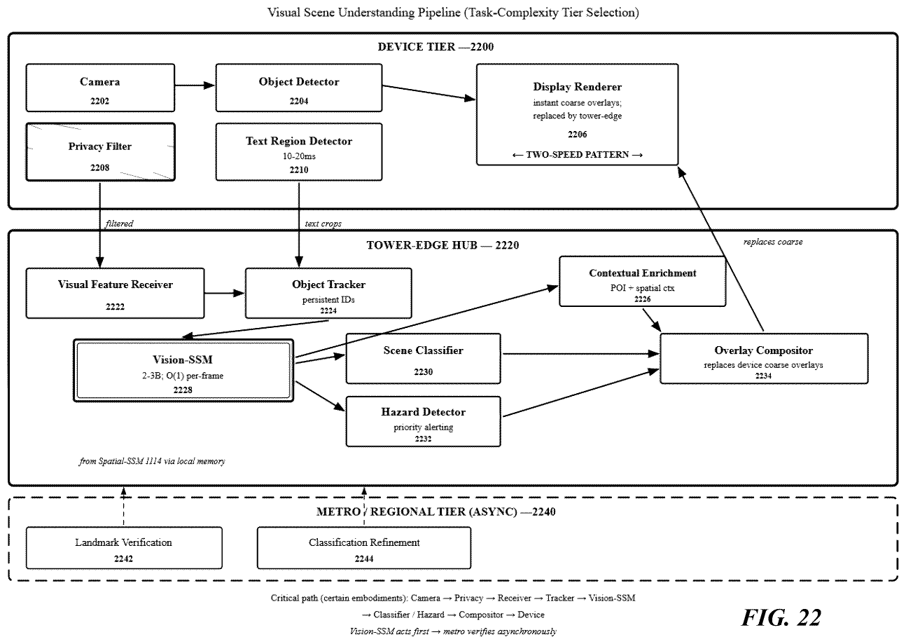

The following worked example illustrates the CNN compression path 630 applied to a representative convolutional neural network model deployed at an edge node 122 for continuous video analysis, such as the object detection and action recognition pipeline described with reference to FIG. 17 or the visual scene understanding pipeline described with reference to FIG. 22. Consider an edge-deployed CNN-based object detection model with a feature pyramid architecture processing 1080p video input (1920×1080 pixels) with the following parameters: 4 feature pyramid levels, 16-bit floating point precision (2 bytes per value), with accumulated feature state maintained across recent frames for temporal tracking consistency.

The active feature state requiring transfer comprises multi-scale feature maps at four pyramid levels: P3 at 240×135 spatial resolution with 256 channels, P4 at 120×68 with 256 channels, P5 at 60×34 with 256 channels, and P6 at 30×17 with 256 channels. Additionally, the state includes a temporal feature buffer aggregating motion and appearance features from the most recent 5 frames for object tracking continuity, and an object tracking state comprising active track histories, bounding box coordinates, confidence scores, and track identity vectors. The total uncompressed state is: P3=240*135*256*2=16,588,800 bytes (approximately 15.8 MB); P4=120*68*256*2=4,177,920 bytes (approximately 4.0 MB); P5=60*34*256*2=1,044,480 bytes (approximately 1.0 MB); P6=30*17*256*2=261,120 bytes (approximately 0.25 MB); temporal feature buffer=approximately 8.0 MB; object tracking state=approximately 1.0 MB. Total uncompressed state: approximately 30 MB.

Following extraction of the feature maps at Step A (631) Step B (632) applies spatial downsampling by a factor of 4 (2× reduction in each spatial dimension) to each feature pyramid level, preserving the spatial locations and magnitudes of the most significant activations through max-pooling with index retention. After downsampling: P3=120*68*256*2=4,177,920 bytes (approximately 4.0 MB); P4=60*34*256*2=1,044,480 bytes (approximately 1.0 MB); P5=30*17*256*2=261,120 bytes (approximately 0.25 MB); P6=15*9*256*2=69,120 bytes (approximately 0.07 MB). Total feature pyramid state after downsampling: approximately 5.3 MB, representing a 4:1 spatial reduction. The temporal feature buffer is reduced to a compact temporal summary of approximately 2.0 MB by retaining only the most recent frame's full features and delta-encoded summaries for the preceding 4 frames. Object tracking state remains at approximately 1.0 MB as it is already compact. Total after Step (a): approximately 8.3 MB.

Step C (633) retains activation peaks above a significance threshold, discarding low-magnitude activations. For each channel of each downsampled feature map, the system identifies the top 12% of spatial positions by activation magnitude and stores each retained activation as a tuple of (spatial index, value). The spatial index is encoded as a single integer offset within the spatial grid (requiring 2 bytes for grids up to 65,536 positions), and the value is stored at the original 16-bit precision (2 bytes), yielding 4 bytes per retained activation. For P3 (120*68=8,160 positions per channel, 12%=979 peaks per channel, 256 channels): 979*256*4=1,002,496 bytes (approximately 0.96 MB). For P4 (2,040 positions, 245 peaks per channel): 245*256*4=250,880 bytes (approximately 0.24 MB). For P5 (510 positions, 61 peaks per channel): 61*256*4=62,464 bytes (approximately 0.06 MB). For P6 (135 positions, 16 peaks per channel): 16*256*4=16,384 bytes (approximately 0.02 MB). Total feature pyramid after peak retention: approximately 1.28 MB. With temporal summary (2.0 MB) and tracking state (1.0 MB): approximately 4.28 MB.

Step D (634) applies a learned compression network, specifically a lightweight autoencoder trained to encode sparse activation peak representations into compact latent codes optimized for reconstruction at the destination node. The encoder receives the per-channel peak index and value lists and produces a fixed-length latent code per pyramid level. In the representative model, the encoder achieves an additional compression factor of approximately 3:1 on the sparse peak data, reducing the feature pyramid component from 1.28 MB to approximately 0.43 MB. The temporal summary is compressed by the same encoder to approximately 0.7 MB. Object tracking state is serialized with standard lossless compression to approximately 0.6 MB. Adding header overhead (model architecture identifier, compression parameters, per-level metadata, spatial grid dimensions, peak retention thresholds, autoencoder model identifier, integrity checksum) of approximately 0.02 MB, the total compressed payload is approximately 1.75 MB.

The overall compression ratio is 30 MB/1.75 MB≈17:1. At a backhaul bandwidth of 50 Mbps (a moderate estimate for microwave or fiber backhaul between edge nodes), the 1.75 MB payload transfers in approximately 0.28 seconds, well within the Phase 3 (Proactive State Transfer) window described with reference to FIG. 8.

For more aggressive compression when bandwidth is constrained, the compression ratio selector 640 can increase the downsampling factor to 8× (3× reduction in each spatial dimension), reduce peak retention to the top 5%, and increase autoencoder compression aggressiveness. This yields approximately 0.5 MB total, a compression ratio of approximately 60:1, transferable in approximately 80 milliseconds at 50 Mbps.

The key property exploited in this compression is specific to the CNN feature map architecture: convolutional feature maps exhibit high spatial redundancy, with the semantically significant information concentrated in a small fraction of spatial positions corresponding to detected features, edges, and object regions, while the majority of spatial positions contain low-magnitude background activations that contribute minimally to downstream detection and classification. This spatial sparsity pattern is a structural property of how convolutional operations respond to visual input and does not exist in SSM hidden states, which are dense fixed-size vectors with no spatial dimension to exploit. It does not exist in Transformer KV caches, which are organized per-token rather than spatially and exhibit token-level importance variance rather than spatial sparsity. The architecture-specific compression path described herein exploits this spatial sparsity to achieve compression ratios for CNN feature state that balance visual fidelity with transfer efficiency, preserving the activation peaks that carry the most information for object detection and scene understanding while discarding the spatially redundant background activations.

### Compression Ratio Selector (634)

Certain embodiments of the state compression engine 172 comprise a compression ratio selector 634 that adaptively adjusts compression aggressiveness based on three dynamic factors: the available bandwidth between the source and destination edge computing infrastructure nodes 122, the estimated time remaining before the user crosses the coverage boundary (as provided by the predictive routing engine 164), and the minimum quality-of-service threshold for the active inference session as specified by the application.

In a preferred embodiment, this adaptive controller 634 implements the following logic: given available bandwidth B (bytes/second), time remaining T (seconds), uncompressed state size S (bytes), and minimum quality threshold Q (a value between 0 and 1 indicating acceptable inference quality relative to uncompressed state), the controller selects a target compression ratio R such that S/R can be transferred within time T at bandwidth B with a quality impact not exceeding 1-Q. The controller achieves this by iteratively adjusting the quantization level, sparsity threshold, and pruning aggressiveness of the selected compression path until the target ratio is achieved while maintaining quality above the threshold.

### Compressed State Payload Data Structure

The compressed state payload is a self-describing data structure that contains all information needed to decompress and restore the session state at a destination edge computing infrastructure node 122. The data structure comprises the following fields: a model architecture identifier indicating the model architecture family (SSM, Transformer, CNN, or other); a compression method indicator specifying the compression path and parameters used; quantization parameters specifying the precision of the compressed data; the number of model layers included in the payload; per-layer compressed state data containing the actual compressed state for each model layer; session metadata including a user identifier, session identifier, originating edge node identifier, and timestamp; an integrity checksum for verifying data integrity after transfer; and a priority indicator that determines the transfer scheduling relative to other traffic on the backhaul connection.

The self-describing nature of the compressed state payload enables the destination edge node 122 to decompress and restore the state without requiring out-of-band coordination about the compression parameters, model architecture, or state format. This is important for heterogeneous edge deployments where the source and destination edge nodes may have different hardware configurations and software versions.

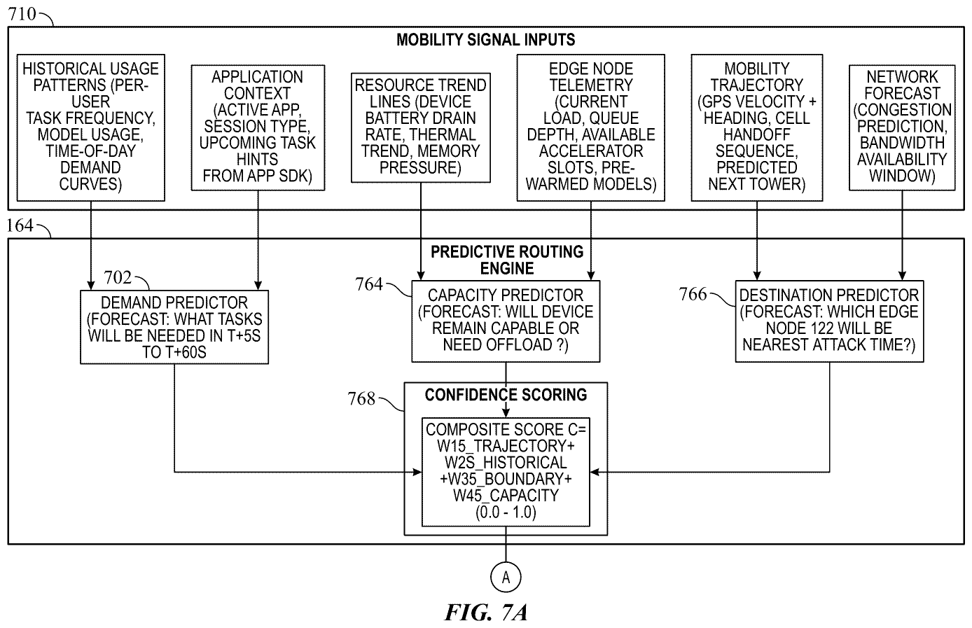

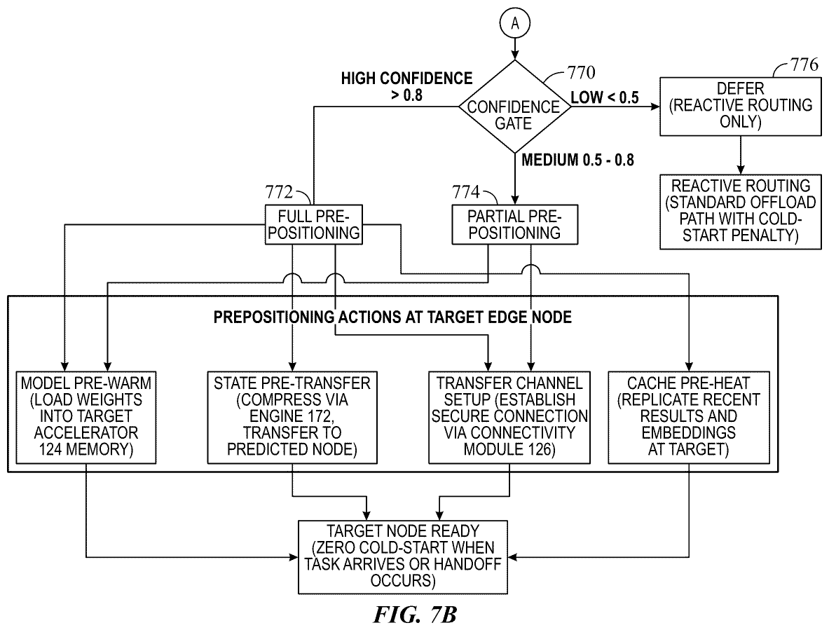

### Predictive Routing Engine (FIG. 7)

Referring now to FIG. 7, there is shown a block diagram of the predictive routing engine 164 in accordance with one or more embodiments. In certain embodiments, the predictive routing engine 164 is operably connected to the workload distribution controller 160, as shown in FIG. 1. In other embodiments, routing engine 164 is a subsystem of the workload distribution controller 160. The predictive routing engine 164 receives mobility signals and other input data and produces pre-positioning directives that cause the state management subsystem 170 to proactively transfer compressed session state to predicted destination edge computing infrastructure nodes 122 before the user arrives.

### Mobility Signal Inputs

In certain embodiments, the predictive routing engine 164 receives six categories of signal inputs 710. Historical usage patterns comprise data on past inference requests, session durations, and mobility trajectories for the user and for the geographic area, providing a baseline for prediction. Mobility trajectory data comprises the current position, velocity, heading, and acceleration of the user device 112, derived from GPS, inertial measurement unit data, or network-based positioning. Application context comprises information about the user's current activity, including, when available, a navigation route or destination that provides a strong trajectory signal. Device resource trend lines comprise time-series data on device resource utilization that may indicate upcoming changes in processing demands. Edge node telemetry comprises current resource availability, queue depth, and model loading status at neighboring edge computing infrastructure nodes 122. Network forecasts comprise predicted bandwidth and latency to candidate destination nodes based on historical network performance data.

For non-terrestrial edge computing infrastructure nodes, the predictive routing engine 164 additionally incorporates edge node position, velocity, and predicted orbital or flight-path trajectory. The trajectory predictor evaluates the relative motion between the user and the serving edge computing infrastructure node. For terrestrial edge nodes, which are fixed, relative motion is determined (solely) by user movement. For non-terrestrial edge nodes such as LEO satellite computing platforms, relative motion includes the orbital trajectory of the edge node itself, and handoff may be triggered by the edge node departing the user's proximity rather than the user departing the edge node's coverage area.

### Trajectory Prediction and Confidence Scoring

In certain embodiments, the predictive routing engine 164 feeds the six categories of signal inputs into three predictor subsystems: a demand predictor 762 that forecasts future inference workload from the user, a capacity predictor 764 that forecasts available resources at candidate destination edge nodes, and a destination predictor 766 that forecasts which edge node the user will be served by next.

The destination predictor 766 computes a predicted destination edge node and a composite confidence score C at 768. In a preferred embodiment, the confidence score is computed as a weighted combination of four components: trajectory certainty C_traj (the consistency and stability of the predicted trajectory based on recent position, velocity, and heading data), historical accuracy C_hist (the accuracy of predictions for similar mobility patterns in the same geographic area at similar times of day), boundary proximity C_prox (the estimated distance and time to the nearest edge node coverage boundary, with higher values as the user approaches a boundary), and capacity projection C_cap (the predicted availability of the required model and computational resources at the candidate destination node). The composite confidence score is: C=alpha_1*C_traj+alpha_2*C_hist+alpha_3*C_prox+alpha_4*C_cap, where alpha_1 through alpha_4 are configurable weights.

The predictive routing engine 164 applies a confidence gate 770 with three threshold regions to determine the pre-positioning action. When the confidence score exceeds a high-confidence threshold (for example, 0.8 in a preferred embodiment), the engine triggers full pre-positioning (772): compressed session state and model weights are transferred to the predicted destination edge node 122, and an accelerator slot is reserved. When the confidence score falls between the high-confidence threshold and a medium-confidence threshold (for example, 0.5 to 0.8), the engine triggers partial pre-positioning (774): compressed state is sent to the top two or three candidate edge nodes, and model pre-warming and transfer channel setup are initiated. When the confidence score falls below the medium-confidence threshold, the engine defers to reactive routing (776): no pre-positioning is performed, and the system continues monitoring and re-evaluating.

### Session Continuity and Multi-Phase Handoff Protocol (FIG. 8)

Referring now to FIG. 8, there is shown a timing diagram illustrating the session continuity and multi-phase handoff protocol in accordance with one or more embodiments. In certain embodiments, the handoff protocol combines the predictive routing engine 164, the state compression engine 172, and a state transfer protocol to achieve proactive session transfer between a source edge node 122a and a destination edge node 122b. In certain embodiments, such a handoff can occur with a mere sub-50 millisecond session interruption.

### Five-Phase Handoff Protocol

Phase 1 (Monitoring and Prediction, continuous) (802): The predictive routing engine 164 continuously evaluates mobility signals and updates trajectory prediction and confidence scores. This phase runs as a background process throughout the lifetime of every active AI inference session that is associated with a mobile user.

Phase 2 (Pre-Handoff Preparation, T minus 5 seconds) (804): When the confidence score exceeds the high-confidence threshold and the estimated time-to-boundary drops below a pre-handoff threshold (for example, 5 seconds in a preferred embodiment), the system initiates pre-handoff preparation. The state compression engine 172 creates a checkpoint of the active session state and compresses it using an architecture-appropriate compression technique. An integrity checksum is computed for the compressed payload. The connectivity module 126 establishes pre-connections to the candidate destination edge node 122b, and an accelerator slot is reserved at the destination for the session's model. Model weights are pre-warmed at the destination if they are not already loaded.

Phase 3 (Proactive State Transfer, T minus 2 seconds) (806): The compressed state payload is transferred to the primary candidate destination edge node 122b via the state transfer protocol using the pre-established connection. The transfer is performed in prioritized chunks, with the most recently updated state elements transferred first to minimize the age of transferred state. If the session state changes during the transfer (because inference continues at the source node 122a), differential updates are computed and sent as incremental deltas. State version tracking is maintained at both source and destination to ensure consistency. The destination node 122b acknowledges receipt and begins decompression and state reconstruction via the state restoration engine.

Phase 4 (Handoff Execution, T-zero) (808): The user crosses the coverage boundary between the source node 122a and the destination node 122b. The system maintains a brief dual-connection period during which both nodes remain active. Incoming inference requests are routed to the destination node 122b, which resumes inference from the transferred state. Any final state delta from the source node 122a is applied to the destination state. In-flight requests that were submitted to the source node before the handoff are allowed to complete at the source, with results forwarded to the device. The total session interruption during Phase 4 is less than 50 milliseconds in preferred embodiments.

Phase 5 (Verification and Cleanup, T plus 1 second) (810): The destination node 122 b verifies session integrity by comparing a sample of inference outputs against an expected baseline computed from the pre-handoff state. The source node 122a drains any remaining in-flight tasks, releases the accelerator slot and memory resources previously allocated to the session, and purges the session state. If verification at the destination fails (for example, if inference outputs diverge significantly from the expected baseline), a recovery protocol is initiated.

### Unified Multi-Pipeline Handoff

When multiple inference pipelines are co-located at the source edge node 122a (as in the sports betting embodiment of FIGS. 16-20 and the AR navigation embodiment of FIGS. 21-24), the handoff protocol transfers all pipeline states simultaneously as a unified session payload. In certain embodiments, the unified session state package comprises: per-pipeline compressed state (each pipeline's state compressed using the architecture-appropriate technique), cross-pipeline shared context (any shared data structures used for cross-pipeline data exchange), and session metadata (user identifier, session identifiers for each pipeline, timestamps, and routing history). The unified transfer ensures that cross-pipeline consistency is maintained across the handoff, with all pipelines resuming from a consistent state at the destination.

### Failure Modes and Recovery

The handoff protocol accounts for several failure scenarios. If the prediction is incorrect (the user moves to a different edge node than predicted), the system re-routes the compressed state from the incorrect destination to the actual destination, or re-transfers directly from the source if the source still holds the state. If the transfer fails due to a network interruption, the system retries transfer via an alternate backhaul path or, if no alternate path is available, falls back to device-cached session state stored in the device-side state cache 118. If the destination node 122b lacks sufficient capacity, the system identifies an alternate destination or temporarily continues serving from the source node 122a at higher latency. If the destination node lacks a compatible model, the system triggers an emergency model deployment at the destination before proceeding with the handoff. In all failure scenarios, the system degrades gracefully: the user may experience temporarily increased latency or reduced inference quality, but the session is not terminated.

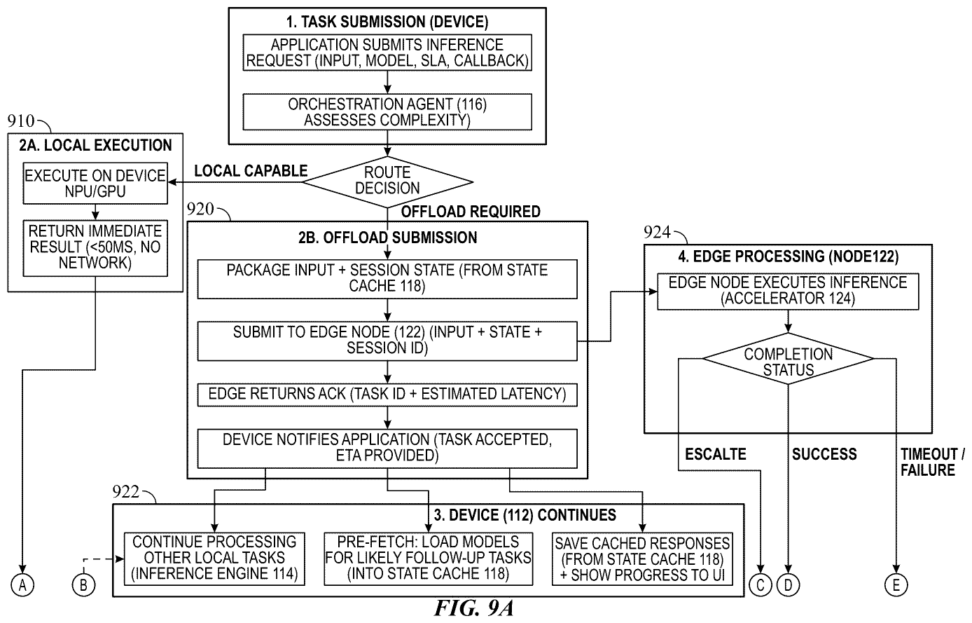

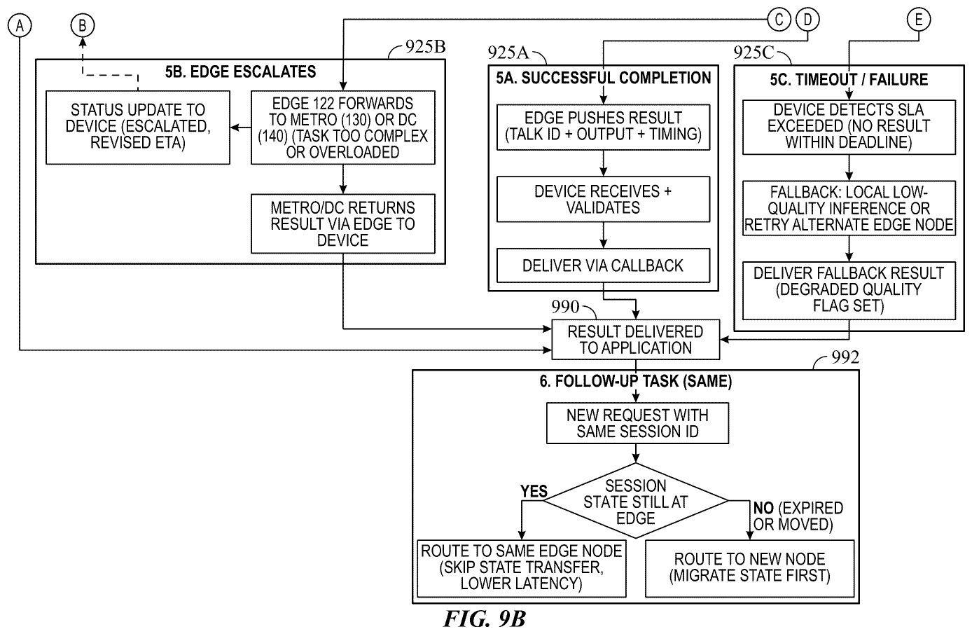

### Asynchronous Task Completion and Device Behavior (FIG. 9)

Referring now to FIG. 9, there is shown a flowchart illustrating the asynchronous task completion flow and device behavior in accordance with one or more embodiments. FIG. 9 depicts two parallel execution paths (a synchronous local execution path 910 and an asynchronous offload path 920) together with device behavior during asynchronous wait and three distinct completion outcomes.

In the synchronous local execution path 910, the local orchestration agent 116 determines that the inference task can be executed on-device. The on-device inference engine 114 executes the task using the device NPU (neural processing unit) or GPU (graphical processing unit). The result is returned immediately to the application layer at 990, within (in certain embodiments) 50 milliseconds and without any network communication. The result may also be stored in the device-side state cache 118 for subsequent reference.

In the asynchronous offload path 920, the local orchestration agent 116 packages the inference input together with session state and transmits the package to the selected edge node 122. The edge node 122 returns an acknowledgment comprising a task identifier and an estimated latency. The device 112 notifies the application that the task has been accepted and provides the estimated time of arrival.

While awaiting the remote result, the device 112 continues productive work rather than blocking at 922. Specifically, the device continues processing other local tasks, pre-fetches models for likely follow-up tasks based on application context, and displays a placeholder or progress indicator to the user interface. This non-blocking device behavior ensures that the user experience is not interrupted by the asynchronous offload.

The edge processing stage 924 at the edge node 122 executes inference using pre-warmed accelerators with resident model weights. Upon completion, the system evaluates three possible outcomes. In the first outcome (successful completion 925a), the edge node 122 pushes the inference result to the device 112, comprising the task identifier, output tensor, and timing metadata. The device 112 receives and validates the result, delivers it to the application layer via callback at 990, and updates the session state in the device-side state cache 118.

In the second outcome (escalation 925b), the edge node 122 determines that the task is too complex or the edge node is overloaded, and forwards the task to the metro/regional coordination tier 130 or data center tier 140. The edge node sends a status update to the device 112 with a revised estimated time of arrival. The higher-tier node completes the inference and returns the result to the device via the edge node 122 at 990.

In the third outcome (timeout or failure 925c), the device 112 detects that the service-level agreement deadline has been exceeded with no result received. The local orchestration agent 116 initiates a fallback: either executing local low-quality inference using the on-device inference engine 114, or retrying the request at an alternate edge node 122. The fallback result is delivered to the application with a degraded-quality flag set at 990, enabling the application to handle the reduced-quality result appropriately.

Following result delivery from any of the three outcomes, a follow-up task 992 arriving with the same session identifier triggers a session affinity check. If the session state remains resident at the same edge node 122, the follow-up task is routed to that node directly, avoiding redundant state transfer. If the session state has moved or expired (for example, due to a mobility handoff during the wait), the task is routed to the new node, with state migration performed first if necessary.

### Non-Terrestrial Handoff Scenario

In embodiments where the edge computing infrastructure tier 120 includes non-terrestrial nodes, the handoff protocol accommodates edge node mobility in addition to user mobility. Consider a scenario in which a user in a maritime or remote environment is served by a LEO satellite edge computing infrastructure node. The satellite traverses its orbital path and will exit the user's line-of-sight within a predictable time window. The predictive routing engine 164 monitors the serving satellite's orbital ephemeris data in addition to user mobility signals, and predicts the next satellite node that will have line-of-sight to the user.

The five-phase handoff protocol proceeds as described above, with the modification that Phase 1 (Monitoring and Prediction) incorporates satellite orbital prediction rather than relying solely on user trajectory prediction. Phase 2 (Pre-Handoff Preparation) and Phase 3 (Proactive State Transfer) operate via inter-satellite link or ground-station relay to transfer compressed session state to the predicted successor satellite node. Phase 4 (Handoff Execution) occurs when the successor satellite acquires line-of-sight to the user and the predecessor satellite's signal degrades below a threshold. Phase 5 (Verification and Cleanup) includes propagation-delay-aware integrity verification.

The same handoff protocol applies to HAPS-based and UAV-based edge computing infrastructure nodes with analogous modifications for flight-path prediction rather than orbital prediction. In all non-terrestrial handoff scenarios, model-specific state compressions are particularly valuable because the backhaul bandwidth between non-terrestrial nodes (inter-satellite links or satellite-to-ground links) may be more constrained than terrestrial backhaul, making high compression ratios critical for completing state transfer within the available handoff time window.

### Co-Located Multi-Pipeline Edge Inference

In many real-world AI applications, multiple inference pipelines must operate in concert, with the output of one pipeline feeding as input to another. For example, a real-time translation application may require automatic speech recognition, neural machine translation, and text-to-speech synthesis operating as a coordinated pipeline. A sports analytics application may require computer vision, temporal analysis, risk assessment, and recommendation generation exchanging data in real time.

In centralized cloud deployments, these pipelines typically operate as separate microservices communicating via network interfaces. Each cross-pipeline data exchange incurs network round-trip latency of 1 to 10 milliseconds or more, and a closed-loop cycle involving three or four pipelines accumulates tens of milliseconds of inter-pipeline communication overhead before accounting for actual inference computation.

In the system 100, multiple interdependent AI inference pipelines can be co-located on a single edge computing infrastructure node 122, sharing local memory for cross-pipeline data exchange. Local shared memory enables data exchange between co-located pipelines with microsecond-level latency, compared to millisecond-level latency for network-based exchange. This improvement enables closed-loop inference cycles in which pipeline A output feeds pipeline B input, which feeds pipeline C input, which feeds back to pipeline A, completing the full cycle in microseconds rather than tens of milliseconds.

The co-located inference architecture is particularly valuable for applications where the value of inference results degrades rapidly with time and where multiple pipelines must exchange data within tight latency budgets. The sports betting embodiment described with reference to FIGS. 16-20 demonstrates nine cross-pipeline data flows among four co-located pipelines. The AR (augmented reality) navigation embodiment described with reference to FIGS. 21-24 demonstrates seven cross-pipeline data flows among three co-located pipelines. In both cases, the closed-loop inference cycle enabled by co-location is structurally impossible to achieve at equivalent speed in a centralized cloud deployment.

When a user with an active multi-pipeline session moves between edge node coverage areas, the unified multi-pipeline handoff described herein transfers all pipeline states simultaneously, preserving cross-pipeline consistency across the transition.

In certain embodiments, systems in accordance with the present disclosure comprise one or more AI agents or implement a multi-agent architecture. For example, the distributed AI inference system described herein may comprise AI agents operating in multiple areas (e.g., the Local Orchestration Agent (116), the Workload Distribution Controller (160), and the Predictive Routing Engine (164)) which collectively form a multi-agent system in which agents at different hierarchical levels cooperate to optimize inference latency, resource utilization, privacy compliance, and session continuity.

### Model Update Distribution Flow (FIG. 10)

Referring now to FIG. 10, there is shown a block diagram illustrating the model update distribution flow in accordance with one or more embodiments of the present disclosure. The model update distribution flow describes the process by which updated AI models trained at the data center tier 140 are validated, staged, and deployed to the edge computing infrastructure tier 120 while maintaining inference continuity for active sessions. The following description explains this distribution process, and the figure includes annotated steps (noted as (#1), (#2), etc.) accompanying certain steps for illustrative purposes.

When a model update becomes available at the data center tier 140 (#1), a model optimization and distribution platform 1002 generates an optimized version of the updated model suitable for edge deployment. The optimized model is registered in a model registry and made available for distribution. The metro/regional coordination tier 130 (not depicted here in its entirety, see the singular metro node A 1020) maintains a database of current clusters and running models at each edge nodes A 1010, B 1012, and C 1014, and coordinates staged rollout.

The system employs a one-tier-up staging protocol for model updates. When an updated model is targeted for deployment for, e.g., edge node A 1010, the system may not update the edge node directly. Instead, the system first stages the updated model at the tier above the target (#2), in this case metro node A 1020. Metro node A 1020 loads the updated model, and the system updates the routing tables at the user device to direct subsequent inference requests to metro node A 1020 where the updated model is now running (#3).

The system then initiates a state transfer from edge node A 1010 to metro node A 1020 (#4), using the state transfer protocol 174 and state compression engine described herein, to migrate any active inference session state associated with the model being updated. This ensures that active sessions are not interrupted during the update process. The orchestration system collects telemetry data from the metro node A 1020 (#5) to verify that the updated model is producing valid and feasible inference results under real workload conditions.

Once the updated model is validated at the staging tier, the system deploys the updated model to edge node A 1010 (#6). The deployment can be managed via a configuration deployment agent at each edge node. After the updated model is running at the edge node A 1010, the system performs a reverse state transfer from the metro node 1020 back to edge node A 1010 (#7), restoring active session state, and updates the device routing tables to redirect inference requests back to edge node A 1010 (#8). The same validation process repeats: the orchestration system monitors telemetry from the edge node A 1010 to confirm that the updated model operates correctly in the edge environment.

The one-tier-up staging protocol provides several advantages. First, it validates the updated model under real inference workload before deploying it to the resource-constrained edge tier, reducing the risk of deploying a model that fails in the edge environment. Second, it maintains inference continuity during the update by temporarily serving from the staging tier. Third, it reuses the same state compression and transfer mechanisms used for mobility handoff (described herein), providing architectural consistency and reducing implementation complexity.

If the updated model is targeted for deployment on a user device, an edge node such as edge node A 1010 is selected as the staging tier. If the updated model is targeted for deployment on one coordination node, another coordination node is selected for staging. Resource constraints at the edge tier may require staging on the coordination node(s) even for edge-targeted updates. After successful deployment at one edge node (e.g. edge node A 1010), the system repeats the process for additional edge nodes in the geographic cluster (e.g., edge nodes B 1012 and C 1014) (#9). In certain embodiments, parallel deployment may be used here to reduce the total rollout time, where bandwidth permits.

### Example Embodiments: Real-Time Voice Translation (FIGS. 11-15)

FIGS. 11 through 15 illustrate an exemplary embodiment of distributed AI inference systems applied to real-time multilingual speech translation. This embodiment distributes three core AI workloads across the multi-tier architecture: Automatic Speech Recognition (ASR), Neural Machine Translation (NMT) implemented as a state-space model, and Text-to-Speech synthesis (TTS). All diagrams share the following conventions: conditional services (dashed border, “IF CAPABLE” label) denote AI workloads placed on-device only when the device has been determined to have sufficient processing capability. per the dynamic workload placement methods described herein. Solid arrows denote primary data flow; dashed arrows denote secondary or fallback data flow.

### Use Case 1: Interactive Communication (FIG. 11)

Referring now to FIG. 11, there is shown a bidirectional, symmetric communication scenario representing the foundational use case for real-time translated conversation. Each participant has ingress (microphone capture and on-device encoding capabilities, 1102 and 1122) and egress (speaker output and on-device multiplexing capabilities, 1106 and 1118) paths with conditional on-device ASR (1110, 1130) and TTS (1114, 1126) deployed if the device is determined capable.

At each participant's edge node (1132, 1138), a full-accuracy ASR (1134, 1142) feeds an SSM-based NMT service (1136, 1140). In some embodiments, only translated text payloads (1146) cross between participant edge nodes, not audio, representing the minimum-bandwidth crossing point. If the receiving device is TTS-capable (text to speech capable), it receives text and synthesizes speech locally; otherwise, edge node TTS generates audio and streams it to the device. The metro/regional tier 1148 provides NMT fallback for rare language pairs and session coordination, without (materially) blocking the latency-critical path. In certain embodiments, the latency target for such tasks is less than 150 milliseconds for end-to-end to enhance smooth, real-time conversational flow. Additionally, state handoffs per the predictive state transfer described in this document enable seamless transitions as participants move between edge node coverage areas.

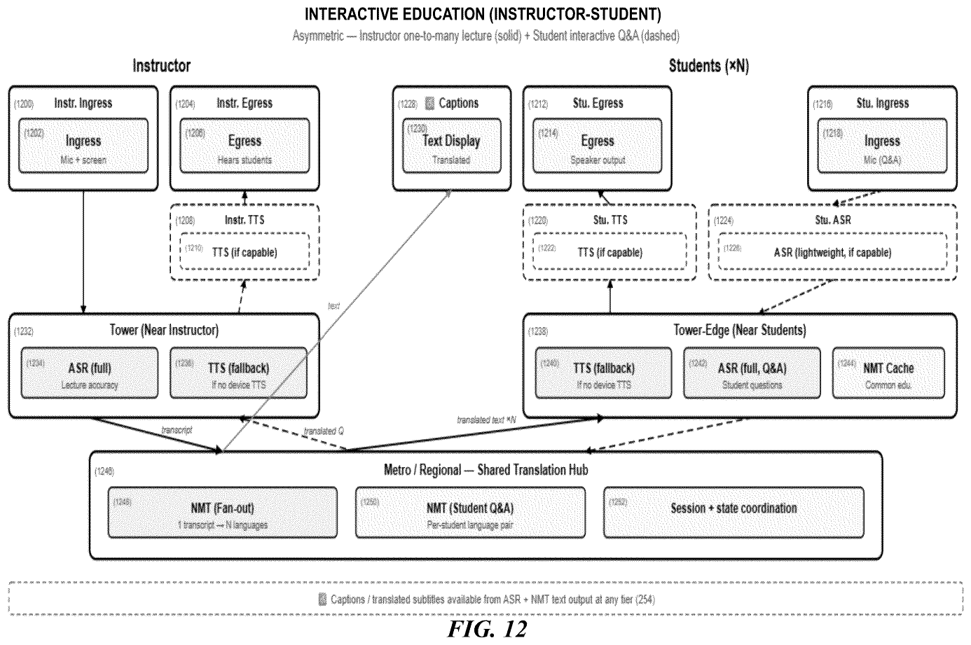

### Use Case 2: Interactive Education (FIG. 12)

Referring now to FIG. 12, there is shown an asymmetric instructor-to-student scenario with two modes: one-to-many lecture delivery and many-to-one student questions. The instructor's device is represented by elements 1200, 1204, and 1208, and the multitude of students' devices are represented by elements 1212, 1216, 1220, and 1224. In the one-to-many lecture delivery mode, the instructor has no on-device ASR and edge node ASR 1234 handles all lecture audio for maximum accuracy. The metro/regional NMT 1248 fan-out receives one transcript and produces N language translations simultaneously, performing shared computation once regardless of audience size. Translated text flows to student edge nodes, where an NMT cache 1244 of pre-translated common educational phrases reduces latency for frequently used vocabulary. Student devices with TTS capability 1220 receive text and synthesize locally; those lacking TTS receive pre-rendered audio from edge TTS 1240. Captions 1228 receive text directly from metro NMT 1248 and work on any device. In the many-to-one student questions mode, a student's question is captured via on-device ASR (if capable) (1224) or routed to the student's nearest edge node for ASR processing 1224. The recognized text is translated by the student edge node's 1238 NMT into the instructor's language and forwarded to the instructor's edge node. The instructor receives the translated question as text or TTS-synthesized audio, depending on device capability. This reverse path reuses the same edge-tier ASR and NMT infrastructure deployed for lecture delivery, demonstrating bidirectional use of the multi-tier architecture within an asymmetric session.

### Use Case 3: Telemedicine (FIG. 13)

Referring now to FIG. 13, there is shown a bidirectional communication scenario structurally similar to FIG. 11 with additional regulatory constraints. A jurisdictional boundary 1300 encloses all device and edge tiers such that no data leaves the regulatory region under any circumstances, including failover. Medical-specialized ASR (1336, 1344) and NMT (1338, 1342) are deployed at each participant's edge node (1334, 1340), with extended medical vocabulary and domain-adapted clinical terminology. Encrypted audit logging 1352 at the metro tier 1348 satisfies regulatory requirements for medical records retention. State handoff respects jurisdictional boundaries, transferring compressed session state only to destination edge nodes (1334, 1340) within the permitted regulatory region. This use case demonstrates the privacy-controlled tier selection described herein, extended to geographic regulatory constraints as a stricter form constraining the boundary within which any tier may operate.

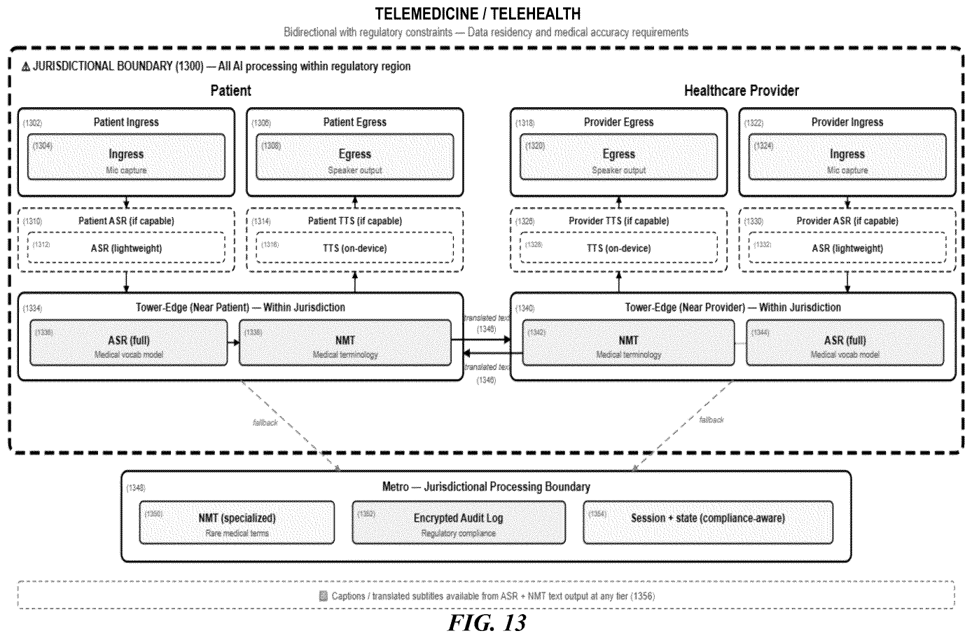

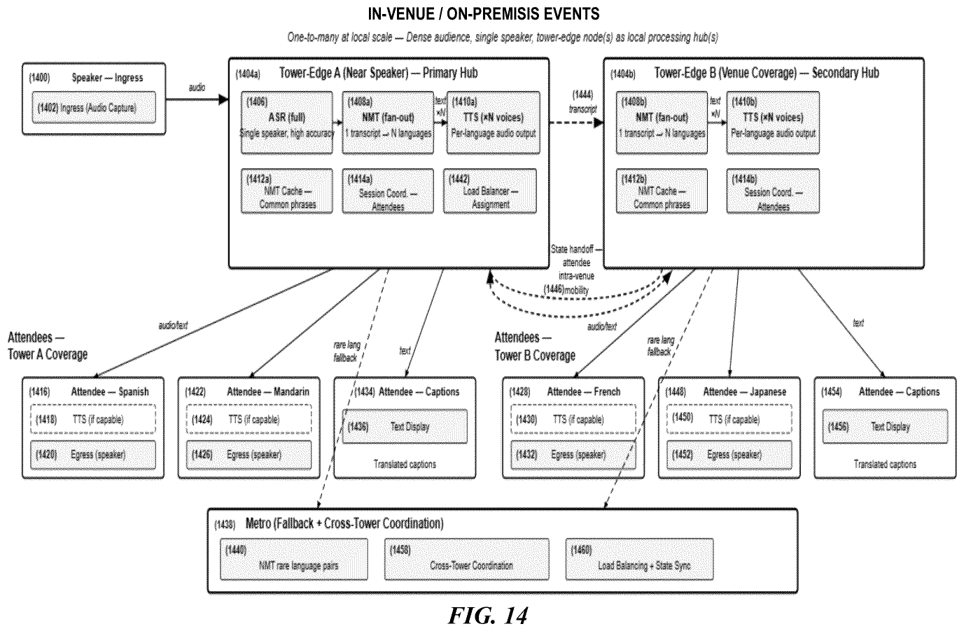

### Use Case 4: In-Venue Events (FIG. 14)

Referring now to FIG. 14, there is shown a one-to-many scenario at venue scale that extends the single tower-edge hub architecture of FIGS. 11-13 to a coordinated multi-edge-node deployment. In this extension, the single edge node of preceding use cases is instantiated as a primary edge node 1404a and one or more secondary edge nodes 1404b, collectively serving a large-audience venue. ASR 1406 runs at the primary edge node 1404a nearest the speaker. The resulting transcript is distributed via inter-edge-node text relay 1444 to the secondary edge node(s) 1404b for local NMT and TTS processing. Each edge node runs NMT fan-out, with the primary edge node running NMT fan-out 1408a and each secondary edge node running NMT fan-out 1408b, each translating one transcript into N languages. A venue-level load balancer 1442 assigns attendees across edge nodes based on geographic proximity and node capacity, with overflow redistribution 1460 rebalancing attendee assignments when individual edge nodes approach capacity limits. TTS-capable attendee devices receive text and synthesize speech locally at scale with minimal per-device bandwidth. Attendees moving within the venue transition between edge coverage areas via inter-edge state handoff 1446, maintaining session continuity using the multi-phase handoff protocol described with reference to FIG. 8.

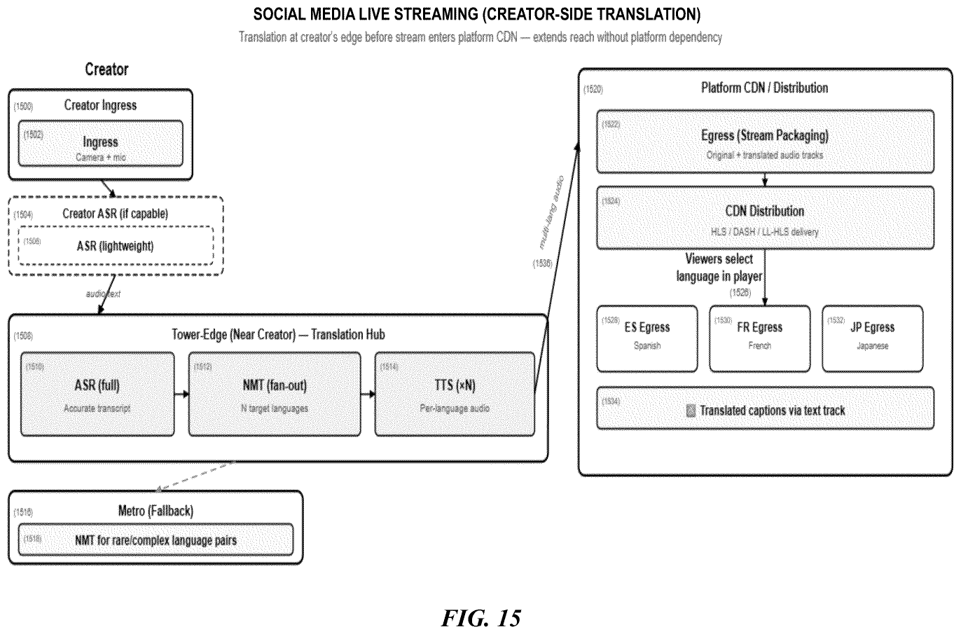

### Use Case 5: Social Media Live Streaming (FIG. 15)

Referring now to FIG. 15, there is shown a different architecture: translation occurs entirely at the creator's edge node 1508 before the stream enters the platform's content delivery network (CDN) 1520. The viewer side 1500, 1504 involves no edge AI; it is pure CDN delivery. At the creator's edge node 1508, the complete ASR 1510, NMT 1512, and TTS 1514 pipeline generates multi-language audio tracks. TTS 1514 is at the edge node rather than on viewer devices because the output is shared audio tracks for CDN injection, demonstrating distribution-topology-aware workload placement. For mobile creators, state handoff maintains stream continuity across edge node transitions.

### Platform Capabilities Demonstrated by FIGS. 11-15

The real-time voice translation embodiment demonstrates the following platform capabilities: SSM-based edge inference with O(1) temporal scaling for NMT across all five use cases; co-located multi-pipeline inference with ASR, NMT, and TTS on shared edge infrastructure; minimum-bandwidth crossing point architecture with text-only inter-edge-node exchange; privacy-controlled tier selection with jurisdictional compliance (FIG. 13); dynamic workload placement based on device capability (conditional ASR/TTS) including venue-scale deployment across hundreds of devices (FIG. 14); adaptive output format selection with text versus audio delivery based on device capability and distribution topology; fan-out translation with shared computation optimization; domain-specialized edge inference with medical terminology (FIG. 13) and educational phrase caches (FIG. 12); load distribution across multiple edge nodes (FIG. 14); asynchronous metro coordination; and unified state handoff during mobility.

### Second Embodiment: Sports Betting (FIGS. 16-20)

FIGS. 16 through 20 illustrate an exemplary embodiment of the distributed AI inference system 100 applied to in-play sports betting operations. This embodiment demonstrates how multiple, interrelated AI inference pipelines are orchestrated across the hierarchical multi-tier architecture, with particular emphasis on: (a) SSM-based inference at the edge computing infrastructure tier providing constant-time updates as temporal context grows; (b) co-location of multiple inference pipelines on shared edge infrastructure with local-memory data exchange; (c) privacy-controlled tier selection determining where sensitive data is processed; (d) dynamic workload placement based on device capability; (e) asynchronous metro-tier coordination; and (f) unified state handoff during user mobility preserving session context across (all) active inference pipelines.

In this embodiment, the device tier comprises bettor devices (smartphones, kiosks, terminals) that perform display, user interaction, and conditional on-device inference when the device has sufficient processing capability. The edge computing infrastructure tier comprises computing nodes deployed near sporting venues and data sources, hosting the latency-critical inference pipelines. The metro/regional coordination tier provides cross-session analysis, compliance, and coordination, always asynchronously (and never in the latency-critical path).

### Part 1: Real-Time Odds Calculation (FIG. 16)

Referring now to FIG. 16, there is shown the deployment of an SSM-based inference pipeline at the edge computing infrastructure tier for real-time odds calculation. A data feed ingestion module 1600 and event normalizer 1602 receive and standardize streaming event data. At the edge node 1604, a game state model 1606 implemented as a state-space model maintains a continuous recurrent representation of the game state. The SSM architecture provides O(1) computational complexity per event update, meaning each new event updates the internal state in constant time regardless of the number of prior events. The game state model 1606 feeds a downstream inference engine 1608 that computes updated output values and a margin adjustment model 1610. A suspension trigger 1612 can instantly halt downstream output in less than 1 millisecond upon high-confidence event detection. At the metro/regional tier 1622, cross-session aggregation 1624, multi-event correlation 1626, and settlement 1628 provide coordination services asynchronously.

### Part 2: Computer Vision Event Detection (FIG. 17)

Referring now to FIG. 17, there is shown the deployment of a computer vision pipeline split across the venue node 1700 and the edge node 1710, demonstrating task-complexity-based tier selection. At the venue node 1700, lightweight quantized object detection 1706 and pose estimation 1708 perform fast detection. At the edge node 1710, an object tracker 1712 maintains persistent identities and an action recognition model 1714 implemented as a Video-SSM classifies actions over time with O(1) per-frame complexity, demonstrating SSM generality across different inference domains. An event classifier 1716 evaluates the action recognition output to categorize detected events by type and significance. A confidence gating module 1718 applies a confidence threshold to the classified events, passing only events that meet or exceed the confidence threshold as confirmed events. Confirmed events that pass the confidence gate are forwarded via interface 1720 directly to an odds engine (e.g., FIG. 16) through a local shared memory data path with no metro hop. At the metro/regional coordination tier, cross-venue event correlation aggregates confirmed events across multiple venues for league-wide analytics, and historical event pattern analysis refines the event classifier 1716 and confidence gating 1718 thresholds over time. In certain embodiments, the metro-tier functions operate asynchronously and never block the latency-critical event detection path between the venue node 1700 and the edge node 1710.

### Part 3: Fraud and Risk Management (FIG. 18)

Referring now to FIG. 18, there is shown embodiments of a multi-tier anomaly detection pipeline. This pipeline is the primary demonstration of privacy-controlled tier selection. At the device tier, a behavioral biometrics module 1800 monitors interaction patterns. Raw biometric data is processed (exclusively) on the device, and (only) a derived confidence score is transmitted to the edge computing infrastructure tier. The raw data never leaves the device tier. This embodies the privacy-controlled tier selection described herein, with sensitive personal data processed at the lowest tier and only non-reversible derived metrics moving to higher tiers. At the edge node 1804, an anomaly detector 1806, a temporal burst detector 1808 implemented as an SSM with O(1) per-event running state (a third SSM deployment), and a correlation engine 1810 operate in parallel. The correlation engine 1810 demonstrates a capability unique to edge co-location: because computer vision (“CV”) event detection (FIG. 17) and the incoming data stream are processed at the same edge node, the system correlates timing between them via local shared memory in real time. At the metro/regional coordination tier, cross-session fraud pattern aggregation 1816 correlates anomaly signals across multiple edge nodes and multiple user sessions to detect coordinated fraud patterns that are not visible at any single edge node. Regulatory compliance logging 1824 maintains encrypted audit trails of all fraud detection events for jurisdictional reporting requirements. These metro-tier functions operate asynchronously and support the multi-tier job placement strategy by providing aggregation and compliance services that complement the real-time edge-tier detection without blocking the latency-critical fraud screening path.

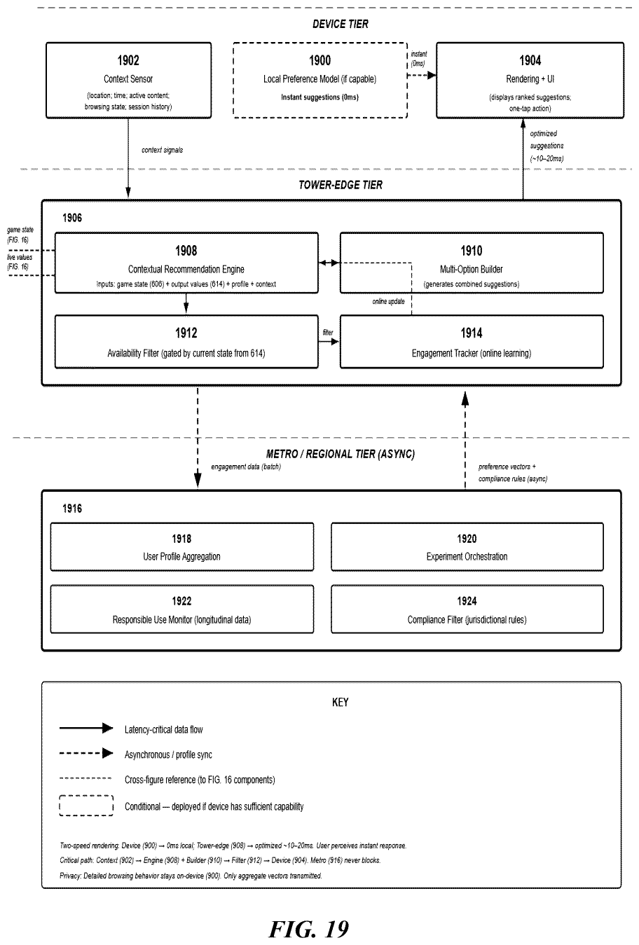

### Part 4: Personalized Recommendations (FIG. 19)

Referring now to FIG. 19, there is a recommendation pipeline demonstrating two-speed dynamic workload placement. At the device tier, a user preference model 1900 provides instant suggestions from a local cache with zero perceived latency. A rendering module 1904 displays device-generated suggestions immediately, then seamlessly replaces them with edge-optimized suggestions when they arrive (approximately 10-20 milliseconds). The on-device preference model 1900 also demonstrates privacy-controlled tier selection: detailed browsing behavior is processed on-device, with only aggregate preference vectors transmitted to higher tiers. At the edge node 1906, a contextual recommendation engine 1908 incorporates real-time data from the odds engine via local shared memory. At the metro/regional coordination tier, a cross-session preference aggregator 1916 analyzes anonymized preference vectors across multiple user sessions and multiple edge nodes to identify trending selections and popular markets, feeding these aggregate signals back to the edge-tier recommendation engines 1908 asynchronously. A recommendation model update coordinator 1920 distributes updated recommendation model weights based on aggregated preference patterns. These metro-tier functions bolster the multi-tier job placement strategy by providing cross-session intelligence that improves edge-tier recommendation quality without introducing latency into the real-time recommendation path.

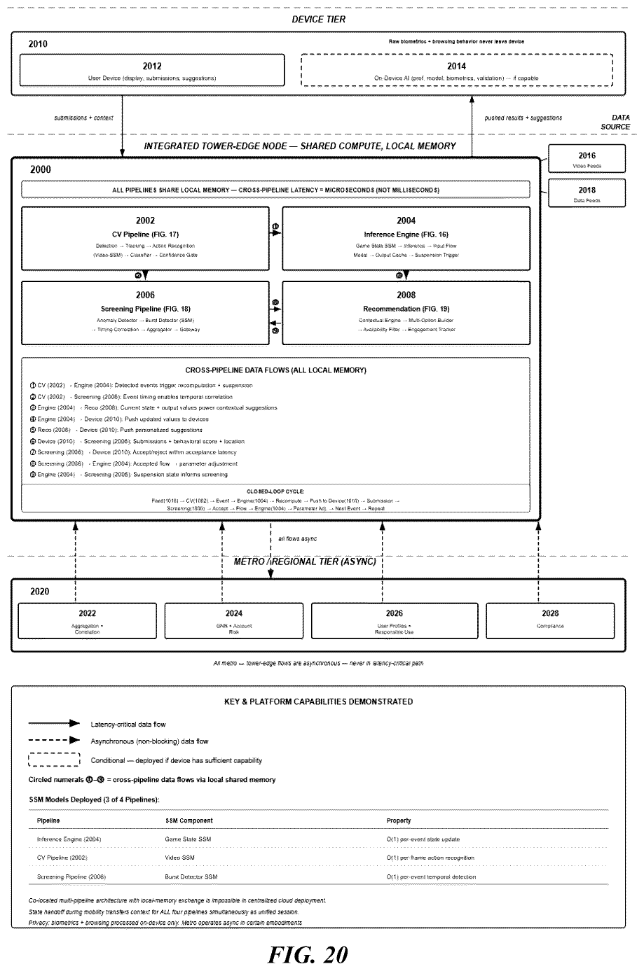

### Integrated Multi-Pipeline Architecture (FIG. 20)

Referring now to FIG. 20, there is shown the integrated architecture with all four inference pipelines co-located on shared edge infrastructure 2000: CV pipeline 2002 (FIG. 17), odds engine 2004 (FIG. 16), fraud pipeline 2006 (FIG. 18), and recommendation engine 2008 (FIG. 19). FIG. 20 illustrates nine cross-pipeline data flows through local shared memory with microsecond latency, creating a closed-loop cycle: event detection, recomputation, recommendation update, user action, screening, parameter adjustment, and next event. This closed-loop architecture with microsecond cross-pipeline communication is a distinguishing feature of edge co-location. SSM-based models are deployed in three of four pipelines: game state model in the odds engine 2004, Video-SSM action recognition in the CV pipeline 2002, and temporal burst detector in the fraud pipeline 2006. When a user moves between edge coverage areas, the system transfers session context for all four pipelines simultaneously as a unified session.

### Platform Capabilities Demonstrated by FIGS. 16-20

SSM-based edge inference with O(1) temporal scaling deployed in three distinct inference domains; co-located multi-pipeline inference with nine cross-pipeline data flows at microsecond latency; privacy-controlled tier selection with biometric data and behavioral data processed exclusively on-device; dynamic workload placement based on device capability with two-speed rendering; task-complexity-based tier selection with lightweight inference at lower tiers and full classification at higher tiers; asynchronous metro coordination; and unified multi-pipeline state handoff during mobility.

### Third Embodiment: AR Navigation and Translation (FIGS. 21-24)

FIGS. 21 through 24 illustrate an exemplary embodiment of a distributed AI inference system applied to augmented reality navigation with integrated real-time environmental translation.

### Part 1: Spatial Understanding Pipeline (FIG. 21)

Referring now to FIG. 21, there is shown an SSM-based inference pipeline at the edge computing infrastructure tier for continuous spatial environment modeling. At the device tier 2130, a camera 2100 and inertial measurement unit (IMU) 2102 capture continuous visual and motion data. A visual-inertial odometry module (SLAM) 2100 maintains a local spatial anchor map on-device. A lightweight object detector 2100 provides coarse on-device detection and localization of nearby objects, obstacles, and environmental features at 5-15 millisecond latency, supplementing the SLAM module's geometric mapping with near-real-time object awareness. The object detector 2100 performs detection and localization but not full semantic understanding; its coarse-grained output identifies the presence and approximate position of objects without detailed classification or contextual interpretation. Full semantic understanding of the detected objects is performed at the edge computing infrastructure tier, where the Spatial-SSM 2114 processes the filtered spatial features with rich contextual data from the POI lookup module 2116 and returns detailed spatial overlays to the device via the overlay renderer 2120. This division of labor between the device tier and the edge computing infrastructure tier illustrates task-complexity-based workload distribution: lightweight, latency-critical coarse detection executes on-device within the device's computational budget, while computationally intensive semantic understanding and contextual enrichment execute at the edge tier where greater processing resources are available. A privacy filter 2104 redacts faces, license plates, and personally identifiable content before any visual data leaves the device tier, transmitting (only) filtered spatial features and derived geometric representations to higher tiers.

At the edge node 2110, a spatial feature receiver 2112 ingests filtered data. A Spatial-SSM 2114 having 128-256 state dimensions maintains a continuous recurrent representation of the user's spatial environment with O(1) computational complexity per update. The Spatial-SSM 2114 is analogous to the game state SSM described with reference to FIG. 16. A POI lookup module 2116 retrieves contextual information, a navigation engine 2118 computes wayfinding overlays, and an overlay renderer 2120 transmits spatial overlays to the device. At the metro/regional tier 2122, cross-edge spatial map coordination 2124, POI database synchronization 2126, and session coordination 2128 operate asynchronously.

### Part 2: Visual Scene Understanding Pipeline (FIG. 22)

Referring now to FIG. 22, there is shown a visual analysis pipeline split across the device and edge tiers. At the device tier 2200, a text region detector 2208 localizes text in the visual field. A display renderer 2204 immediately composites the lightweight detector's coarse results onto the user's visual field, providing instant feedback subsequently replaced by high-accuracy edge results delivered from an overlay compositor 2230, implementing the two-speed rendering pattern. This is a direct application of the dynamic workload placement analogous to the on-device preference model 1900 and contextual recommendation engine 1908 described with reference to FIG. 19.

At the edge node 2220, a Vision-SSM 2228 having 2-3 billion parameters performs full-accuracy identification and scene understanding with O(1) per-frame complexity. A hazard detector 2232 implements priority alerting that bypasses the normal pipeline. A contextual enrichment module 2226 draws cross-pipeline spatial context from a Spatial-SSM via local shared memory.

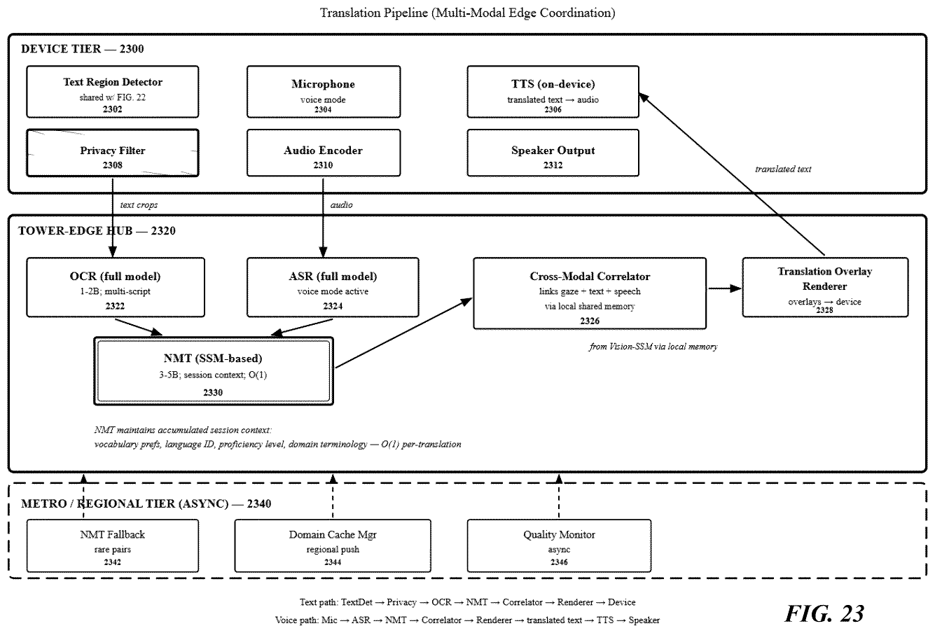

### Part 3: Translation Pipeline (FIG. 23)

Referring now to FIG. 23, there is shown a multi-modal translation pipeline at the edge tier. The pipeline handles both visual text and ambient speech translation through parallel paths converging at a unified NMT stage. An OCR module 2322 performs multi-script text recognition on visual text detected by the text region detector 2208 (FIG. 22). In the auditory path, an ambient speech recognition module 2324 performs continuous ASR on environmental audio captured by the device microphone, converting detected speech into text with language identification. The OCR output and ASR output are both routed to an NMT module 2330, implemented as a state-space model having 3-5 billion parameters, which translates text and speech while maintaining accumulated session context with O(1) complexity per translation via the SSM linear recurrence property. A TTS synthesis module 2306 generates spoken audio output for translated speech content, enabling audio overlay delivery to the user's headset or earpiece for ambient speech translations. A cross-modal correlator 2326 receives gaze target information from the Vision-SSM 2228 (FIG. 22) via local shared memory, linking visual text and ambient speech to provide unified translation. When the user's gaze is directed at a text element, the correlator 2326 prioritizes visual text translation; when the user is engaged in conversation, the correlator prioritizes ambient speech translation. This cross-modal correlation at edge latency is a direct analogue of the timing correlation engine 1810 described with reference to FIG. 18. At the metro/regional coordination tier 130, a translation model update coordinator distributes updated NMT and TTS model weights based on geographic language demand patterns, and a cross-session translation memory aggregator pools commonly translated phrases across multiple user sessions within a region to improve translation speed and consistency. Rare language pair fallback 2342 provides NMT processing for language combinations whose models exceed edge node capacity. These metro-tier functions operate asynchronously and never block the latency-critical translation path.

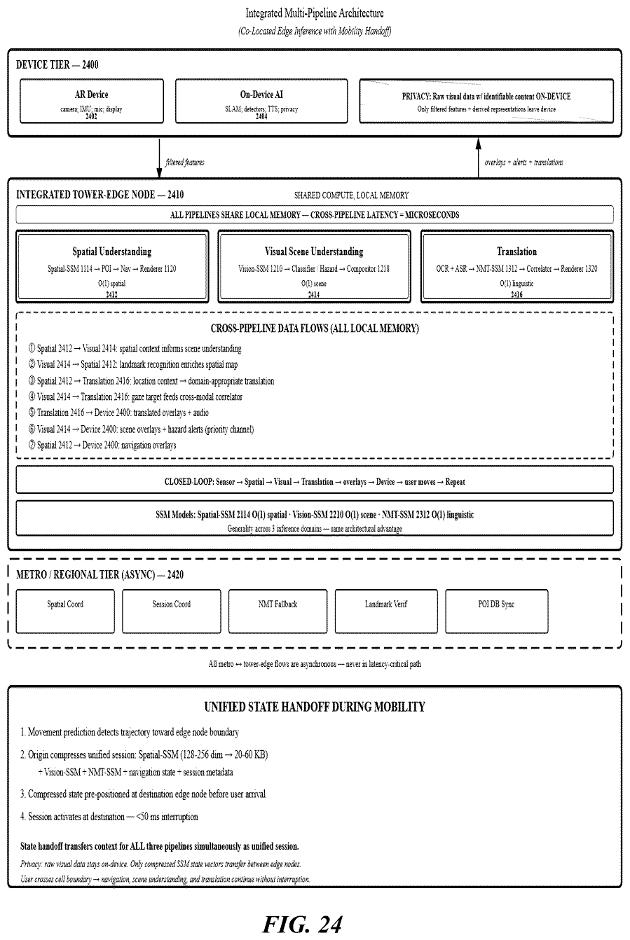

### Integrated Multi-Pipeline Architecture With Mobility Handoff (FIG. 24)

Referring now to FIG. 24, there is shown the integrated architecture with three inference pipelines co-located on shared edge infrastructure: Spatial Understanding 2412, Visual Scene Understanding 2414, and Translation 2416. FIG. 24 illustrates seven cross-pipeline data flows through local shared memory, creating a closed-loop cycle: sensor capture, spatial mapping, scene understanding, contextual translation, overlay rendering, user movement, and spatial update. This is directly analogous to the nine-flow architecture of FIG. 20.

When a user moves between edge coverage areas, the system transfers session context for all three pipelines simultaneously as a unified session: Spatial-SSM state compressed to 20-60 KB via SSM linear recurrence properties, Vision-SSM state compressed via temporal state pruning, NMT-SSM state including accumulated translation context, navigation state, and session metadata. The predictive state pre-positioning system detects the user's movement trajectory and begins transferring the compressed unified session state to the predicted destination edge node before the user arrives. Upon arrival, the compressed state is decompressed and activated with less than 50 milliseconds interruption.

### Platform Capabilities Demonstrated by FIGS. 21-24

SSM-based edge inference in three distinct domains (spatial, visual, linguistic); co-located multi-pipeline inference with seven cross-pipeline flows at microsecond latency; privacy-controlled tier selection with raw visual data processed exclusively on-device by a privacy filter; dynamic workload placement with two-speed rendering; task-complexity-based tier selection across device, edge, and metro tiers analogous to the CV pipeline split in FIG. 17; asynchronous metro coordination; and unified multi-pipeline state handoff during mobility with model-specific compression achieving less than 50 millisecond interruption in certain embodiments.

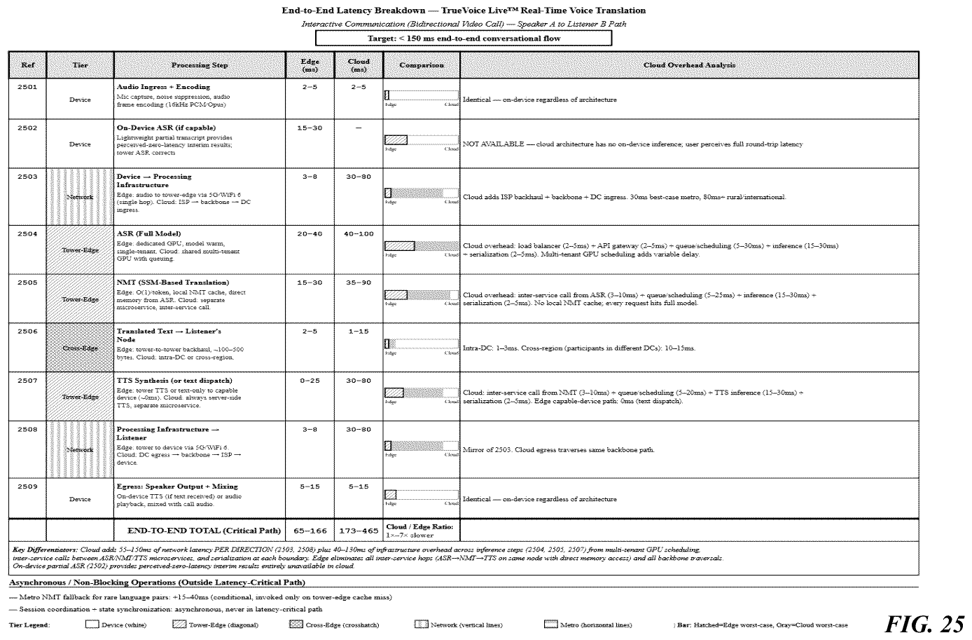

### Performance Comparison: Edge Vs. Cloud Deployment (FIGS. 25-27)

FIGS. 25 through 27 present quantitative end-to-end latency comparisons between the edge-enabled deployment described herein and a cloud-only deployment for each of the three exemplary embodiments. These comparisons provide evidence of the technical improvement achieved by the system 100. It is to be understood that these data points are merely prototypical and not exhaustive, such that systems exhibiting latency characteristics outside of these findings are also envisioned by the invention(s) of this disclosure.

### Real-Time Voice Translation Latency (FIG. 25)

FIG. 25 presents latency data for the real-time voice translation embodiment of FIGS. 11-15. Edge-enabled deployment achieves end-to-end latency of 65-166 milliseconds depending on use case configuration, compared to 173-465 milliseconds for equivalent cloud-only deployment. The improvement factor ranges from approximately 1.5× to 7× depending on the use case, with the greatest advantage in the interactive communication scenario (FIG. 11) where bidirectional low-latency requirements amplify the benefit of edge processing.

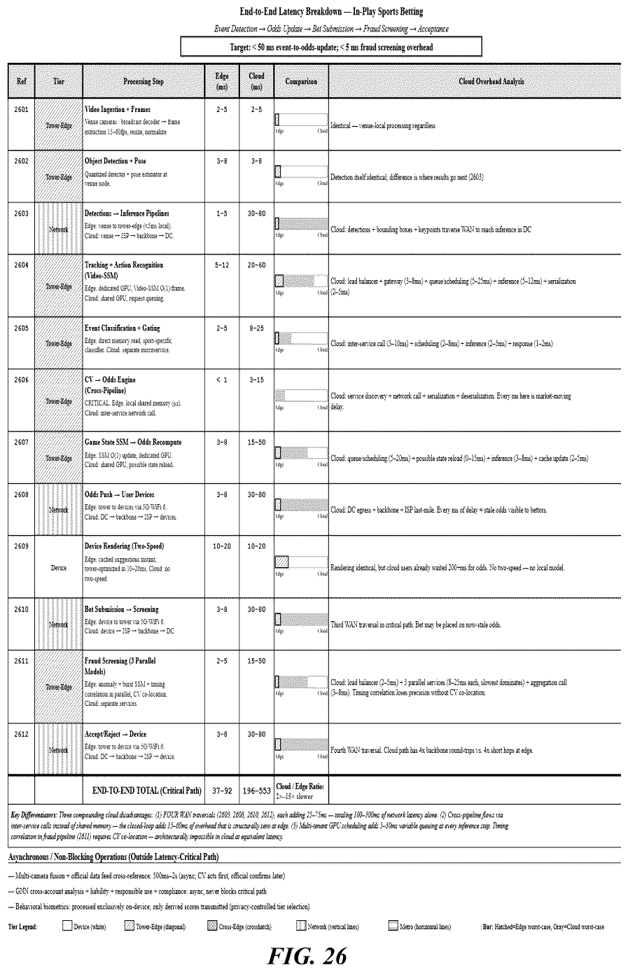

### Sports Betting Latency (FIG. 26)

FIG. 26 presents latency data for the sports betting embodiment of FIGS. 16-20. Edge-enabled deployment achieves end-to-end latency of 37-92 milliseconds, compared to 196-553 milliseconds for cloud-only deployment. The improvement factor ranges from approximately 2× to 15×, with the greatest advantage in the closed-loop cycle path where multiple cross-pipeline exchanges via local shared memory each save a network round-trip compared to cloud microservice communication.

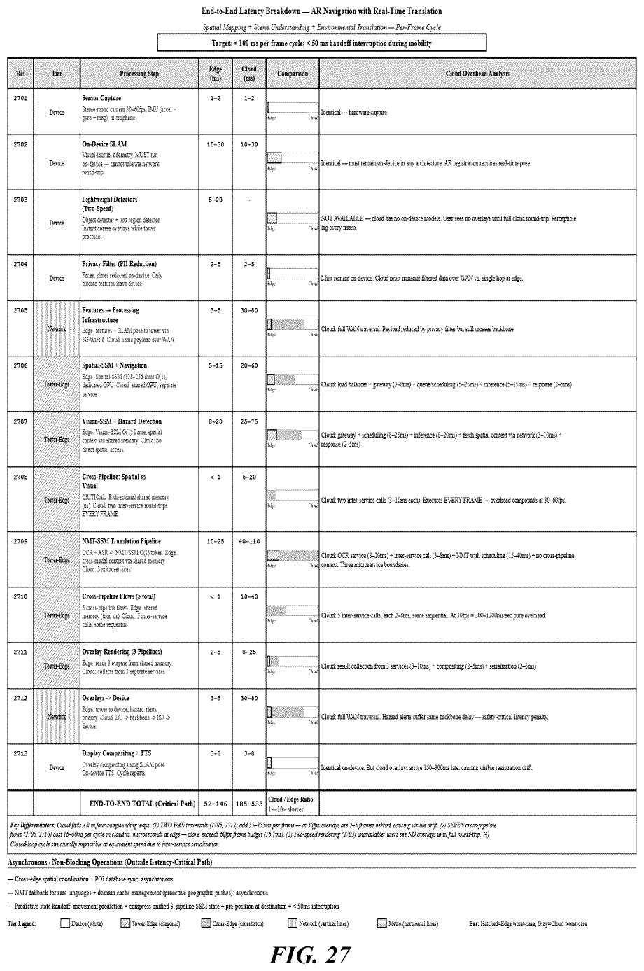

### AR Navigation Latency (FIG. 27)

FIG. 27 presents latency data for the AR navigation embodiment of FIGS. 21-24. Edge-enabled deployment achieves end-to-end latency of 52-146 milliseconds, compared to 185-535 milliseconds for cloud-only deployment. The improvement factor ranges from approximately 1.3× to 10×. The hazard detection priority path achieves the lowest absolute latency, demonstrating the safety benefit of edge deployment for AR applications.

The sources of cloud overhead common across all three embodiments are: wide-area network traversals between user devices and cloud data centers (typically 30-100 milliseconds round-trip), multi-tenant GPU scheduling queues at cloud data centers (typically 10-50 milliseconds additional latency), and inter-service serialization for cross-pipeline data exchange in microservice architectures (typically 1-10 milliseconds per exchange). The edge-enabled deployment eliminates wide-area network traversals, avoids multi-tenant scheduling contention through dedicated edge resources, and replaces inter-service network communication with local shared memory access for co-located pipelines.

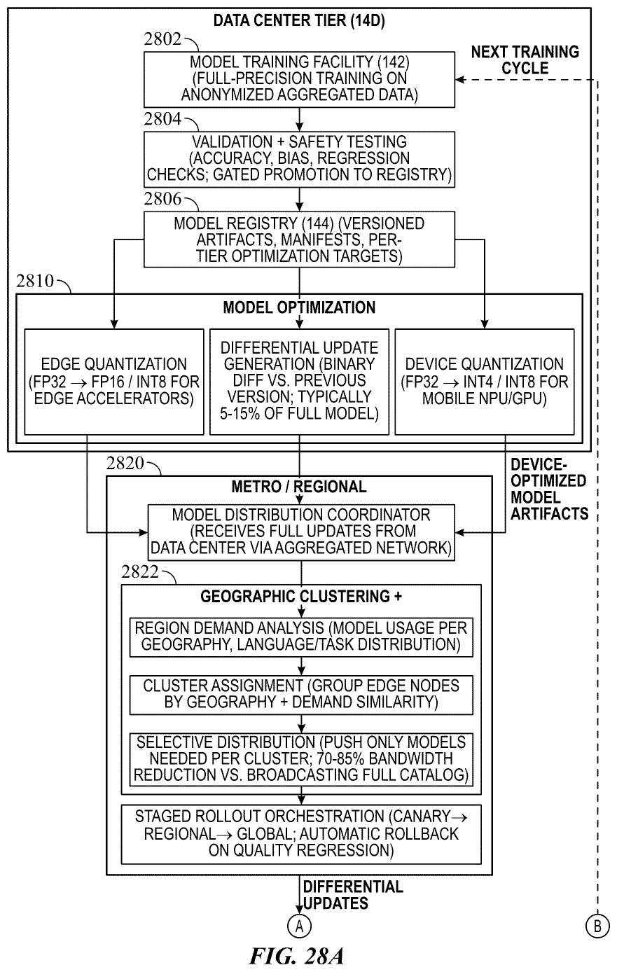

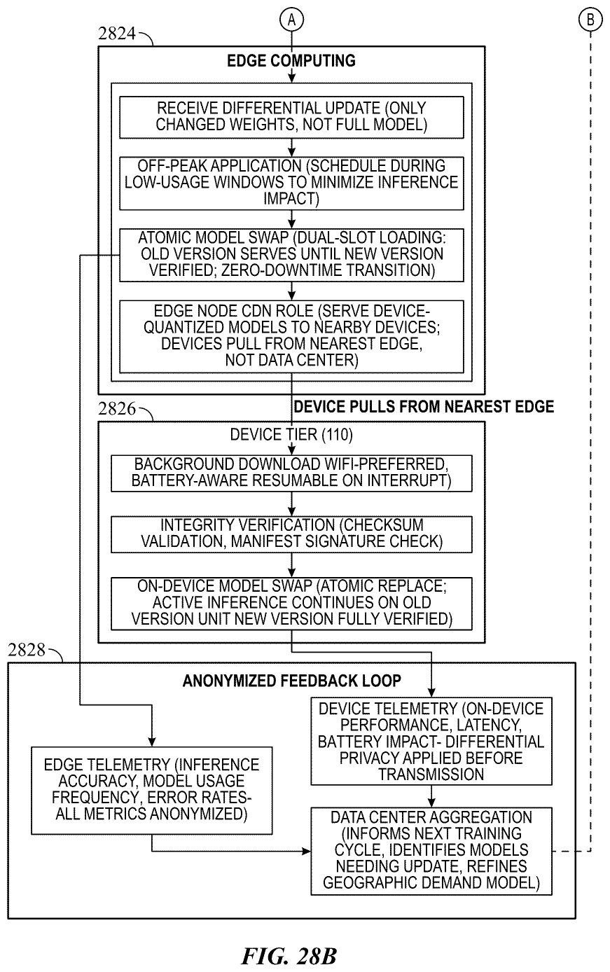

### Model Deployment and Distribution Pipeline (FIG. 28)

Referring now to FIG. 28, there is shown a block diagram illustrating the model deployment and distribution pipeline in accordance with one or more embodiments. FIG. 28 depicts the end-to-end lifecycle by which AI models trained at the data center tier 140 are prepared, validated, and distributed to the edge computing infrastructure tier 120 and the device tier 110. FIG. 28 is complementary to FIG. 10, which describes the model update distribution flow for already-deployed models; FIG. 28 addresses initial deployment and the full pipeline from training through production readiness.

The pipeline begins with data center model training at 2802, where models are trained on full-precision hardware using aggregated telemetry and training data. Upon training completion, the pipeline proceeds through validation and safety testing measures at 2804, which check for accuracy, bias, and regression patterns. If a model satisfies the validation and safety testing at 2804, it is promoted to entry into the model registry 2806, which generates versioned artifacts, manifests, and per-tier optimization targets for the model. Following the registry 2806, the model progresses to the optimization and quantization stage 2810. In this stage, (each) trained model is quantized and optimized for the target hardware profiles present in the edge computing infrastructure tier 120 and the device tier 110. Optimization includes weight pruning, INT8/INT4 quantization calibration, and architecture-specific kernel compilation for target accelerators (NPU, GPU, or DSP).

Following optimization, the pipeline sends device-optimized model artifacts to the metro/regional tier 130 which intakes the artifacts via the model distribution coordinator 2820. Geographic clustering is then performed at 2822 Geographic clustering groups edge nodes 122 into deployment cohorts based on geographic proximity, workload similarity, and model demand patterns derived from historical telemetry. This grouping enables staged rollout such that a model is deployed first to a pilot cohort of edge nodes 122 in a single geographic region at 2824, validated against baseline accuracy and latency metrics, and then progressively deployed to additional cohorts.

The staged edge rollout phase distributes the optimized model to the metro/regional coordination tier 130 for staging, consistent with the one-tier-up staging protocol described with reference to FIG. 10. In certain embodiments, the coordination node(s) 132 validates the model against local test inputs before authorizing distribution to the edge nodes 122 in its region. Once validated, the model is pushed to an edge node 122, which load the model into accelerator memory and register the model with the local orchestration agent 116 on connected devices.

Device-tier distribution, the final stage at 2826, provides lightweight model variants to user devices 112 that have been determined capable of on-device inference. These device-tier models are further compressed using the model-specific state compression techniques described with reference to FIG. 6, and are distributed over available wireless links during low-utilization periods to minimize impact on active inference sessions.

A telemetry feedback loop 2828 closes the pipeline. Each edge node and each user device running the deployed model reports inference accuracy, latency, throughput, and error rates to the data center tier 140 via the metro/regional coordination tier 130. This telemetry informs subsequent training cycles and identifies edge nodes or device classes where the deployed model underperforms, triggering targeted retraining or re-optimization.

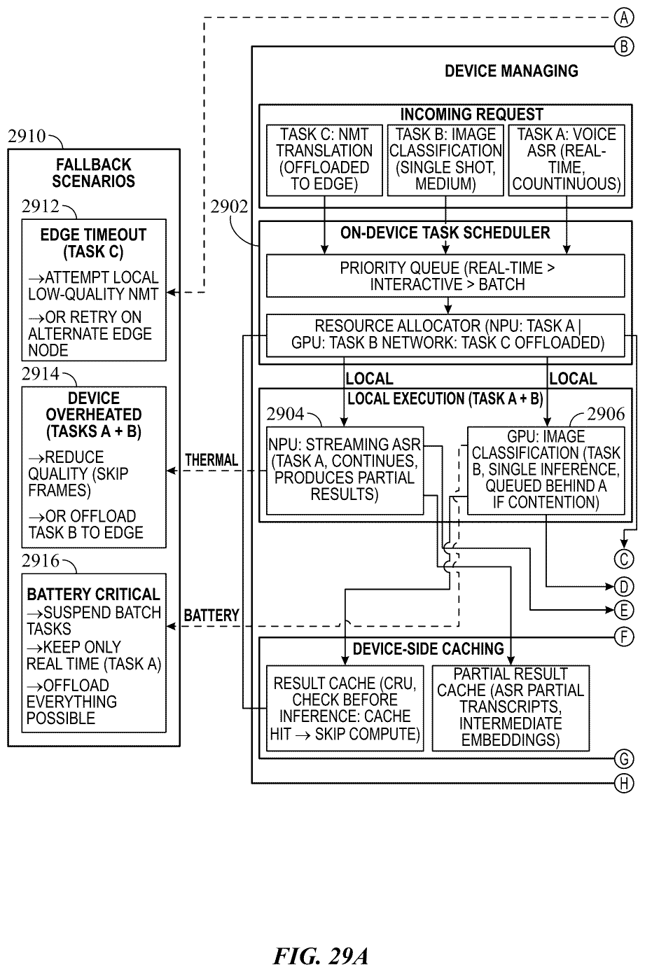

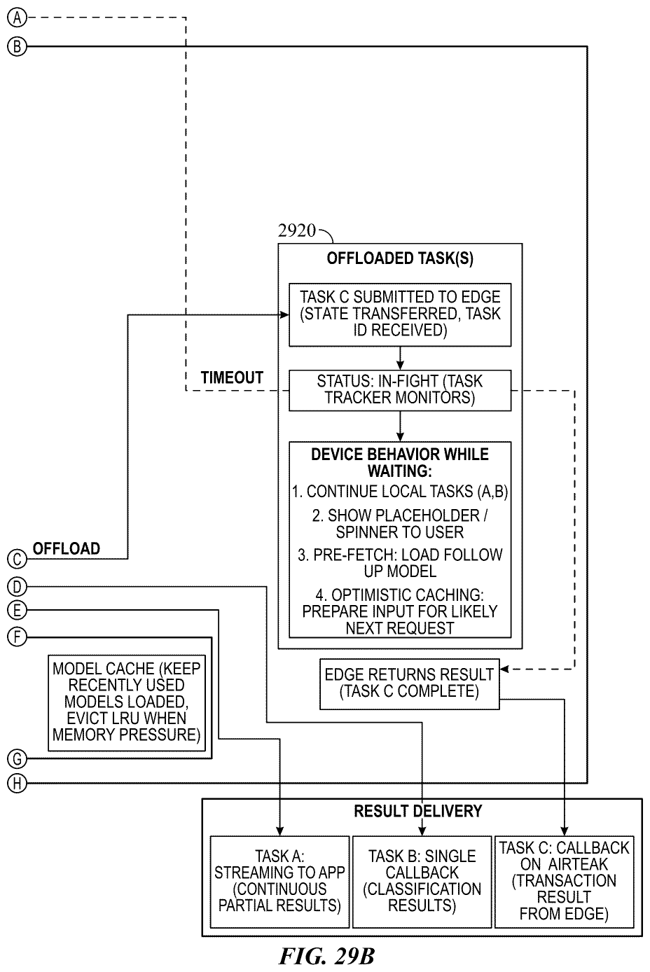

### Device-Tier Concurrent Task Management (FIG. 29)

Referring now to FIG. 29, there is shown a block diagram illustrating device-tier concurrent task management in accordance with one or more embodiments. FIG. 29 provides additional details on the internal operation of the user device(s) 112 of FIG. 1, complementing the device component architecture described with reference to FIG. 4 and the task lifecycle described with reference to FIG. 5.

The local orchestration agent 116 maintains a priority-based task scheduler 2902 that manages concurrent inference tasks on the device. In certain embodiments, each inference task submitted to the device is assigned a priority level based on its latency requirements, with real-time interactive tasks (such as voice recognition or AR overlay rendering) receiving highest priority, background pre-computation tasks receiving lowest priority, and batch analytics tasks receiving intermediate priority.

The task scheduler 2902 allocates device accelerator resources across available compute units. On devices equipped with both an NPU 2904 and a GPU 2906, the scheduler 2902 assigns SSM-based inference tasks (such as NMT or predictive routing) to the NPU 2904 and convolutional or transformer-based tasks (such as image classification or object detection) to the GPU 2906. This dual-accelerator allocation enables parallel execution of heterogeneous inference tasks without resource contention. On devices with only a single accelerator (not depicted), the scheduler 2902 time-slices the accelerator across tasks according to priority, preempting lower-priority tasks when a higher-priority task arrives.

FIG. 29 further depicts three fallback scenarios 2910 that the local orchestration agent handles autonomously. In an edge timeout scenario 2912, when a task offloaded to an edge node exceeds its estimated completion time, the device either retries at an alternate edge node or initiates degraded-quality local inference, as also described with reference to FIG. 9. In an overheated device scenario 2914, when the device thermal sensors indicate that the accelerator temperature exceeds a predefined threshold, the scheduler 2902 reduces the local inference clock rate and offloads excess task(s) 2920 to the edge node 122 an asynchronous offload path. In a battery-critical scenario 2916, when the device battery level falls below a critical threshold, the scheduler 2902 can suspend all non-essential local inference tasks, offloads remaining task(s) 2920 to the edge node 122, and reduces the on-device inference engine 114 to a minimal-power monitoring mode that handles (only) wake-word detection or equivalent always-on tasks. In each fallback scenario, the local orchestration agent 116 notifies the application layer of the degraded operating mode and updates the routing tables to reflect the changed device capability profile.

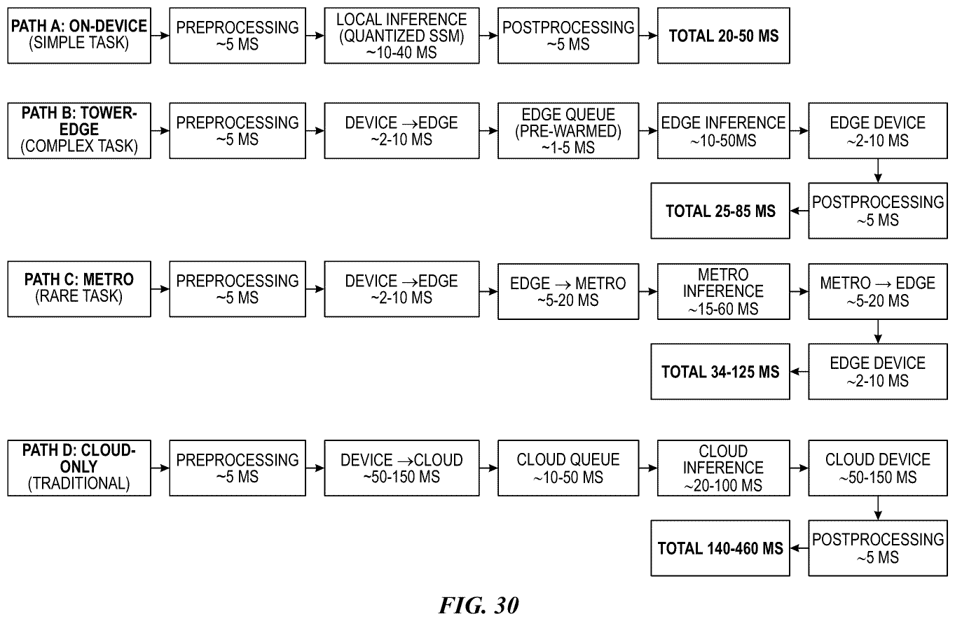

### Latency Breakdown Across Execution Paths (FIG. 30)

Referring now to FIG. 30, there is shown a comparative chart illustrating end-to-end latency breakdowns across four execution paths of the system in accordance with one or more embodiments. FIG. 30 provides a system-level latency overview that complements the per-embodiment latency comparisons presented in FIGS. 25-27.

FIG. 30 decomposes end-to-end latency into component contributions for each of four execution paths. The on-device execution path exhibits a total latency range of 20-50 milliseconds, comprising accelerator inference time with zero network contribution. The tower-edge execution path exhibits a total latency range of 25-85 milliseconds, comprising device-to-edge network transit (typically 1-5 milliseconds), edge accelerator inference time, and result return transit. The metro execution path exhibits a total latency range of 34-125 milliseconds, comprising device-to-edge transit, edge-to-metro backhaul (typically 5-15 milliseconds), metro inference time, and return transit through the same path. The cloud execution path exhibits a total latency range of 140-460 milliseconds, comprising wide-area network transit to the data center (typically 30-100 milliseconds), multi-tenant GPU scheduling queue wait time (typically 10-50 milliseconds), cloud inference time, and return transit.

The latency ranges shown in FIG. 30 represent aggregate measurements across multiple model types and workload categories. The ranges account for variation in model size, input complexity, accelerator utilization, and network conditions. These system-level ranges are consistent with the per-embodiment measurements reported in FIGS. 25-27, which provide finer-grained breakdowns for the specific AI workloads in each embodiment. It is to be understood that these data points are merely prototypical and not exhaustive in any capacity, such that systems exhibiting latency characteristics outside of these findings are also envisioned by the invention(s) of this disclosure.

Existing approaches to distributed AI processing describe the distribution of AI inference workloads across device, edge, and cloud tiers, and describe routing inference requests based on computational requirements, latency, and available resources. The system and methods described herein differ from existing approaches in at least four respects.

First, the use of data sensitivity classification as a dynamic routing control factor for tier selection alongside latency and computational complexity. The privacy classification engine 166 described herein classifies the sensitivity of data contained in each inference request and uses that classification as a mandatory constraint on the routing decision, restricting processing of sensitive data to lower tiers closer to the data source. This privacy-controlled tier selection operates as a technical routing parameter with concrete inputs (data type scanning, regulatory rule evaluation, user preference settings) and concrete outputs (a tier constraint mask applied to the composite routing decision), not as an abstract policy statement. Existing distributed inference systems do not treat data sensitivity as a first-class routing parameter that constrains tier selection.

Second, model-architecture-specific compression of active AI inference session state for transfer between edge computing infrastructure nodes during user mobility. The state compression engine 172 described herein applies compression techniques adapted to the specific structural properties of each AI model architecture: delta encoding and structured sparsity compression exploiting the fixed-size state of state-space models, token-level importance scoring and low-rank factorization exploiting the key-value cache structure of Transformer models, and spatial downsampling exploiting the feature map structure of convolutional models. Existing systems do not address the compression and transfer of computational state between edge nodes during mobility, much less compression adapted to model architecture.

Third, predictive pre-positioning of compressed session state at destination edge nodes based on mobility prediction. The predictive routing engine 164 described herein monitors mobility signals, predicts destination edge nodes with confidence scoring, and proactively transfers compressed session state to predicted destinations before user arrival. This predictive pre-positioning, combined with the model-specific compression, enables sub-100 millisecond session interruption during handoff between edge node coverage areas. Existing systems do not predictively pre-position inference session state.

Fourth, co-located multi-pipeline inference with local-memory cross-pipeline data exchange creating closed-loop inference cycles at microsecond latency. The co-location architecture described herein deploys multiple interdependent inference pipelines on shared edge infrastructure with local shared memory exchange, achieving cross-pipeline communication latency three orders of magnitude lower than network-based exchange in centralized cloud deployments. The closed-loop inference cycles demonstrated in the sports betting (nine cross-pipeline flows) and AR navigation (seven cross-pipeline flows) embodiments are structurally impossible to achieve at equivalent speed in centralized architectures.

It would be understood that a computer system or computer (involving a processor, transitory (volatile) memory, non-transitory (non-volatile memory), and computer readable instructions implemented on the memory (computer readable medium)) is used in the described systems, methods, devices, equipment, hardware, and computer readable medium). Also described or contemplated herein are specialized or unique configuration or adaptations such as for example, in connection with GPUs, TPUs, and co-location. Thus for example, some computer system or systems described herein as discussed may have special hardware or software integrated adapted or specifically directed to implementing, training or performing AI models.

It should be understood by those of ordinary skill in the art that there are multiple inventions described herein and the use of the term “invention” is not to mean that there is only one invention or that a feature is essential or definitive of the disclosed invention(s).

Computer executable instructions, when stored in non-transitory storage media accessible to a processor, configure a computer system (or computer) into a special-purpose machine that is customized to perform the operations specified in the instructions and provide or be capable of features and functionality described herein.

According to certain embodiments of the invention(s), the techniques or processes herein are performed by a computer processor in response to the processor executing one or more sequences of one or more instructions contained in memory. Such instructions may be read into memory from another storage medium, such as a storage device. Execution of the sequences of instructions contained in memory causes the processor to perform the process steps described herein. In alternative embodiments, hard-wired circuitry may be used in place of or in combination with software instructions.

The term storage media as used herein refers to any non-transitory media that stores data and/or instructions that cause a machine to operate in a specific fashion. Such storage media may comprise non-volatile media and/or volatile media. Non-volatile media includes, for example, optical or magnetic disks, such as a storage device. Volatile media includes dynamic memory, such as main memory. Common forms of storage media include, for example, hard disk, solid state drive, or any other magnetic data storage medium, a CD-ROM, any other optical data storage medium, a RAM, a PROM, and EPROM, a FLASH-EPROM, NVRAM, any other memory chip or cartridge.

Hardware and software implementation is also illustratively described or understood from the disclosure.

It should be understood that variations, clarifications, or modifications are contemplated.

It will be understood that the description provided herein applies to systems, methods, and computer readable medium embodiments of the invention when the description is provided in the context of one or more of these. For example, computer implemented method steps will be understood from the discussion and operation of a system or described processes.

Exemplary systems, devices, components, non-transitory computer readable medium, and methods are described for illustrative purposes.

Thus, for example, any sequence(s) and/or temporal order of steps of various processes or methods that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order.

The present disclosure provides examples of illustrative embodiments and embodiments of present invention are not limited to the specified examples.

It is also implicit and understood that the applications or systems illustratively described herein provide computer-implemented functionality that automatically performs a process or process steps.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that for example may involve multiple possibilities, but to a person of ordinary skill in the art a reasonable or primary understanding or meaning is understood.

It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A distributed artificial intelligence inference system comprising:
one or more processors configured to execute stored computer readable instructions that configure the system using the processors to be configured to,
for each inference request received from an end-user device:
(a) assess a computational complexity of the inference request,
(b) determine a latency requirement,
(c) classify a sensitivity level of data associated with the inference request by analyzing the associated data against predefined sensitivity patterns to assign one of a plurality of privacy levels, wherein each privacy level maps to a set of permitted processing tiers,
wherein the permitted processing tiers comprises a hierarchical multi-tier system comprising at least a device tier comprising a plurality of end-user devices, an edge computing infrastructure tier comprising a plurality of edge nodes, a metro/regional coordination tier, and a data center tier
and wherein the sensitivity level limits which processing tiers are eligible to process the inference request such that the inference request to be processed at a tier is excluded by the privacy classification,
(d) assess a data volume, a device resource state, and a network condition,
and
(e) select a target processing tier from among the permitted tiers based on a composite routing score derived from at least one of the following groups, the computational complexity, the latency requirement, the data volume, the device resource state, and the network condition;
compress active session state of at least one inference pipeline using a compression method selected based on a model architecture identifier of the inference pipeline, wherein the compression method is selected from among a plurality of architecture-specific compression methods;
predict a destination edge node for a user device based on at least trajectory data and historical mobility patterns,
compute a destination confidence score, and when the destination confidence score exceeds a threshold, initiate transfer of compressed session state to the predicted destination edge node before the user device exits a coverage area of a current edge node; and
wherein at least two inference pipelines are co-located on a single edge node and exchange data via local shared memory, creating a closed-loop inference cycle in which an output of a first inference pipeline is consumed as an input by a second inference pipeline within a single inference cycle.

2. The system of claim 1, wherein the plurality of privacy levels comprises: a regulated level constraining processing to the device tier or an edge node with encrypted audit logging.

3. The system of claim 1, wherein the plurality of architecture-specific compression methods implemented in the system comprises:
for an inference pipeline having a state-space model architecture, extracting a fixed-size hidden state vector and applying delta encoding relative to a reference checkpoint state followed by structured sparsity encoding and adaptive quantization to produce a compressed state representation; and
for an inference pipeline having a transformer architecture, computing incremental key-value cache deltas relative to a prior checkpoint, scoring tokens by importance, pruning tokens below an importance threshold, and applying low-rank factorization to produce a compressed state representation; and for an inference pipeline having a convolutional neural network architecture, applying spatial downsampling to activation maps, retaining activation peaks above a significance threshold, and applying a learned compression network to produce a compressed state representation.

4. The system of claim 3, wherein for the state-space model architecture, the compressed state representation has a size between 0.5 kilobytes and 8 kilobytes per active model instance.

5. The system of claim 3, wherein for the transformer architecture, the compression method provides a compression ratio between 50:1 and 100:1.

6. The system of claim 1, wherein the destination confidence score is computed as a weighted combination of at least one of the following: a trajectory certainty component derived from position, velocity, and heading data of the user device; a historical accuracy component derived from prediction accuracy for similar mobility patterns; a boundary proximity component indicating distance of the user device from a coverage area boundary of the current edge node; and a capacity projection component derived from resource availability telemetry of the predicted destination edge node.

7. The system of claim 1, wherein the one or more third processors are further configured to: when the destination confidence score is between the threshold and a second threshold lower than the threshold, initiate partial state transfer comprising session metadata and model architecture identifiers without transferring full compressed session state; and when the destination confidence score is below the second threshold, defer state transfer until a handoff trigger condition is detected.

8. The system of claim 1, wherein the at least two co-located inference pipelines exchange data via local shared memory.

9. The system of claim 1, wherein the compressed session state is serialized into a self-describing compressed state payload data structure comprising at least one of the following: a model architecture identifier, a compression method identifier, quantization parameters, a layer count, per-layer compressed state data, session metadata including a user identifier and session identifier, and an integrity checksum.

10. The system of claim 1, wherein the plurality of edge nodes comprise at least one non-terrestrial edge node selected from the group consisting of a low-Earth-orbit satellite, a high-altitude platform station, and an unmanned aerial vehicle, and wherein the one or more third processors are further configured to incorporate orbital trajectory data or flight path data of the at least one non-terrestrial edge node when computing the destination confidence score.

11. The system of claim 1, further comprising one or more processors configured to execute stored instructions that, when transferring compressed session state for a plurality of co-located inference pipelines, assemble compressed states for each pipeline into a unified session payload and transfer the unified session payload as a single transfer unit, the unified session payload comprising per-pipeline compressed state, cross-pipeline shared context, and session metadata.

12. The system of claim 1, further comprising one or more processors configured to execute stored instructions that adjust a compression aggressiveness parameter based on: an available bandwidth between a source edge node and the predicted destination edge node, an estimated time remaining before the user device crosses a coverage area boundary, and a minimum quality-of-service threshold specified by the inference pipeline, to produce compressed session state that can be transferred within the estimated time at the available bandwidth while maintaining reconstruction quality above the minimum threshold.

13. A computer-implemented method for distributed artificial intelligence inference, the method comprising:
receiving, at an end-user device, an inference task request; classifying, by one or more processors, a sensitivity level of data associated with the inference task request by analyzing the data against predefined sensitivity patterns to assign one of a plurality of privacy levels, each privacy level mapping to a set of permitted processing tiers;
constraining eligible processing tiers to the set of permitted tiers corresponding to the assigned privacy level, wherein the constraining operates as a mandatory pre-filter applied before evaluating other routing factors whereby no combination of favorable scores on computational complexity, latency, data volume, device resource state, or network condition causes the inference task to be processed at a tier excluded by the privacy classification;
computing a composite routing score for the inference task based on at least computational complexity, latency requirement, data volume, device resource state, and network condition, considering only tiers within the set of permitted tiers;
selecting a target processing tier from the set of permitted tiers based on the composite routing score; and
transmitting the inference task to the selected target processing tier for execution.

14. The method of claim 13, wherein the inference task request contains data elements at different privacy levels, and the method further comprises: splitting the inference task request into sub-requests, each sub-request containing data elements at a single privacy level; routing each sub-request to a processing tier permitted by its respective privacy level; and recombining results from the sub-requests before returning to the requesting application.

15. The method of claim 13, further comprising: maintaining an audit log of instances where the mandatory pre-filter excludes a processing tier that would otherwise have the highest composite routing score, the audit log recording the excluded tier, the privacy level that caused exclusion, and the tier to which the inference task was routed instead.

16. A computer-implemented method for model-architecture-specific state compression in a distributed inference system, the method comprising:
receiving, at one or more processors, a request to compress session state of an inference pipeline executing at an edge node;
identifying an artificial intelligence model architecture of the inference pipeline from among at least a state-space model architecture, a transformer architecture, and a convolutional neural network architecture;
selecting a compression method based on the identified model architecture, wherein: for the state-space model architecture, the compression method comprises extracting a fixed-size hidden state vector from each active model layer, applying delta encoding relative to a reference checkpoint state to produce a delta vector, applying structured sparsity encoding to the delta vector by encoding only dimensions that have changed by more than a configurable threshold, and applying adaptive quantization;
wherein for the transformer architecture, the method comprises computing incremental key-value cache deltas relative to a prior checkpoint, scoring tokens by importance based on attention weights, pruning tokens below an importance threshold, and applying low-rank factorization to remaining key-value pairs; and
for the convolutional neural network architecture, the compression method comprises applying spatial downsampling to activation maps, retaining activation peaks above a significance threshold with their spatial indices, and applying a learned compression network;
applying the selected compression method to produce a compressed state payload comprising at least one of the following group: a model architecture identifier, a compression method identifier, quantization parameters, a layer count, per-layer compressed state data, session metadata, and an integrity checksum; and
transmitting the compressed state payload to a destination node for decompression and session state restoration.

17. The method of claim 16, wherein for the state-space model architecture, the compressed state payload has a size between 0.5 kilobytes and 8 kilobytes per active model instance, and for the transformer architecture, the compression method provides a compression ratio between 50:1 and 100:1.

18. The method of claim 16, further comprising: determining an available bandwidth between the edge node and the destination node; determining a transfer time constraint based on a predicted time until a mobility handoff event; and adjusting a compression aggressiveness parameter by modifying at least one of the configurable threshold, a quantization level, and a pruning aggressiveness to produce a compressed state payload that can be transferred within the transfer time constraint at the available bandwidth while maintaining a reconstruction quality above a minimum threshold.

19. The method of claim 16, wherein the inference pipeline comprises a plurality of co-located inference pipelines, and wherein the method further comprises: compressing session state for each of the plurality of inference pipelines using a respective architecture-specific compression method; assembling the compressed states into a unified session payload; and transmitting the unified session payload as a single transfer unit.

20. The method of claim 16, wherein the compressed state payload further comprises a priority field, and wherein the method further comprises: when a transfer is interrupted before completion, retransmitting compressed state data in order of the priority field such that highest-priority state data is restored first.

21. The method of claim 16, wherein the request to compress session state is triggered by a model update event, and wherein the method further comprises: compressing active session state at the edge node prior to deploying an updated model version; staging the updated model version at a tier one level above a target deployment tier; deploying the updated model version to the target deployment tier; and restoring the compressed session state into the updated model version to maintain session continuity across the model update.

22. A system for predictive state pre-positioning in a distributed inference network, the system comprising:
a plurality of edge nodes, each edge node comprising at least one processor configured to execute at least one artificial intelligence inference pipeline;
one or more first processors configured to execute stored computer readable instructions that configure the one or more processors to:
receive a plurality of signal inputs comprising at least trajectory data from a user device, historical mobility patterns associated with the user device, and capacity telemetry from candidate destination edge nodes;
compute a composite destination confidence score for each candidate destination edge node based on at least one of the following group: a trajectory certainty component derived from the trajectory data, a historical accuracy component derived from the historical mobility patterns, a boundary proximity component indicating a distance of the user device from a coverage area boundary of a current edge node, and a capacity projection component derived from the capacity telemetry;
one or more second processors configured to execute stored computer readable instructions that that configure the one or more second processors to:
when the composite destination confidence score for a candidate destination edge node exceeds a high-confidence threshold, initiate full state transfer comprising compressed session state for all active inference pipelines to the candidate destination edge node;
when the composite destination confidence score is between the high-confidence threshold and a medium-confidence threshold, initiate partial state transfer comprising session metadata and model identifiers to the candidate destination edge node; and
when the composite destination confidence score is below the medium-confidence threshold, defer state transfer; and wherein the compressed session state is produced by one or more processors that select a compression method based on a model architecture of each active inference pipeline from among a plurality of architecture-specific compression methods.

23. The system of claim 22, wherein the one or more first processors configured to compute the composite destination confidence score are further configured to receive network condition forecasts and application-level context signals as additional signal inputs, and to incorporate the additional signal inputs into the composite destination confidence score.

24. The system of claim 22, further configured to, upon initiating full state transfer, maintain a dual-connection state in which the user device is simultaneously connected to both the current edge node and the candidate destination edge node for a verification period, and to release the connection to the current edge node after verifying successful state restoration at the candidate destination edge node.

25. The system of claim 22, wherein the one or more processors configured to initiate state transfer are further configured to coordinate transfer of compressed states for a plurality of co-located inference pipelines as a unified session payload comprising per-pipeline compressed state, cross-pipeline shared context, and session metadata.

26. The system of claim 22, wherein at least one of the plurality of edge nodes is a non-terrestrial edge node, and wherein the one or more processors configured to compute the composite destination confidence score are further configured to incorporate orbital trajectory data or flight path data of the non-terrestrial edge node, and to account for signal propagation delay to the non-terrestrial edge node when determining transfer timing.

27. A computer-implemented method for maintaining artificial intelligence inference session continuity during user mobility, the method comprising:
monitoring, by one or more processors, mobility signals for a user device with an active AI inference session at a first edge computing infrastructure node;
predicting, based on the mobility signals, a destination edge computing infrastructure node;
compressing, by the one or more processors, the active AI inference session state using a compression technique selected based on a model architecture of the active inference session, wherein the compression technique is selected from among a plurality of architecture-specific compression techniques each adapted to exploit structural properties of a corresponding model architecture family;
transferring the compressed session state to the predicted destination edge computing infrastructure node before the user device arrives at the destination;
activating the session at the destination node upon arrival of the user device; and
verifying session integrity at the destination node by comparing inference outputs against an expected baseline.

28. The method of claim 27, wherein the active AI inference session comprises a plurality of co-located inference pipelines, and the method further comprises transferring compressed session state for all of the plurality of co-located inference pipelines as a unified session payload, the unified session payload preserving cross-pipeline consistency across the transition.

29. The system of claim 1, wherein two or more of first processors, second processors, and third processors that are implemented on common computing hardware at a single edge computing infrastructure node, such that the routing, compression, and prediction functions execute on shared processing resources.
